(19) United States
(12) Patent Application Publication
(10) Pub. No.: US 2011/0126106 A1
(43) Pub. Date: May 26, 2011

(54) SYSTEM FOR GENERATING AN INTERACTIVE OR NON-INTERACTIVE BRANCHING MOVIE SEGMENT BY SEGMENT AND METHODS USEFUL IN CONJUNCTION THEREWITH

(76) Inventors: Nitzan Ben Shaul, Kfar Shmaryahu (IL); Noam Knoller, Amsterdam (NL); Udi Ben Arie, Tel Viv (IL); Guy Avneyon, Rishpon (IL)

(21) Appl. No.: 12/936,824

(22) PCT Filed: Apr. 7, 2009
(86) PCT No.: PCT/IL09/00397

§ 371 Date: Feb. 2, 2011

(30) Foreign Application Priority Data
Jul. 4, 2008 (US) 61042773

(51) Int. Cl. G06F 3/01

(52) U.S. Cl. 715/723

(57) ABSTRACT

A system and method for generating an interactive or non-interactive filmed branching narrative, the method comprising receiving a plurality of narrative segments, receiving and storing ordered links between individual ones of the plurality of narrative segments and generating a graphic display of at least some of the plurality of narrative segments and of at least some of the ordered links Additionally or alternatively, a system or method for generating a branched film, the method comprising generating an association between video segments and respectively script segments thereby to define film segments; and receiving a user's definition of at least one CTP defining at least one branching point from which a user-defined subset of said film segments are to branch off, and generating a digital representation of the branching point associating the user defined subset of the film segments with the CTP, thereby to generate a branched film element.

### REFERENCE TO CO-PENDING APPLICATIONS

Priority is claimed from U.S. provisional application No. 61/042,773, entitled “System, method and a computer readable medium for generating and displaying an interactive movie” and filed 7 Apr. 2008.

### FIELD OF THE INVENTION

The present invention relates generally to computerized systems for generating content and more particularly to computerized systems for generating video content.

### BACKGROUND OF THE INVENTION

Conventional technology pertaining to certain embodiments of the present invention is described inter alia in:

U.S. Pat. No. 5,805,784 to Crawford, entitled “Computer story generation system and method using network of re-usable substories”

U.S. Pat. No. 7,246,315 to Andrieu et al, entitled “ Interactive personal narrative agent system and method”

Bates, J. (1992), ‘Virtual Reality, Art, and Entertainment’, Presence: The Journal of Teleoperators and Virtual Environments, 1: 1, pp. 133-38.

Bordwell, D. (2002), ‘Film Futures’, SubStance 31.1, pp. 88-104

Brooks, K. (1999), Metalinear Cinematic Narrative: Theory, Process, and Tool, doctoral dissertation, Cambridge, Mass.: MIT.

Frome, J. and Smuts, A. (2004), ‘Helpless Spectators: Generating Suspense in Videogames and Film’, TEXT Technology, no. 1, pp. 13-34.

Inscape system, posted on the World Wide Web at inscapers.com.

Mateas, Michael and Stern, Andrew (2005) Façade, posted on the World Wide Web at interactivestory.net.

Murray, J. (1997), Hamlet on the Holodeck: The Future of Narrative in Cyberspace, New York: The Free Press.

Storyspace, software from Eastgate Systems referenced on the World Wide Web at eastgate.com.

Ciarlini, Angelo E. M. et al, “Planning and interaction levels for TV storytelling”, U. Spierling and N. Szilas (Eds.): ICIDS 2008, LNCS 5334, pp. 198-209, 2008, Springer-Verlag Berlin Heidelberg 2008.

Bae, Byung-Chull and R. Michael Young, “A user of flashback and foreshadowing for surprise arousal in narrative using a plan-based approach”, U. Spierling and N. Szilas (Eds.): ICIDS 2008, LNCS 5334, pp. 156-167, 2008, Springer-Verlag Berlin Heidelberg 2008.

Cheong, Yun-Gyung and R. Michael Young, “Narrative generation for suspense: modeling and evaluation”, U. Spierling and N. Szilas (Eds.): ICIDS 2008, LNCS 5334, pp. 144-155, 2008, Springer-Verlag Berlin Heidelberg 2008.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide an improved system and method for generating hyper-narrative interactive movies.

There is thus provided, in accordance with at least one embodiment of the present invention, a method for generating a filmed branching narrative, the method comprising receiving a plurality of narrative segments, receiving and storing ordered links between individual ones of the plurality of narrative segments and generating a graphic display of at least some of the plurality of narrative segments and of at least some of the ordered links.

The terms “filmed branching narrative”, “hyper-narrative film” and “branched film” are used generally interchangeably and may include non-interactive films; It is appreciated that a branched film need not provide an interactive functionality for selecting one or another of the branches. The terms “interactive hypernarrative” and “interactive movie” are used generally interchangeably. The terms “film” and “movie” are used generally interchangeably.

Also provided, in accordance with at least one embodiment of the present invention, is a method for generating a branched film, the method comprising generating an association between video segments and respectively script segments thereby to define film segments; and receiving a user's definition of at least one CTP (Crucial Transitional point) defining at least one branching point from which a user-defined subset of the film segments are to branch off, and generating a digital representation of the branching point associating the user defined subset of the film segments with the CTP, thereby to generate a branched film element.

Also provided, in accordance with at least one embodiment of the present invention, is a system for generating a filmed branching narrative, the system comprising an apparatus for receiving a plurality of narrative segments, and an apparatus for receiving and storing ordered links between individual ones of the plurality of narrative segments and for generating a graphic display of at least some of the plurality of narrative segments and of at least some of the ordered links.

Further in accordance with at least one embodiment of the present invention, the system also comprises a track player operative to accept a viewer's definition of a track through the filmed branching narrative and to play the track to the viewer.

Still further in accordance with at least one embodiment of the present invention, the narrative segment comprises a script segment including digital text.

Additionally in accordance with at least one embodiment of the present invention, the narrative segment comprises a multi-media segment including at least one of an audio sequence and a visual sequence.

Further in accordance with at least one embodiment of the present invention, the system also comprises an apparatus for receiving and storing, for at least one individual segment from among the plurality of narrative segments, at least one segment property characterizing the individual segment.

Still further in accordance with at least one embodiment of the present invention, the ordered links each define a node interconnecting individual ones of the plurality of narrative segments and wherein the system also comprises apparatus for receiving and storing, for at least one node, at least one node property characterizing the node.

Further in accordance with at least one embodiment of the present invention, the system also comprises a linking rule repository storing at least one rule for generating a linkage characterization characterizing a link between individual segments as a function of at least one property defined for the individual segments; and a linkage characterization display generator displaying information pertaining to the linkage characterization.

Additionally in accordance with at least one embodiment of the present invention, the at least one segment property includes a set of characters associated with the segment.

Further in accordance with at least one embodiment of the present invention, the at least one segment property includes a plot outline associated with the segment.

Still further in accordance with at least one embodiment of the present invention, the receiving and storing includes selecting a point on the graphic display corresponding to an endpoint of a first narrative segment and associating a second narrative segment with the point.

Further in accordance with at least one embodiment of the present invention, the system also comprises a linking rule repository storing at least one rule for generating a linkage characterization characterizing a link between individual segments as a function of at least one property defined for the individual nodes; and a linkage characterization display generator displaying information pertaining to the linkage characterization.

Additionally in accordance with at least one embodiment of the present invention, the system also comprises a track generator operative to accept a user's definition of a track through the filmed branching narrative, to access stored segment properties associated with segments forming the track, and to display the stored segment properties to the user.

Further in accordance with at least one embodiment of the present invention, the at least one segment property includes a characterization of the segment in terms of conflict.

Also provided, in accordance with at least one embodiment of the present invention, is a method for playing an interactive movie, the method comprising receiving a hyper-narrative structure that comprises multiple narrative movie tracks, each narrative movie track is divided into dramatic segments culminating in an ending dramatic segment and crucial transitional points; wherein typically, a crucial transitional point facilitates a user's interactive transition from one dramatic segment of a first narrative movie track to another dramatic segment in that track, or to a dramatic segment of a second narrative movie track wherein typically, upon transiting to some ending dramatic segments no further transitions and crucial transitional points are available; and repeating the stages of playing to a user a dramatic segment; and allowing the user, at a crucial transitional point, to interact and transit to another dramatic segment or continue playing at least one dramatic segment without the user's intervention wherein typically, upon transiting to some ending dramatic segments no further transitions and crucial transitional points are available.

Also provided, in accordance with at least one embodiment of the present invention, is a method for generating an interactive movie, the method comprising receiving a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment in a second narrative movie track wherein typically, upon transiting to some ending dramatic segments no further transitions and crucial transitional points are available; and generating a graphical representation of the hyper-narrative structure.

Further provided, in accordance with at least one embodiment of the present invention, is a method for generating an interactive movie, the method comprising receiving a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment of a second narrative movie track wherein typically, upon transiting to some ending dramatic segments no further transitions and crucial transitional points are available; and storing the hyper-narrative structure.

Also provided, in accordance with at least one embodiment of the present invention, is a system for playing an interactive movie, the system comprising a memory unit for storing a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment of a second narrative movie track wherein typically, upon transiting to some ending dramatic segments no further transitions and crucial transitional points are available; a media player module that is adapted to play to the user a dramatic segment out of the stored dramatic segments; and an interface that is adapted to allow the user, at a crucial transitional point, to interact and transit to another dramatic segment or continue playing without the user's intervention at least one dramatic segment, wherein typically, upon transiting to some ending dramatic segments no further transitions and crucial transitional points are available.

Also provided, in accordance with at least one embodiment of the present invention, is a system for generating an interactive movie, the system comprising an interface that is adapted to receive a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment of a second narrative movie track wherein typically, upon transiting to some ending dramatic segments no further transitions and crucial transitional points are available; and a graphical module that is adapted to generating a graphical representation of the hyper-narrative structure.

Further provided, in accordance with at least one embodiment of the present invention, is a system for generating an interactive movie, the system comprising an interface, adapted to receive a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a another dramatic segment of a second narrative movie track wherein typically, upon transiting to some ending dramatic segments no further transitions and crucial transitional points are available; and a memory unit, adapted to store the hyper-narrative structure.

Further provided, in accordance with at least one embodiment of the present invention, is a computer readable medium that stores a hyper-narrative structure and to store instructions that when executed by a computer cause the computer to repeat the stages of: playing to a user a dramatic segment and allowing the user, at a crucial transitional point, to interact and transit to another dramatic segment or continue playing at least one dramatic segment without the user's intervention, wherein typically, upon transiting to some ending dramatic segments no further transitions and crucial transitional points are available; wherein typically, the hyper-narrative structure comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment in a second narrative movie track wherein typically, upon transiting to some ending dramatic segments no further transitions and crucial transitional points are available.

Additionally provided, in accordance with at least one embodiment of the present invention, is a computer readable medium that stores instructions that when executed by a computer cause the computer to receive a hyper-narrative structure that comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment in a second narrative movie track wherein typically, upon transiting to some ending dramatic segments no further transitions and crucial transitional points are available; and generate a graphical representation of the hyper-narrative structure.

Also provided, in accordance with at least one embodiment of the present invention, is a computer readable medium that stores instructions that when executed by a computer cause the computer to repeat the stages of: playing to a user a dramatic segment of a hyper-narrative structure and allowing the user, at a crucial transitional point, to interactively transit to another dramatic segment in that track or to a dramatic segment in a second narrative movie track or continue playing at least one dramatic segment without the user's intervention, wherein typically, upon transiting to some ending dramatic segments no further transitions and crucial transitional points are available; wherein typically, the hyper-narrative structure comprises multiple narrative movie tracks, each narrative movie track is divided into dramatic segments culminating in an ending dramatic segment, and crucial transitional points; wherein typically, a crucial transitional point facilitates a user's interactive transition from one dramatic segment of a first narrative movie track to another dramatic segment in that track or to a dramatic segment in a second narrative movie track wherein typically, upon transiting to some ending dramatic segments no further transitions and crucial transitional points are available.

Further in accordance with at least one embodiment of the present invention, the ordered links each comprise a graphically represented CTP and wherein typically, the apparatus for receiving and storing is operative to allow a new segment to be connected between any pair of CTPs.

Still further in accordance with at least one embodiment of the present invention, the apparatus for receiving and storing is operative to allow a new segment to be connected between an existing CTP and at least one of the following: an ancestor of the existing CTP; and a descendant of the existing CTP.

Additionally in accordance with at least one embodiment of the present invention, the editing functionality includes at least some Word XML editor functionalities.

Further in accordance with at least one embodiment of the present invention, the apparatus for receiving and storing includes an option for connecting at least first and second user-selected tracks each including at least one CTP, by generating a segment starting at a CTP of the first track and ending at a CTP in the second track.

Also provided, in accordance with at least one embodiment of the present invention, is a system for generating a branched film, the system comprising apparatus for generating an association between video segments and respectively script segments thereby to define film segments; and a CTP manager operative to receive a user's definition of at least one CTP defining at least one branching point from which a user-defined subset of the film segments are to branch off, and to generate a digital representation of the branching point associating the user defined subset of the film segments with the CTP, thereby to generate a branched film element.

Further in accordance with at least one embodiment of the present invention, the segment property includes a characterization of a segment as one of an opening segment, regular segment, connecting segment, looping segment, and ending segment.

Additionally in accordance with at least one embodiment of the present invention, the graphic display of at least some of the plurality of narrative segments and of at least some of the ordered links comprises a graphic display generated in accordance with an interlacer condition, wherein the interlacer condition comprises a request to display all ending segments.

Further in accordance with at least one embodiment of the present invention, the graphic display of at least some of the plurality of narrative segments and of at least some of the ordered links comprises a graphic display generated in accordance with an interlacer condition, wherein the interlacer condition comprises a request to display all looping segments.

Further in accordance with at least one embodiment of the present invention, the segment property includes a list of at least one obstacle present in the segment.

Still further in accordance with at least one embodiment of the present invention, each obstacle is associated with a character in the segment. The term “characters” as used herein refers to protagonists, antagonists, or other human or animal or fanciful figures which speak in, are active in or are otherwise involved in, a narrative.

Additionally in accordance with at least one embodiment of the present invention, the graphic display of at least some of the plurality of narrative segments and of at least some of the ordered links comprises a graphic display generated in accordance with an interlacer condition, wherein the interlacer condition comprises a request to display obstacles for character x in an order of appearance defined by a previously determined order of the segments.

Further in accordance with at least one embodiment of the present invention, the node property comprises a characterization of each node as at least a selected one of: a splitting node, non-splitting node, expansion node, contraction node, breakaway node.

Additionally in accordance with at least one embodiment of the present invention, the graphic display of at least some of the plurality of narrative segments and of at least some of the ordered links comprises a graphic display generated in accordance with an interlacer condition, wherein the interlacer condition comprises a request to display all non-splitting nodes, thereby to facilitate identification by a human user of potential splittings.

Further in accordance with at least one embodiment of the present invention, the system also comprises a branched film player operative to play branched film elements generated by the CTP manager. Also provided, in accordance with at least one embodiment of the present invention, is a computer program product, comprising a computer usable medium having a computer readable program code embodied therein, the computer readable program code adapted to be executed to implement any of the methods shown and described herein.

Further in accordance with at least one embodiment of the present invention, the system also comprises an editing functionality allowing each narrative segment to be text-edited independently of other segments.

Still further in accordance with at least one embodiment of the present invention, the track player is operative to accept a user's definitions of a plurality of tracks through the filmed branching narrative and to play any selected one of the plurality of tracks to the viewer according to the user's intervention.

Also provided, in accordance with at least one embodiment of the present invention, is a hyper narrative authoring system comprising apparatus for generating a schema object which passes on, to a production environment, a set of at least one condition including computation of how to translate user's behavior to a next segment to play.

Further in accordance with at least one embodiment of the present invention, the schema object is structured to support a human author's use of natural language pertaining to narrative to characterize branching between segments and to associate the natural language with at least one of an input device or Graphic User Interface components used to implement the branching.

Still further in accordance with at least one embodiment of the present invention, the schema object is operative to store a breakdown of natural language into objects.

Additionally in accordance with at least one embodiment of the present invention, the objects comprise at least one of “idioms” and “targets”.

Further in accordance with at least one embodiment of the present invention, the system is also operative to display simulations of interactions.

Still further in accordance with at least one embodiment of the present invention, the conditions are stored in association with respective nodes interconnecting branching narrative segments.

Further in accordance with at least one embodiment of the present invention, the conditions are defined over CTP properties defined for at least one of the nodes.

Many variations, examples and applications of the above are described in detail herein. To give one example, a sequence of segment script outlines may be presented from CTP n to CTP (n+m), thereby to ease identification by a human user, of lacking information when two segments are interlaced.

The authoring environment shown and described herein is typically operative such that the HNIM_schema object passes on, to the production environment, a list of conditions (defined e.g. over the CTP properties) on how to translate the user's actions and behavior to the next segment to play. Since the CTP is the point of branching, the CTP is typically where the author sets the conditions. In contrast, in conventional hypertext models including recent hypercinema such as the Danish model for interactive cinema (e.g. “D-dag”, “Switching”), no computation takes place at the point of branching. A particular advantage of certain embodiments is that the author can work on the interaction model using high level, dramatic terms and non-formal language which are meaningful to her or him. Rather than the system forcing the user to think in terms of “click on the mouse and drag an object until it touches the hotspot”, the system supports the user in terms meaningful to him for the same operation, such as: “hide the photo under the carpet”. And yet, despite using natural language, such as English, by breaking the natural language down to objects such as “idioms” and “targets” e.g. as described herein, particularly with reference to the interaction-model editor, the system shown and described herein can perform and display simulations of the interaction.

Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display, store and accept information, including computer programs, in accordance with some or all of the teachings of the present invention, such as but not limited to a conventional personal computer processor, workstation or other programmable device or computer or electronic computing device, either general-purpose or specifically constructed, for processing; a display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may whereever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1 is a diagram of a hyper-narrative data structure according to an embodiment of the invention.

FIG. 2 is a diagram of an expected response to a dramatic segment according to an embodiment of the invention.

FIG. 3 is a diagram of a crucial transitional point according to an embodiment of the invention.

FIG. 4 is a simplified functional block diagram of a computerized system for generating hyper-narrative interactive movies including movie segments mutually interconnected at nodes, also termed herein CTPs, the system typically including apparatus for storing and employing characteristics of at least one segment and/or CTP and apparatus for generating a branching final product based on user inputs at the narrative level, all in accordance with certain embodiments of the present invention.

FIG. 5 is a simplified flowchart illustration of a method for displaying an interactive movie, according to an embodiment of the invention.

FIG. 6 is a simplified flowchart illustration of a method for generating an interactive movie, according to an embodiment of the invention.

FIG. 7 is a simplified flowchart illustration of a method for generating an interactive movie, according to an embodiment of the invention.

FIG. 8 is a simplified functional block diagram illustration of a system for playing an interactive movie according to an embodiment of the invention.

FIG. 9 is a simplified functional block diagram illustration of a system for generating an interactive movie according to an embodiment of the invention.

FIGS. 10-38B taken together illustrate an example of an implementation of the computerized hyper-narrative interactive movie generating system of FIG. 4. Specifically:

FIGS. 10-15 are Script Editor Properties data tables which may be formed and/or used by the Hyper-Narrative Interactive Script editor of FIG. 4, according to certain embodiments of the present invention.

FIGS. 16A-18B together comprise an example of a suitable GUI for the Hypernarrative Script Editor of FIG. 4, according to certain embodiments of the present invention.

FIGS. 19-20 illustrate example screen shots on which GUIs for a segment property editing functionality and a character property editing functionality, typically provided as part of hyper-narrative editor 20 of FIG. 4, may be based, according to certain embodiments of the present invention.

FIG. 21A is a simplified flowchart illustration of operations performed by the script editor in FIG. 4, according to a first embodiment of the present invention.

FIG. 21B is a simplified flowchart illustration of operations performed by the script editor in FIG. 4, according to a second embodiment of the present invention.

FIG. 22 is a simplified functional block diagram illustration of the interaction model editor of FIG. 4, according to certain embodiments of the present invention.

FIG. 23 is a simplified functional block diagram illustration showing definitions of idioms and behaviors being generated in the interaction model editor of FIG. 4, by an actions and gestures editor operating in conjunction with the production environment and hyper-narrative editor, both of FIG. 4, according to certain embodiments of the present invention.

FIGS. 24A-24C illustrate data structures which may be used by the authoring system 15 of FIG. 4, according to certain embodiments of the present invention.

FIGS. 25-32B illustrate an example work session using the authoring environment of FIG. 4 including the interaction model editor and interlacer of FIG. 4, according to certain embodiments of the present invention.

FIGS. 33A-33B are screenshots exemplifying a suitable GUI for the Interlacer of FIG. 4, according to certain embodiments of the present invention.

FIG. 34 is a simplified flowchart illustration of methods which may be performed by the production environment of FIG. 4, including the interaction media editor thereof, according to certain embodiments of the present invention.

FIG. 35 is a screenshot exemplifying a suitable GUI (graphic user interface) for the production environment of FIG. 4, according to certain embodiments of the present invention.

FIG. 36 is a simplified flowchart illustration of methods which may be performed by the player module of FIG. 4, according to certain embodiments of the present invention.

FIGS. 37A-37D, taken together, are an example of a work session in which a human user interacts with the screen editor of FIG. 4, via an example GUI, in order to generate an HNIM (hyper-narrative interactive movie) in accordance with certain embodiments of the present invention.

FIG. 38A illustrates an example of a suitable HNIM Story XML File Data Structure, according to certain embodiments of the present invention.

FIG. 38B illustrates an example of a suitable HNIM XML File Data Structure for the production environment of FIG. 4, according to certain embodiments of the present invention.

### DETAILED DESCRIPTION OF CERTAIN EMBODIMENTS

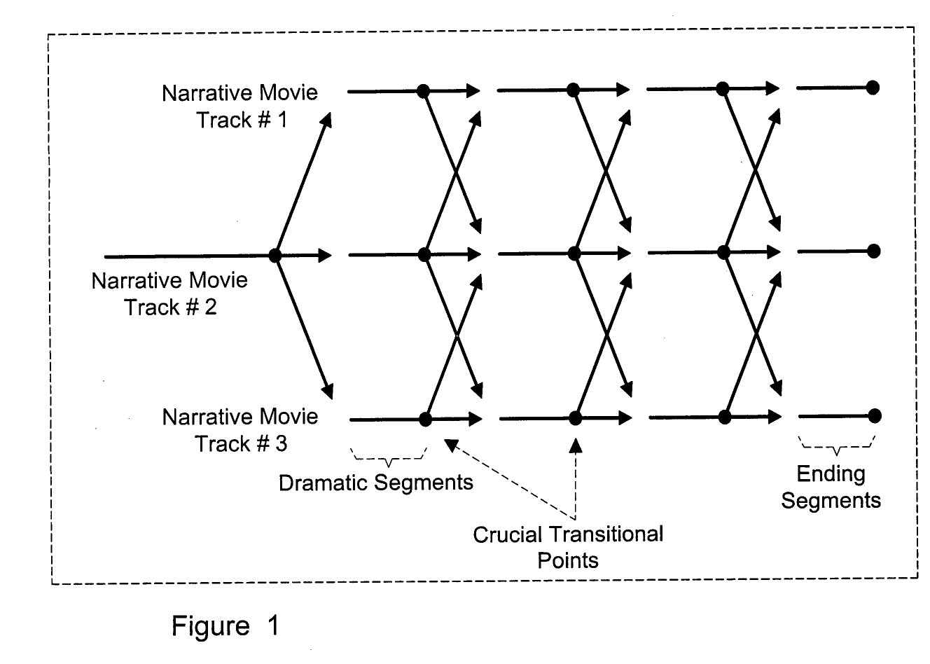

FIG. 1 illustrates a hyper-narrative structure according to an embodiment of the invention. Typically, the hyper-narrative structure includes multiple narrative movie tracks with each narrative movie track divided into dramatic segments culminating in an ending dramatic segment, and crucial transitional points. A crucial transitional point facilitates a user's interactive transition from one dramatic segment of a first narrative movie track to another dramatic segment of the same narrative movie track or a dramatic segment of a second narrative movie track wherein upon transiting to some ending dramatic segments no further transitions and crucial transitional points are available.

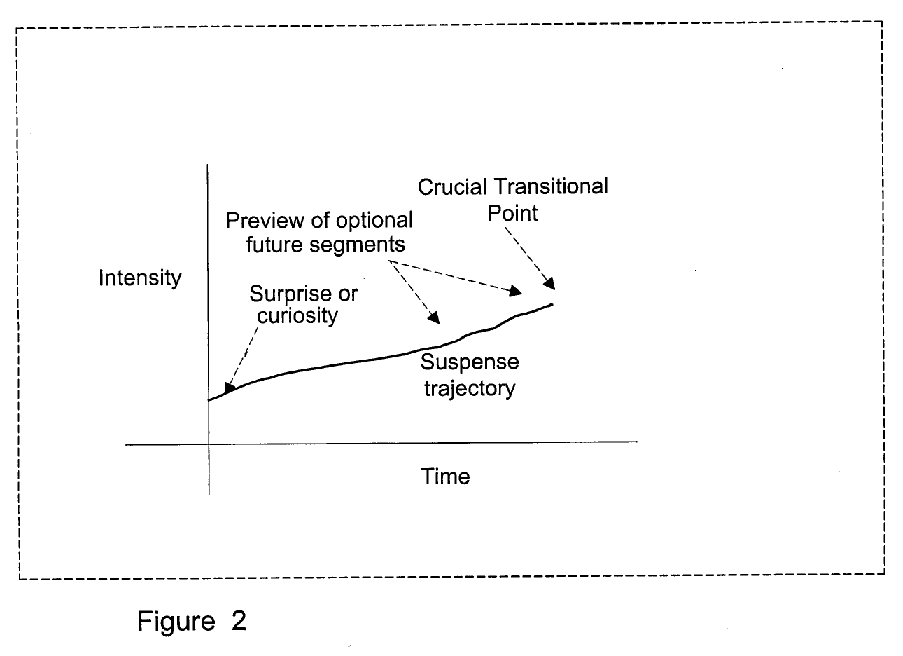

A dramatic segment typically includes a dramatically ambiguous succession of events, occurring to unpredictable protagonists towards whom a user (also referred to as an interactor) feels empathy and who often work counter to the user's common sense expectations regarding which behavior fits what given situation, as illustrated in FIG. 2 and as described herein.

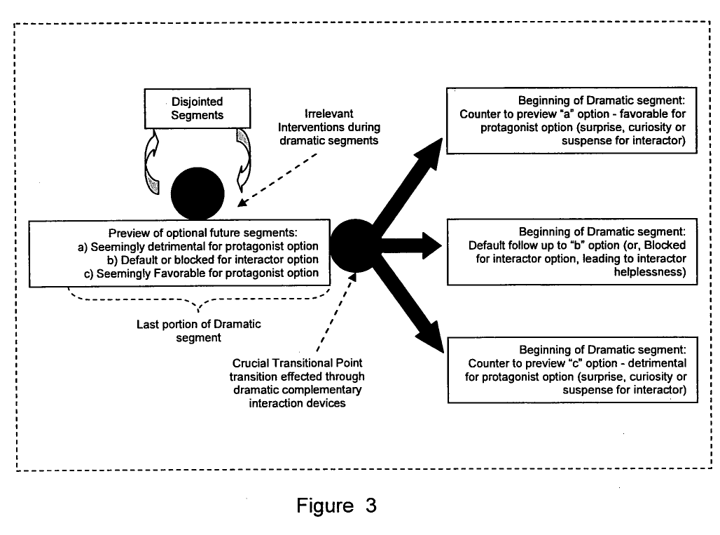

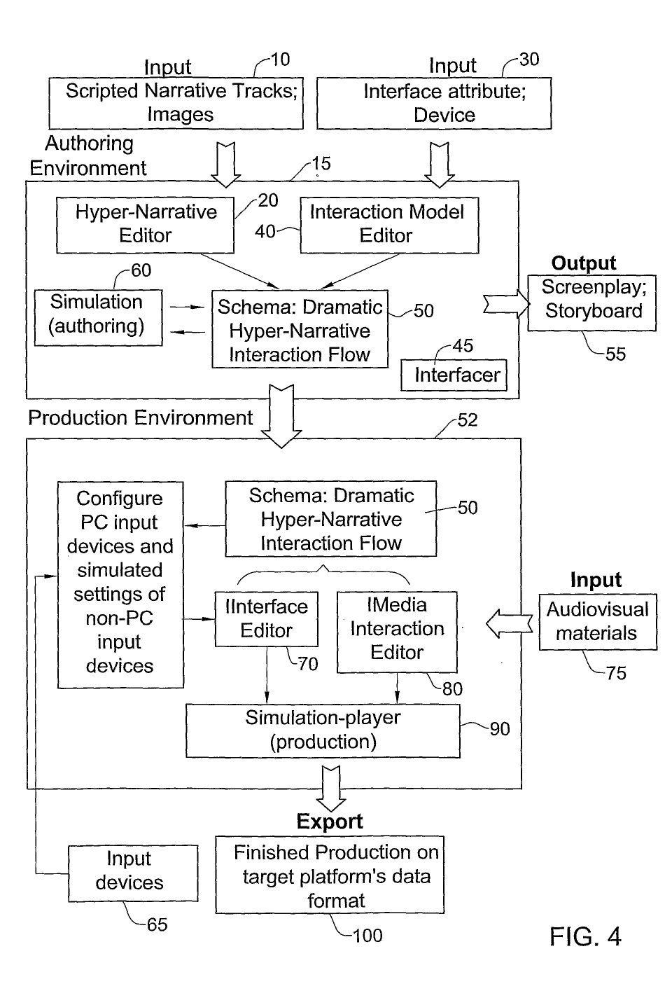

A crucial transitional point can be preceded by one or more actions and can be followed by one out of multiple different dramatic segments of different narrative movie tracks, as described herein generally and as illustrated in FIG. 3. It is noted that crucial transitional points can be computed to dramatically, logically, emotionally and coherently evoke in the interactor the desire to behaviorally intervene only at these points. This is usually evoked when the interactor is led by the drama to raise hypothetical conjectures, such as ‘what if the protagonist did that’ or ‘if only the protagonist had done that’; when the interactor is drawn to help the protagonist by alerting him/her to approaching danger; by reminding the protagonist of something he left behind and which could turn out to be detrimental; or when the protagonist asks the interactor to assist him/her in a task. The scenes evoking hypothetical conjectures, etc. can be labeled and stored in a data structure such as a list. A hyper-narrative structure can be received and processed in an authoring environment 15 and in a production environment 52, as described herein and as illustrated in FIG. 4.

The authoring environment 15 can include a hyper-narrative editor, an interaction model editor, and a simulation module. It can receive as input scripted narrative tracks and interface attributes and output a scheme of dramatic hyper-narrative interaction flow.

The output of the interaction model editor typically comprises an “interaction model”. The interaction model defines input channels required for a hyper-narrative interactive movie interface, both globally and for each crucial transitional point or for each dramatically unintended intervention. The authoring environment includes a dynamic model of the interactor, and dynamically changes the mapping between interactor behaviors and narrative tracks based on an interpretation of the interactor model.

An “Interaction idiom” typically comprises a set of labels that describe interactor actions or behaviors and optional responses. These labels describe the interactor's optional actions as they are played out in the movie world. Pressing the mouse can be labeled as “knocking on glass” and dragging the mouse as “scratching on glass”. Interactor optional behaviors can be labeled as “empathy”, “hostility” “apathy” or “helplessness”. The idioms typically link between what the interactor does behaviorally and the options of the system's response, labeled as: “forward unpredictable dramatic segment x”, forward default segment y” or “forward helplessness segment z”.

The hyper-narrative editor labels different dramatic segments or portions thereof. These “sets of labels” are stored in a list. One set of labels indicates which dramatic segment can relate logically, coherently, engagingly, dramatically (e.g., in unpredictable manner), narratively and audiovisually to which other dramatic segments (these labels are stored in a list). One set of labels indicates which groupings of dramatic segments can relate logically, coherently, engagingly, dramatically, narratively and audiovisually to which consequent dramatic segment or which groupings of consequent dramatic segments (these labels are stored in a list). One set of labels may be for the different ending segments, labeled in such manner that indicates to which preceding grouping of dramatic segments played they can relate in a logical, coherent, engaging, dramatic, narrative and audiovisual way to form consistent narrative closure.

Typically a construction of a knowledge gap may be provided and can be used to the interactor's favor: the interactor gains knowledge that the protagonist lacks about the different possible dramatic options the protagonist is about to face in a putative future dramatic segment through placing cinematic compositions such as flash forwards, flashbacks, shot/reaction shot constructs, split screens, morphing, looping or shift in camera point of view towards the end of dramatic segments. These compositions are labeled in the hyper-narrative editor indicating into what dramatic segments they can be incorporated and to which dramatic segment's beginning they can be related after crucial transitional points.

Dramatic segments and portions thereof are labeled in a list for re-usability.

One of the possible future events intimated to the interactor before he/she is lured to behaviorally intervene cannot be shifted to, despite the interactor's desire and attempt to do so. This deliberate thwarting of the interactor's preferred intervention evokes the interactor's suspenseful helplessness due to his/her following the protagonist into trouble, from which s/he cannot safeguard the protagonist. Such scenes are labeled “helplessness” and are stored in a list.

Any instructions to the interactor on when, what type of interaction idioms he can use, and how these may affect a narrative shift are made known dramatically from within the narrative world. The instructions for the interactor scenes are labeled and stored in an “interactor instructions” list that includes subsets of labels. One set includes labels such as “protagonist/narrator voice-over/audiovisual composition addresses interactor through ‘direct’ or ‘indirect’ ways”. Under “direct” ways a subset of instructions includes “talks/signals directly to interactor” whereas under “indirect” ways a subset of instructions includes “hints to interactor”.

The authoring and production environments allow for simulations of hyper-narrative and interactive transitions.

The production environment allows adaptation to different formats (PC, DVD, Mobile Device, Game Consoles, etc.).

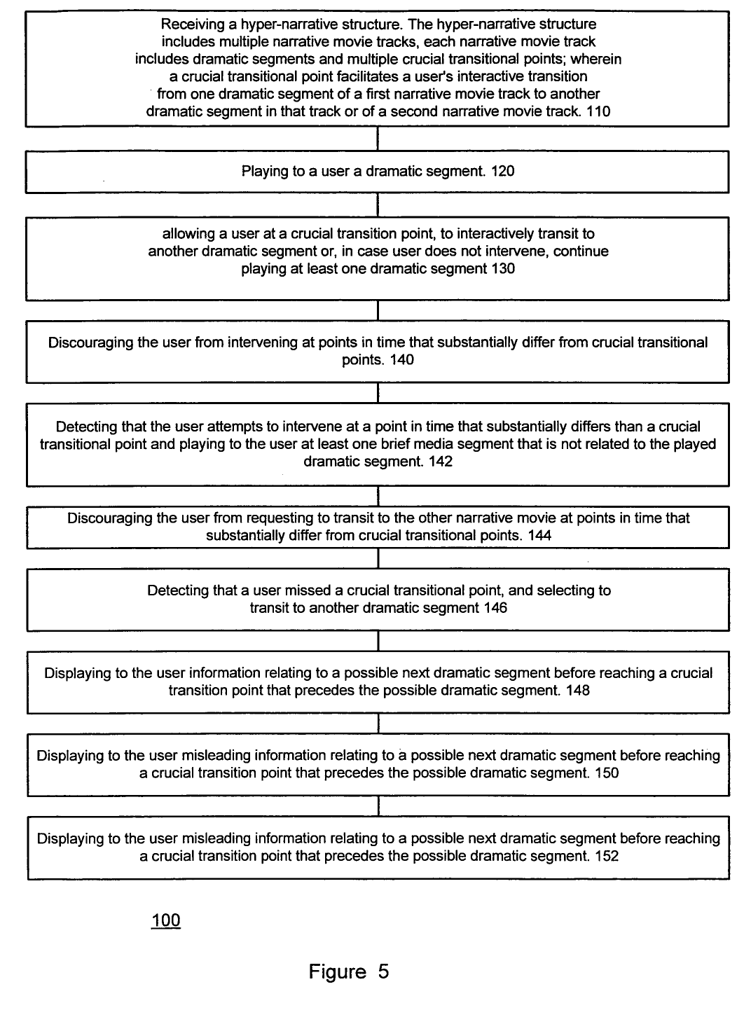

FIG. 5 illustrates a method 100 for displaying an interactive movie, according to an embodiment of the invention.

Method 100 can start by stage 110 of receiving a hyper-narrative structure.

Stage 110 can be followed by stage 120 of playing to a user a dramatic segment.

Stage 120 may be followed by stage 130 of allowing a user at a crucial transitional point, to interact and transit to another segment in that track or to a segment in another narrative movie track or continue playing at least one dramatic segment without the user's intervention wherein upon transiting to some ending dramatic segments no further transitions and crucial transitional points are available. Stage 130 can be viewed as allowing the user, at a crucial transitional point, to select between to select, at a crucial transitional point, whether to interact and transit to another segment in that track or to a segment in another narrative movie track or continue playing at least one dramatic segment without the user's intervention. The selection can be inferred from a reaction of the user to the interactive movie.

Stage 130 can be followed by stage 120 until the displaying of the movie ends.

Method 100 can also include at least one of the additional stages or a combination thereof: (i) stage 140 of discouraging the user from intervening at points in time that substantially differ from crucial transitional points; (ii) stage 142 of detecting that the user attempts to intervene at a point in time that substantially differs from a crucial transitional point and playing to the user at least one brief media segment that is not related to the played dramatic segment; (iii) stage 144 of discouraging the user from attempting to intervene at points in time that differ from crucial transitional points; (iv) stage 146 of detecting that a user missed a crucial transitional point, and selecting to transit to another narrative segment; (v) stage 148 of displaying to the user information relating to a possible next dramatic segment before reaching a crucial transitional point that precedes the possible dramatic segment; (vi) stage 150 of displaying to the user misleading information relating to a possible next dramatic segment before reaching a crucial transitional point that precedes the possible dramatic segment; (vii) stage 152 of displaying to the user misleading information relating to a possible next dramatic segment before reaching a crucial transitional point that precedes the possible dramatic segment.

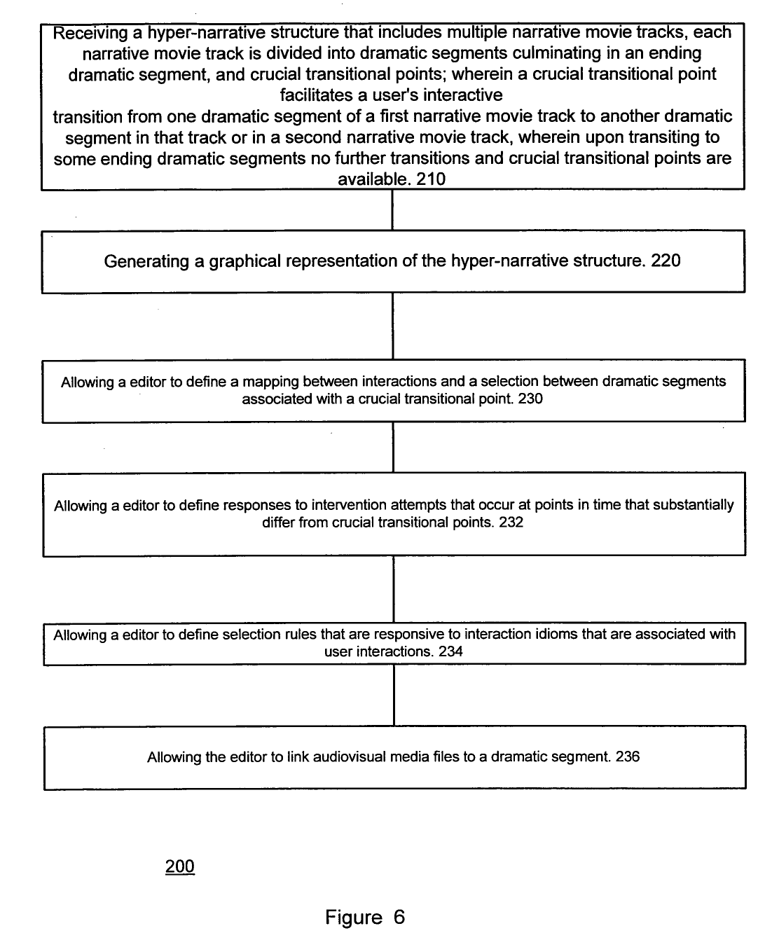

FIG. 6 illustrates method 200 for generating an interactive movie, according to an embodiment of the invention.

Method 200 starts by stage 210 of receiving a hyper-narrative structure that includes multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available. The hyper-narrative structure can include narrative movie tracks (for example three or four narrative movie tracks) but this is not necessarily so.

Stage 210 may be followed by stage 220 of generating a graphical representation of the hyper-narrative structure.

Method 200 can also include at least one of the additional stages or a combination thereof: (i) stage 230 of allowing an editor to define a mapping between interactions and a selection between dramatic segments associated with a crucial transitional point; (ii) stage 232 of allowing an editor to define responses to intervention attempts that occur at points in time that substantially differ from crucial transitional points; (iii) stage 234 of allowing an editor to define selection rules that are responsive to interaction idioms that are associated with user interactions; (v) stage 236 of allowing the editor to link audiovisual media files to a dramatic segment.

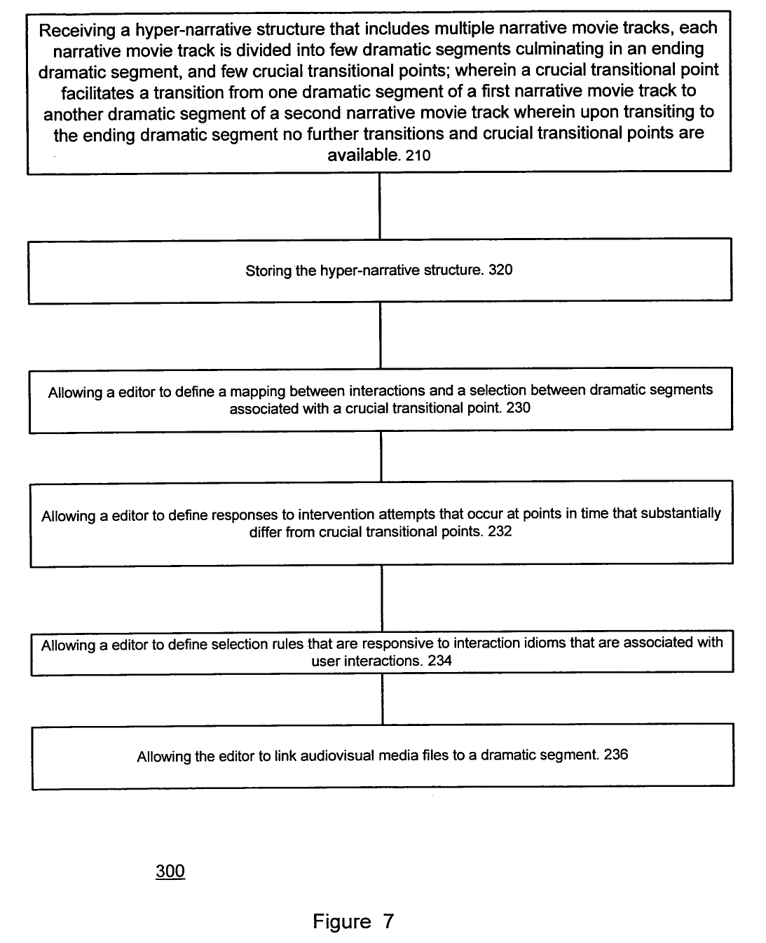

FIG. 7 illustrates method 300 for generating an interactive movie, according to an embodiment of the invention. Method 300 starts by stage 310 of receiving a hyper-narrative structure that includes multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available. Stage 310 may be followed by stage 320 of storing the hyper-narrative structure.

Method 300 can also include at least one of the additional stages or a combination thereof: (i) stage 230 of allowing an editor to define a mapping between interactions and a selection between dramatic segments associated with a crucial transitional point; (ii) stage 232 of allowing an editor to define responses to intervention attempts that occur at points in time that substantially differ from crucial transitional points; (iii) stage 234 of allowing an editor to define selection rules that are responsive to interaction idioms that are associated with user interactions; (v) stage 236 of allowing the editor to link audiovisual media files to a dramatic segment.

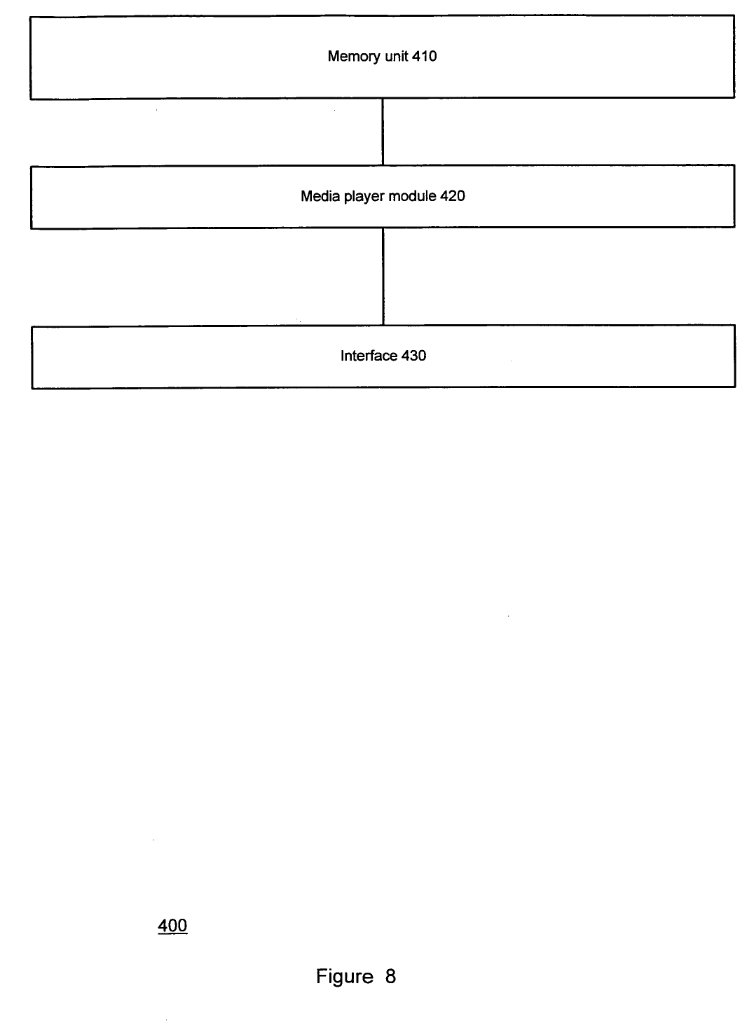

FIG. 8 illustrates system 400 for playing an interactive movie according to an embodiment of the invention. System 400 includes memory unit 410 for storing a hyper-narrative structure that includes multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available. System 400 also includes media player module 420 that may be adapted to play to the user a dramatic segment out of the stored dramatic segments; and interface 430 that may be adapted to allow the user, at a crucial transitional point, to interactively transit to another narrative movie track or continue playing at least one dramatic segment without the user's intervention and until the ending dramatic segment. System 400 can execute method 200.

System 400 can also perform at least one of the following operations: (i) discourage the user from intervening at points in time that differ from crucial transitional points; (ii) detect that the user attempts to intervene at a point in time that substantially differs from a crucial transitional point and playing to the user at least one brief media segment that is not related to the played dramatic segment; (iii) discourage the user from requesting to transit to other dramatic segments at points in time that are not crucial transitional points; (iv) detect that a user missed a crucial transitional point, and select whether to transit to another narrative movie track or continue playing at least one dramatic segment without transiting to another narrative movie track until the ending dramatic segment; (v) display to the user information relating to a possible next dramatic segment before reaching a crucial transitional point that precedes the possible dramatic segment; (vi) display to the user misleading information relating to a possible next dramatic segment before reaching a crucial transitional point that precedes the possible dramatic segment; (vii) display to the user misleading information relating to a possible next dramatic segment before reaching a crucial transitional point that precedes the possible dramatic segment.

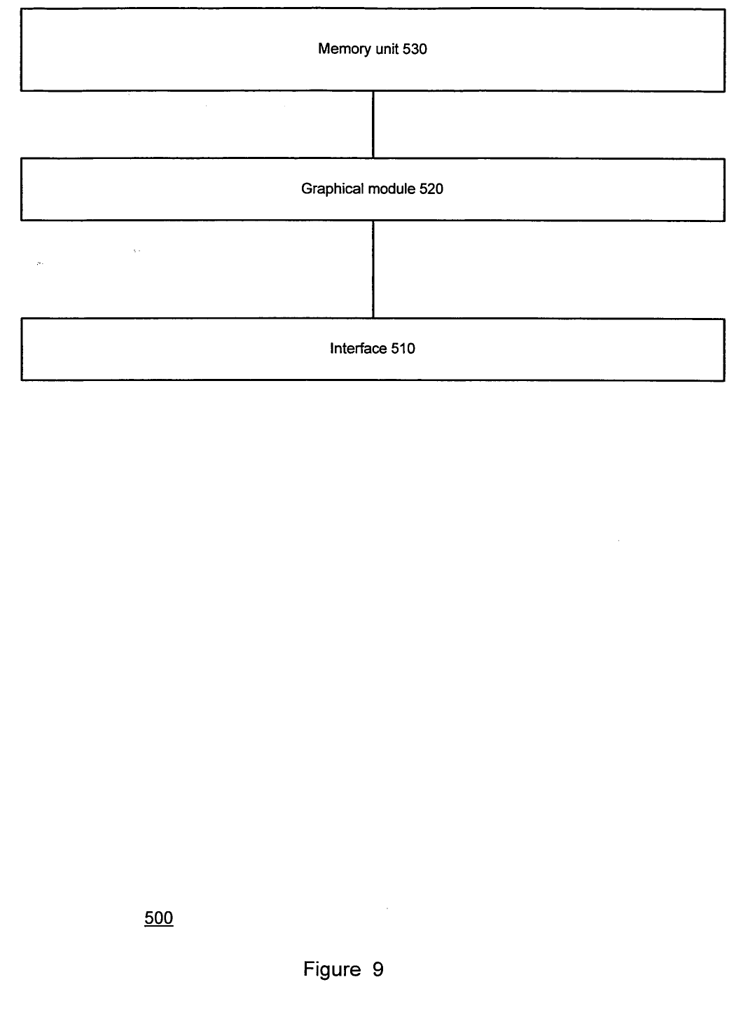

FIG. 9 illustrates system 500 for generating an interactive movie according to an embodiment of the invention. System 500 can include the production environment and/or the authoring environment of FIG. 4. System 500 includes interface 510. System 500 can include memory unit 530 and additionally or alternatively graphical module 520. Interface 510 receives a hyper-narrative structure that includes multiple narrative movie tracks with each narrative movie track divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available. Graphical module 520 may be adapted to generating a graphical representation of the hyper-narrative structure.

System 500 can allow a user to perform at least one of the following operations: (i) define a mapping between interactions and a selection between dramatic segments associated with a crucial transitional point; (ii) define responses to intervention attempts that occur at points in time that substantially differ from crucial transitional points; (iii) define selection rules that are responsive to interaction idioms that are associated with user interactions; (iv) link audiovisual media files to a dramatic segment.

Memory unit 530 can store the hyper-narrative structure.

A computer readable medium can be provided. It is tangible and it stores instructions that when executed by a computer cause the computer to repeat the stages of: playing to a user a dramatic segment and allowing the user, at a crucial transitional point, to interactively transit to another dramatic segment in that track or to a dramatic segment in a second narrative movie track or continue playing at least one dramatic segment without the user's intervention and until the ending dramatic segment; wherein the hyper-narrative structure includes multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available. The computer readable medium can also store the hyper-narrative structure.

Typically the computer readable medium stores instructions that when executed by a computer cause the computer to discourage the user from intervening at points in time that differ from crucial transitional points.

Typically the computer readable medium stores instructions that when executed by a computer cause the computer to detect that the user attempts to intervene at a point in time that differs from a crucial transitional point and play to the user at least one brief media segment that is not related to the played dramatic segment.

Typically the computer readable medium stores instructions that when executed by a computer cause the computer to discourage the user from requesting to transit to a different dramatic segment at points in time that differ from crucial transitional points. Typically the computer readable medium stores instructions that when executed by a computer cause the computer to detect that a user missed a crucial transitional point, and select whether to transit to another dramatic segment in that track or to a dramatic segment in a second narrative movie track, or continue playing at least one dramatic segment without transiting to another narrative movie track until the ending dramatic segment.

Typically the computer readable medium stores instructions that when executed by a computer cause the computer to display to the user information relating to a possible next dramatic segment before reaching a crucial transitional point that precedes the possible dramatic segment.

Typically the computer readable medium stores instructions that when executed by a computer cause the computer to display to the user misleading information relating to a possible next dramatic segment before reaching a crucial transitional point that precedes the possible dramatic segment.

Typically the computer readable medium stores instructions that when executed by a computer cause the computer to display to the user misleading information relating to a possible next dramatic segment before reaching a crucial transitional point that precedes the possible dramatic segment.

A computer readable medium is provided. It stores instructions that when executed by a computer cause the computer to: receive a hyper-narrative structure that includes multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to another dramatic segment in that track or to a dramatic segment of a second narrative movie track wherein upon transiting to some ending dramatic segments no further transitions and crucial transitional points are available; and generate a graphical representation of the hyper-narrative structure.

Typically the computer readable medium stores instructions that when executed by a computer cause the computer to allow a user to define a mapping between interactions and a selection between dramatic segments associated with a crucial transitional point.

Typically the computer readable medium stores instructions that when executed by a computer cause the computer to allow a user to define responses to intervention attempts that occur at points in time that differ from crucial transitional points.

Typically the computer readable medium stores instructions that when executed by a computer cause the computer to allow a user to define selection rules that are responsive to interaction idioms that are associated with user interactions.

Typically the computer readable medium stores instructions that when executed by a computer cause the computer to allow a user to link audiovisual media files to a dramatic segment.

A suitable Model and Platform for Authoring Hyper-Narrative Interactive Movies is now described in detail, still with reference to FIGS. 1-9 and particularly FIG. 4. The system of FIG. 4 is also termed herein an “HNIM” system and a Hyper-Narrative Interactive Movie generated by the system is also termed herein an “HNIM”. The system receives and/or generates a hyper-narrative structure that includes an environment that enables such a hyper-narrative structure to be stored, processed, and at least portions thereof to be stored. The system of FIG. 4 may serve as an authoring platform for creating a computer-mediated interaction between users or interactors' and narrative movies.

A software application of the system shown and described herein may include:
a. An authoring environment or “script editor” 15 which enables the author to design and plan ahead the structure of the dramatic hyper-narrative flow as well as the interaction model, prior to production. This module can also export a written screenplay, a visual storyboard or a combination thereof; and
b. A production environment 52 in which completed audiovisual materials may be connected to the structure created in the authoring environment. With the interface and media present, the author may still be able to modify the structure according to artistic and usability-related changes emerging from the production of the HNIM.

Certain embodiments of the various functional components of the two environments are now described in detail. The input to the system may include scripted narrative tracks and/or images, referenced 10 in the functional block diagram of FIG. 4. Typically, the human author enters into the script editor 15, pre-written portions of scripts including different narrative tracks and an initial branching of these. Alternatively, the author can start writing from scratch using the script editor, and branch the resulting narrative as appropriate, also using the script editor. Another optional input to the script editor 15 is interface attribute device characterization information 30 which is typically stored in a list and handled by an interaction-model editor device list manager in interaction model editor 40 as described in detail below.

The output which script editor 15 typically passes over to production environment 52 typically includes a schema 50 representing a dramatic hyper-narrative interaction flow and may comprise at least one software object. Typically, the Schema 50 includes all data objects employed by editors 20 and 40 in the authoring environment. Schema 50 typically includes a script, associated with all the data stored in runtime in HNIM_schema.script and HNIMS_schema.interaction-model objects, as described in detail below, particularly with reference to the description of a suitable script properties data structure herein below. Typically, all script properties data generated using the script editor 15 are stored as properties of the HNIM schema object 50. Alternatively, functionality is provided which passes on to the production environment 52 only those script properties that the production environment requires rather than the entire contents of the script properties data structure.

A simulation generator 60 is typically operative to simulate all possible narrative tracks' flow, from the beginning to the end of an HNIM. The simulation typically starts at a chosen segment by showing the current position in an “HNIM Map” and presents the corresponding segment script text, typically stored as “property HNIM_script.Narrative_track.Segment.ID. Script_text”, as described in detail below. Subsequently, the system presents CTP branching possibilities that can follow the current segment, which possibilities may be stored as “property [HNIM_script.Narrative_track.Segment.CTP.ID. Intervention. ID. Next-segment[n])”, as described in detail below. The user then specifies which presumed viewer/user intervention she or he chooses to follow. Subsequently the system presents the next chosen segment by showing the current position on the “HNIM Map” while presenting the corresponding segment script text property and so on. The user's evolving segment trajectory is also shown simultaneously in the “HNIM Map” where the traversed segments may be colored, allowing a user to trace his moves.

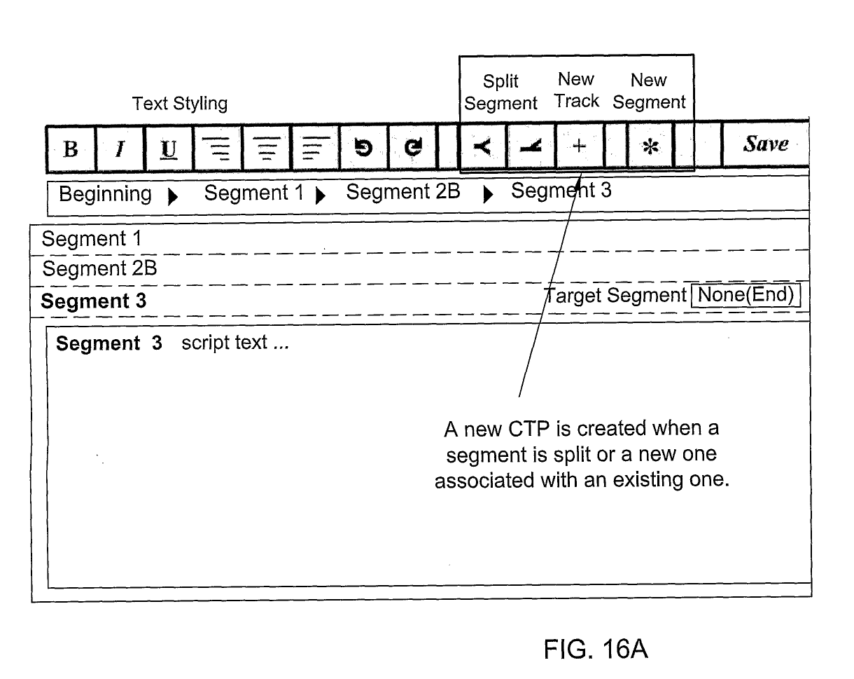

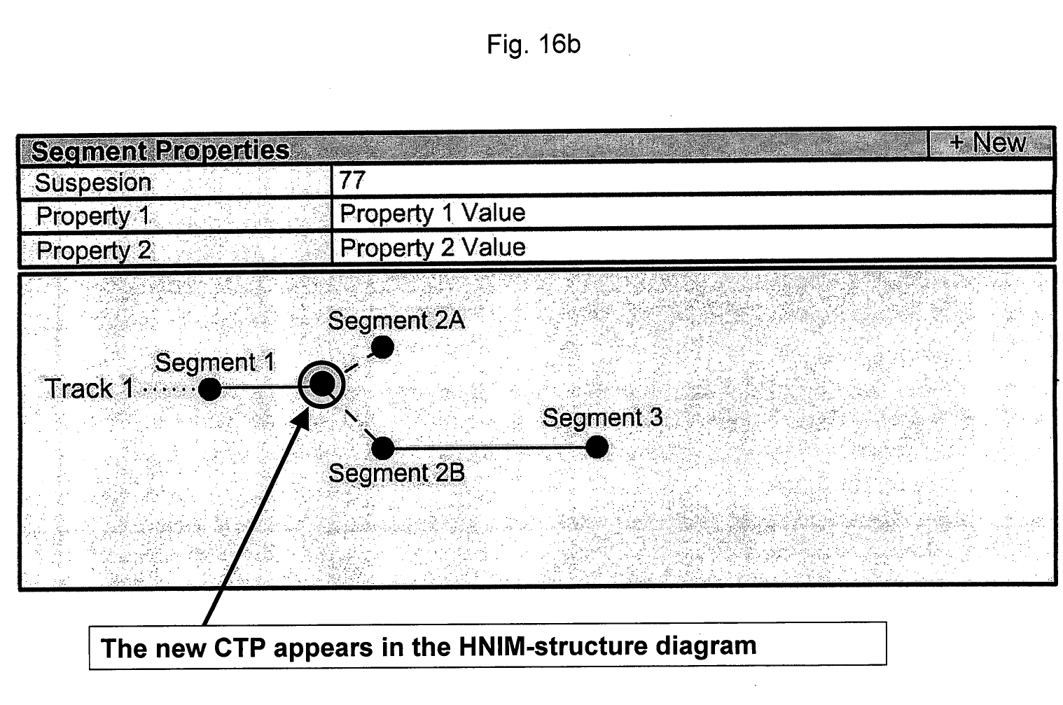

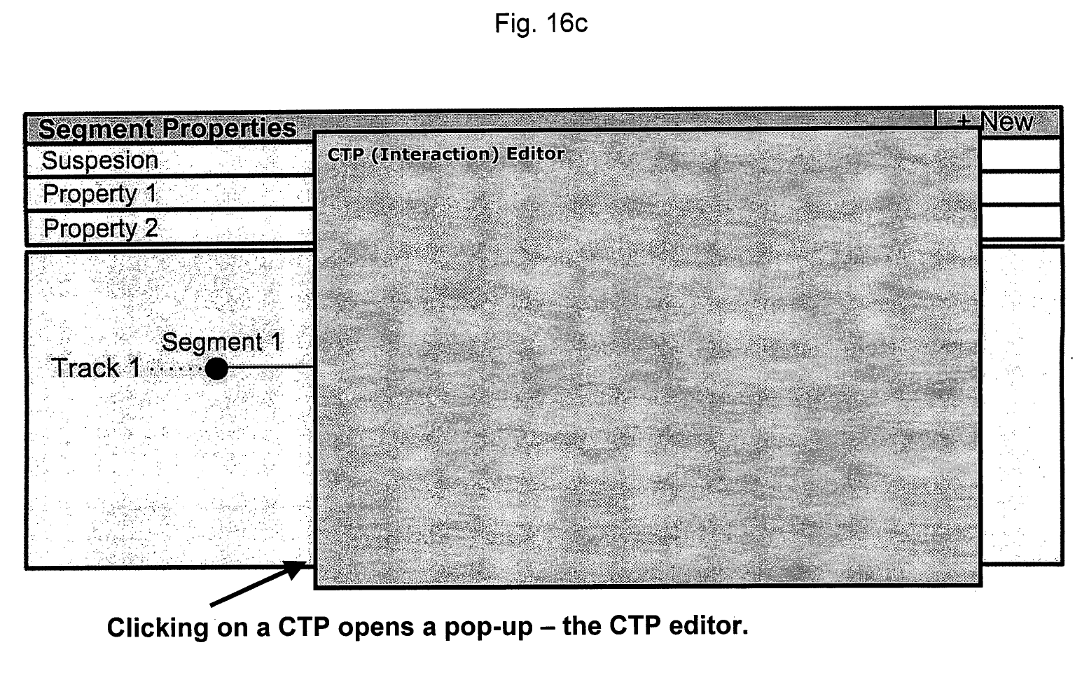

The term “map” is used herein to refer to a graphic representation of a track, including participating script segments and CTPs interconnecting these, e.g. the “structure diagram” illustrated in FIG. 16B.

Another output of the script editor 15 may comprise a HNIM Screenplay and storyboard 55 which may be conventionally formatted and go out to be filmed and edited outside the system.

Referring now to production environment 52, it is appreciated that Edited Film or Edited Film clips 75 may be received from outside the system. These, and/or a schema 50 provided by the script editor may be prepared for a target platform by suitable interaction between interface editor 70, media editor (also termed herein “media interaction editor”) 80, PC interface device configuration unit 85 and simulation unit 90 (also termed herein “player 90”), all as described in detail below.

Unit 85 may be operative to configure PC input or output devices as well as simulated settings of non-PC input or output devices. It is appreciated that if the target platform for the hyper-narrative interactive movie comprises a PC computer, there may be no simulation issue since the production environment has access to the same “input devices” or “output devices”. However, if the HNIM is targeted to run on a Wii, iPhone, game console, VOD, or any other customized platform, these may be simulated by PC input or output device configuration unit 85. Any suitable input devices may be used in conjunction with the system of FIG. 4, such as but not limited to a mouse, a touch screen, a light pen, an accelerometer, a webcam or other sensors. Any suitable output devices may be used in conjunction with the system of FIG. 4, such as but not limited to displays, head mounted displays, loudspeakers, headphones, micro-engines or other actuators.

Both the Media Interaction Editor 80 and the Interface editor 70 typically receive a “HNIM_schema.interaction-model.requiredDevicesList”, described in detail below. This list describes the interface devices (including input and output devices, or devices that are both input and output devices) that together comprise the HNIM's target platform. The Media interaction editor 80 determines the properties of the hotspot layer over the video and the branching structure of the HNIM for the simulation player 90. Interface editor 70 may be operative to correlate this data to a graphical simulation of the control interfaces of customized platforms. For example, if the HNIM is targeted for an iPhone and makes use of its accelerometer, the interface editor provides a graphical control that allows the user to simulate the tilting of an iPhone and create an equivalent data structure. The correlated outputs of the Media Interaction Editor 80 and of the Interface editor 70 may be exported to the simulation player 90. Eventually, the finished HNIM 100 may be exported to the target platform, in the target platform's data format.

The authoring environment 52 enables an author, without any special programming skills, to design the dramatic hyper-narrative flow, by guiding the author through the authoring of a branching structure of dramatic events, the interactor's behavioral options and the relationships between the two. The authoring environment typically comprises a hyper-narrative editor 20 and an interaction model editor 40. It is possible to begin authoring and planning in either of them, creating either the interaction model first or the hyper-narrative structure first, but to complete a HNIM both are typically employed.

The Hyper-Narrative editor 20's interface typically includes a graphical workspace in which blocks, say, can be connected to create a branching structure representing the structure of the HNIM. A block represents a “dramatic segment”, while a forking point leading out from the block represents a “Crucial Transitional Point”. A suitable method for using the editor 20 may for example include some or all of the following steps, suitably ordered e.g. as follows:

Operation a) The author creates narrative tracks, and divides them into “dramatic segments”.

Operation b) The author combines these segments into a branching structure, with the branch-points signifying points at which interaction can lead to any of, say, 2-4 paths. These may be the “crucial transitional points”.

Operation c) A plan list stores plan data indicating the optional dramatic segments to which the interactor can shift at each crucial transitional point.

Operation d) At each “crucial transitional point”, the author can open a menu to specify which of the interactor's optional behavioral actions, e.g. as specified in the interaction model editor 40, leads to which branch of the hyper-narrative structure. Typically, at least one branch has to be selected, and at least one branch has to be marked as the default, in case the interactor fails to intervene or is not detected by the system.

Operation e) Besides the main structure, representing the HNIM story, the author can define the responses of the HNIM to interactor actions that occur outside the crucial transitional points. These may be also stored in the plan list. They can be generic, or follow an incremental logic (i.e. respond differently to frequent rather than incidental interventions outside the crucial transitional points).

Operation f) The authoring environment 15 allows the author to attach to every segment in the structure both text and images, which can be exported as an (html-based) script or storyboard, allowing the author to share prototypes of the hyper-narrative structure with colleagues.

The Interaction model editor 40 allows the author to define an “interaction model” for the work. Interaction model editor 40 typically uses suitable menus to select general types and modalities of input rather than specific devices, to define input and output devices used by a HNIM. This allows specific devices to be replaced by similar devices, and also gives the author greater clarity and overview regarding the experiential dimension, whereby interaction devices form at each transitional point an integral part of the dramatic succession, complementing and forwarding it, or cut away to disjointed, e.g. disjoint segments. The output of the interaction model editor may comprise an “interaction model”.

Typically, the interaction model defines some or all of the following:
a) The input channels required for an HNIM's interface, both globally and for each crucial transitional point (or dramatically unintended interventions), described in terms such as of data type (continuous vs. discrete) and sensory modality (auditory, visual, haptic); and (optional) a similar description of the feedback output presented by the system's interface to the interactor when the latter is active.
b) Any further processing required (e.g. pattern recognition), to translate the raw input described in a) above, into “interaction idioms”.
c) The “Interaction idiom”, which may comprise a set of dramatically meaningful labels that describe interactor actions or behaviors. These meaningful labels describe the interactor's optional (immediate) actions or (processed) behaviors as they are played out in the movie world. These labels can be given directly to a type of raw input (bypassing any kind of further processing: e.g. pressing the mouse can be labeled as “knocking on glass”, dragging the mouse as “scratching on glass” etc . . . ), but they can also be given to the outcome of further processing, which would then be a set of more complex patterns or behaviors such as “empathy”, “hostility” or “apathy” behaviors. The idioms may link meaningfully between what the interactor does behaviorally and the dramatic segment selected at the crucial transitional point forming at each transition an integral part of the dramatic succession, complementing and forwarding it.

The Production environment 52 is typically used after there are filmed materials to work with. The structure of the hyper-narrative flow and of the interaction model, created in the authoring environment 15, establishes the guideline for editing the material of the HNIM. A suitable method for using the production environment 52 includes some or all of the following steps, suitably ordered e.g. as follows:
a) The production environment 52 allows an editor to link audiovisual media files to each dramatic segment, replacing the media files (texts or images) used during authoring and planning with finished scenes.
b) The production environment 52 allows the editor to preview the story, and to simulate the interface and interactive experience (regardless of platform) on a standard PC.
c) The production environment 52 allows an editor to configure the settings of the input devices and audiovisual media output to the selected target platform (standard PC, PC+ additional devices, Nintendo Wii, Apple iPhone etc . . . ), as long as that platform may be compatible with the requirements set in the HNIM's interaction model.
d) The production environment 52 then allows the editor to export the finished production to the target platform's data format.

A suitable method for using the system of FIG. 4 typically includes some or all of the following steps, suitably ordered e.g. as follows:
a) The hyper-narrative includes three or four different optional “narrative movie tracks” with a different “predetermined order”. Each optional narrative movie track may be ordered as a fully developed dramatic story with a beginning leading to an end. These narrative movie tracks may be divided into “dramatic segments”, dynamically interrelated at predefined “crucial transitional points”. These points are usually placed at the end of a segment.
b) Each dramatic segment can shift at each crucial transitional point to each of the other pre-ordered dramatic segments running in parallel. Each of the shifts to one of the other parallel threads leads to a dramatic segment which picks up and follows the dramatic segment leading onto it, logically and in a coherent manner. The different ending segments are devised in such a manner that they logically, coherently and dramatically short-circuit the divergent narrative movie threads leading to the ending segments, so that each ending segment offers a multi-consistent and satisfying narrative closure.
c) While, according to certain embodiments of the computerized system, it is essential to maintain narrative flow, and while the story does not wait for the interactor and forwards an option in case the interactor fails to intervene, the interactor may be induced to want to intervene in the story. Such complementary engagement can be achieved once behavioral interaction is allowed, required or blocked when it is clearly consonant with the moments in which interactors (rather than characters) are cognitively lured by the dramatic narrative succession to want to change the course of events rather than await what lies ahead.

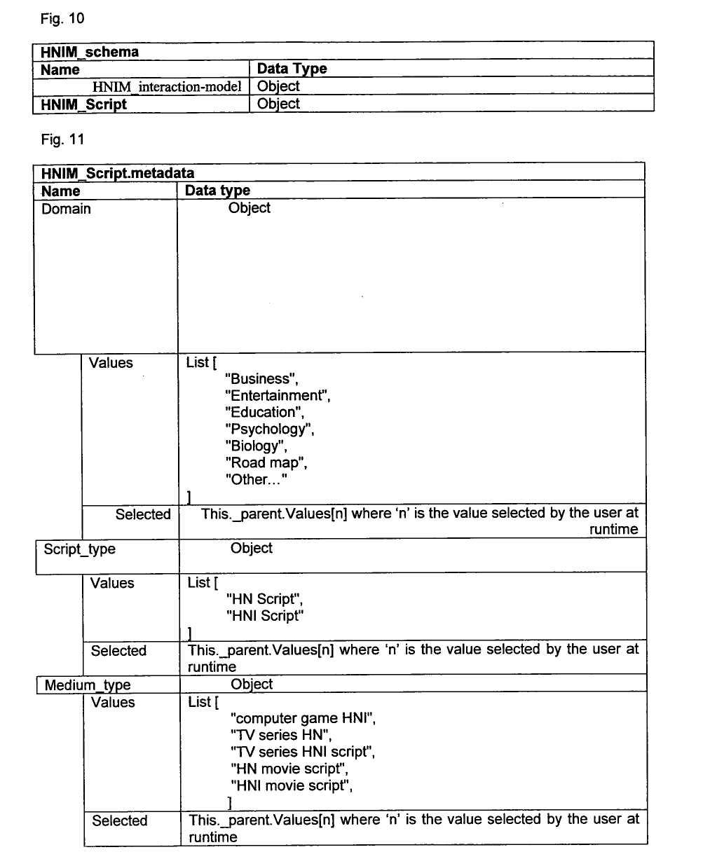

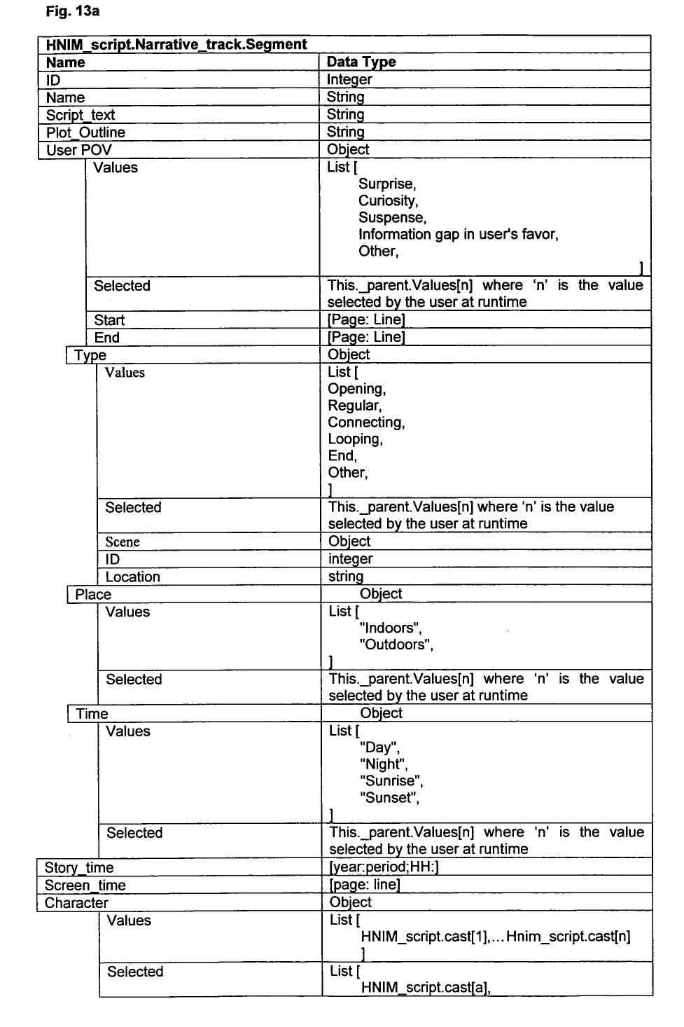

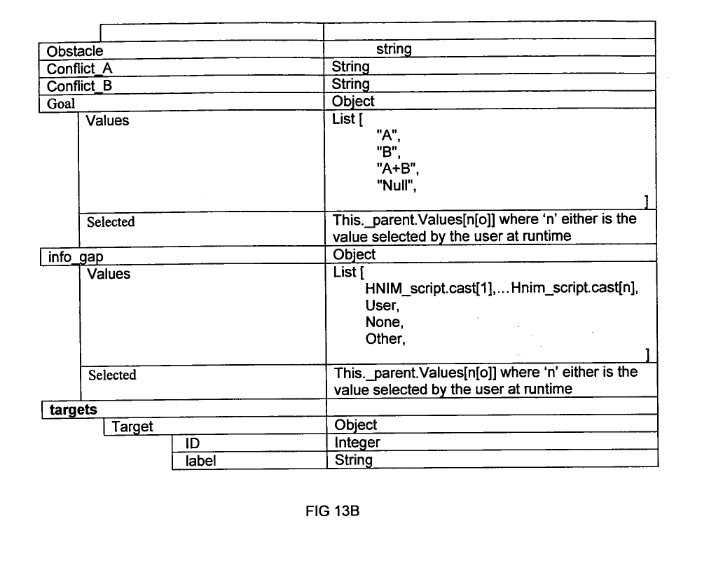

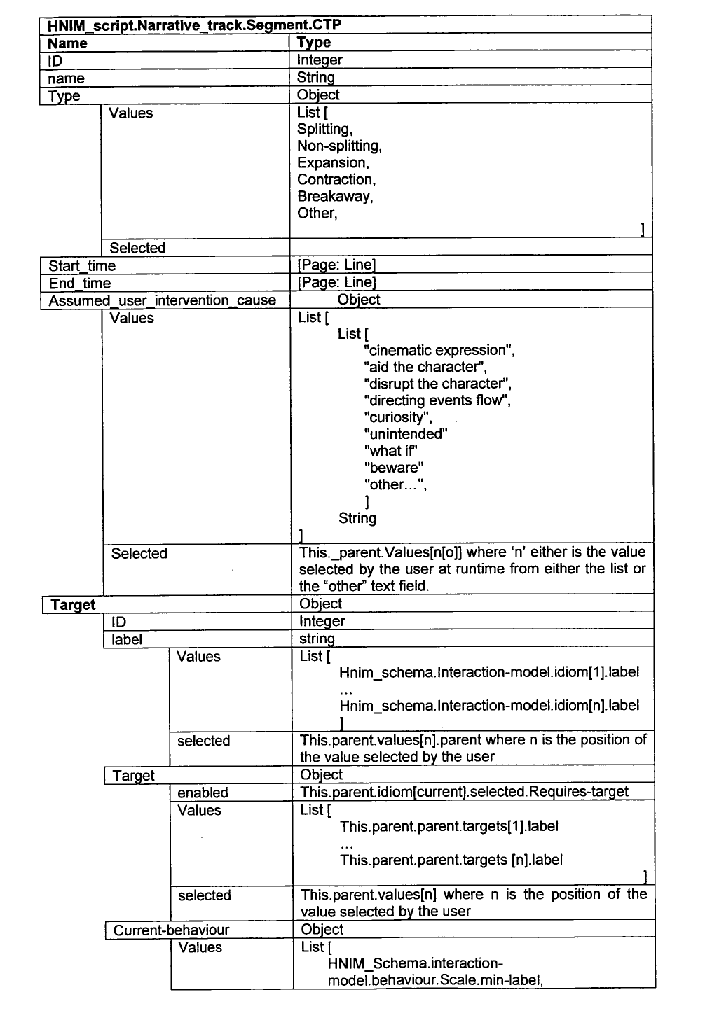

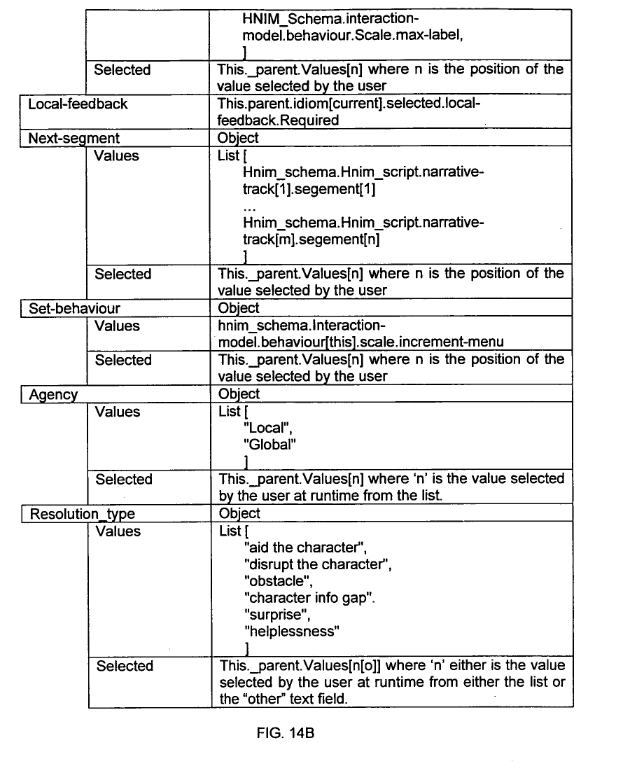

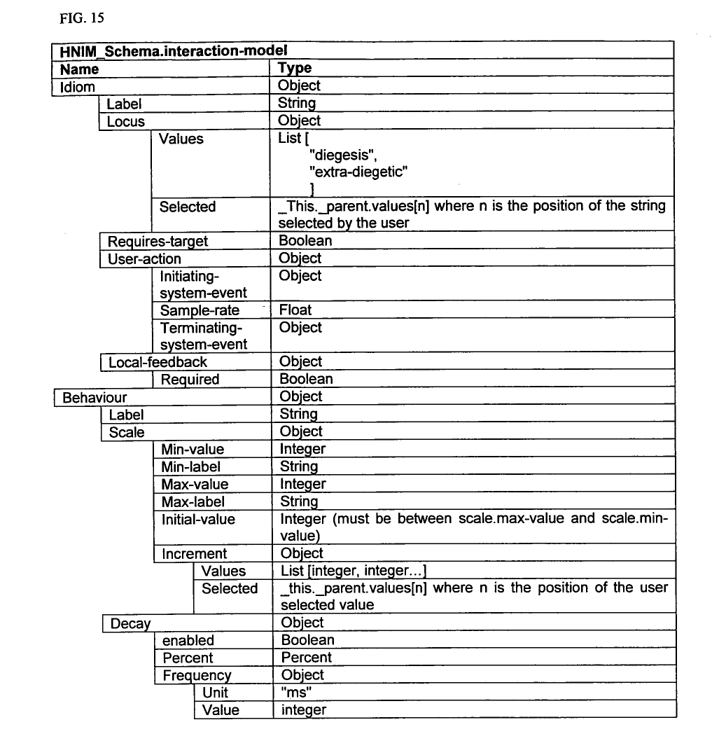

One example implementation of the computerized system of FIG. 4 is now described in detail with reference to FIGS. 10-38B. For simplicity, the system of FIG. 4 is described herein as generating hyper-narrative interactive movies, however, more generally, it is appreciated that the system of FIG. 4 is suitable for generating many branching audio and/or visual products such as but not limited to hyper-narrative scripts, interactive or not, computer games and hyper-narrative interactive script therefor, TV series and hyper-narrative script therefor, whether interactive or not, and movie hyper-narrative scripts, whether interactive or not.

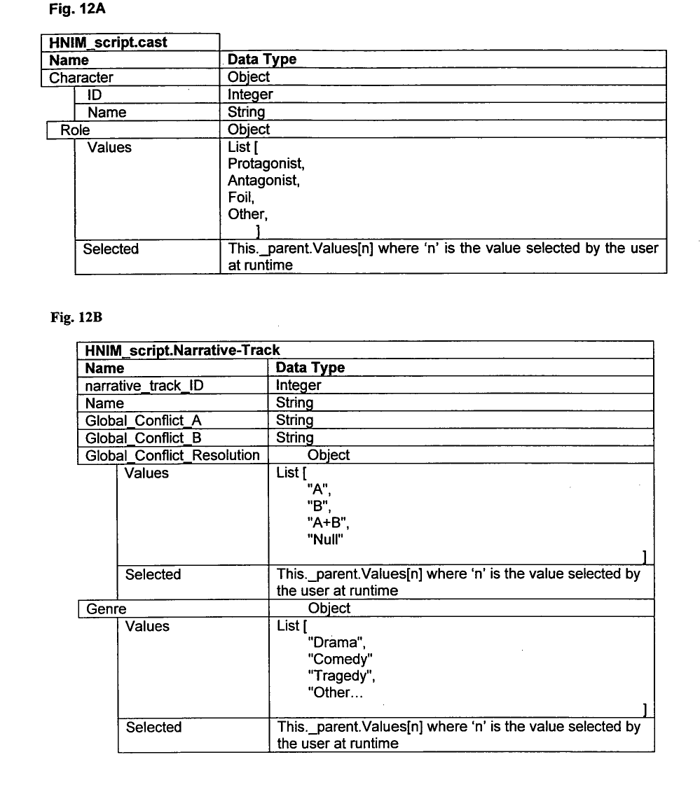

One suitable implementation for the Hyper-Narrative Interactive Script editor 20 of FIG. 4 is now described in detail. The tables of FIGS. 10-15 are an example of a data structure specifying the fields of an HNIM_Script object (FIGS. 11-15), created and maintained by the hypernarrative script editor 20 of FIG. 4. The HNIM_Script object may comprise a child of the HNIM_Schema, which the Authoring environment 15 sends to the Production environment 52.

Another child of the HNIM_Schema object defined in the table of FIG. 10 may be the HNIM-Schema.Interaction-model object created and maintained by the interaction model editor 40 of FIG. 4, as shown in the table of FIG. 10. Each top level field may be described in a separate table. Where necessary, additional tables of complex child objects receive their own table. An example of tables provided in accordance with this embodiment of the invention is shown in FIGS. 11-15.

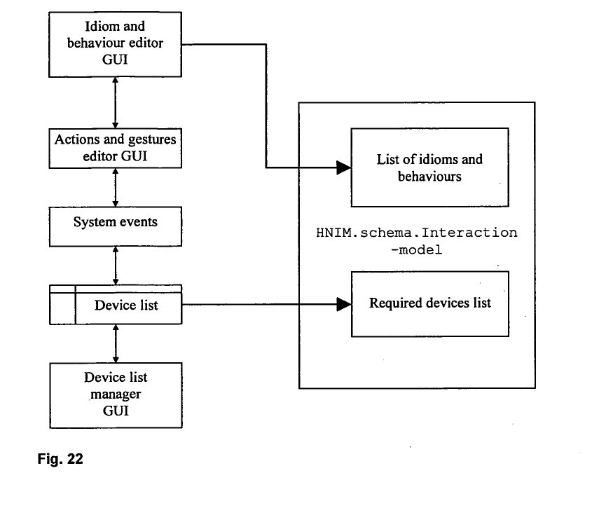

Reference is now made to FIGS. 16A-18B which together comprise an example of a suitable GUI for the Hypernarrative Script Editor 20 (also termed herein “CTP editor”) of FIG. 4. The GUI of FIGS. 16A-18B may be suitable for operation in conjunction with the Script Editor Properties data structure described above in detail with reference to FIGS. 10-15 and the method for using interaction idioms and behaviors in the hyper narrative editor 20, described below in detail with reference to FIGS. 22-24. As shown, using the screen display of FIG. 16A, a new CTP may be created e.g. when a script segment is split or when a new script segment is associated via the CTP with an existing script segment. The new CTP typically appears in a graphic representation of a track, also termed herein “HNIM structure diagram” or “map”, as shown in FIG. 16B. In the illustrated example, a CTP editing functionality, also termed herein “the CTP editor”, opens as a pop-up when a user clicks on a selected CTP in the structure diagram best seen in FIG. 16B.

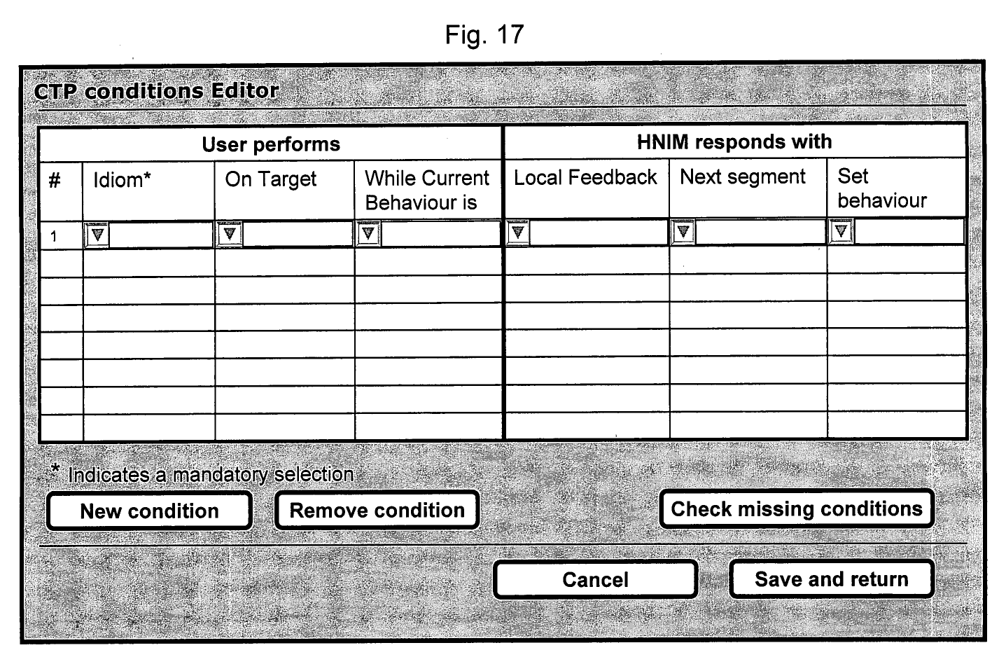

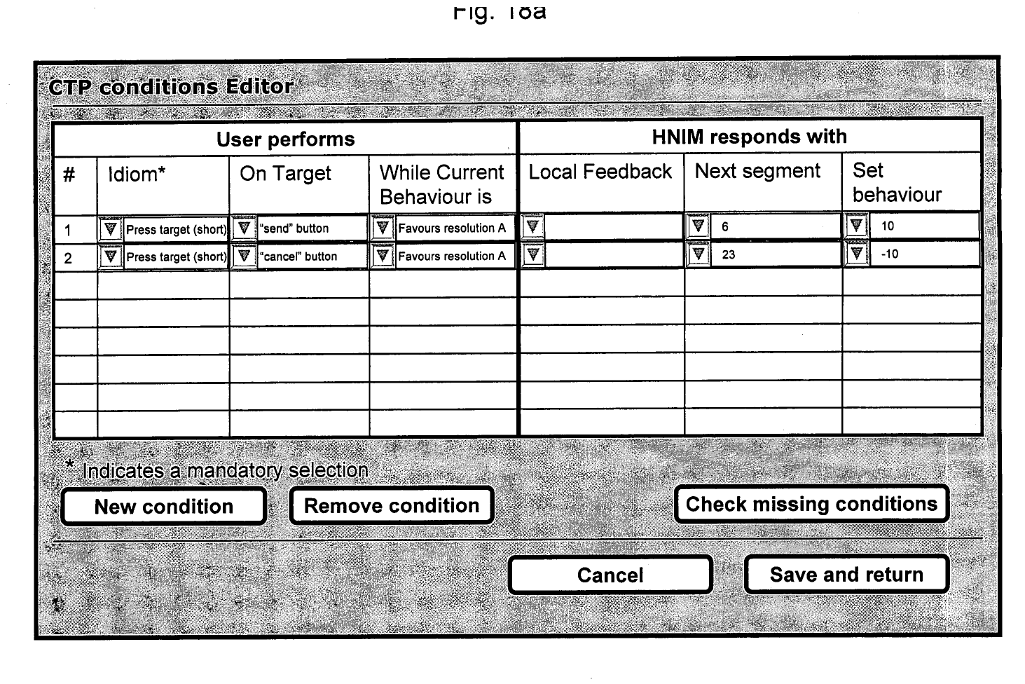

As shown in FIG. 17, the CTP editor typically allows a human author, also termed herein “author” or “user”, to select idioms available to the user at this point, and provides the HNIM system's response (“HNIM responds with” area in the example GUI of FIG. 17). Given the particular GUI and data structure shown herein merely by way of example, the user may interact with the system as follows: Using the “Idiom” column provided in the example GUI, the user selects from a list, populated with the fields saved in: Hnim_schema.Interaction-model.idiom[1 . . . n].label. If for the selected idiom hnim_schema.interaction-model.idiom[this].requires-target=TRUE, then the “on target” column may be designed to be mandatory. The user then selects, e.g. using the “on target” column, the target from a list of the segment's targets, or if there is none and one is required, edits the list and adds a target to it. The production environment 52 then knows what targets have been defined; these targets may be converted into hotspots in environment 52.

The “While current behaviour is” column is populated with a list containing the min and max labels saved in hnim_schema.Interaction-model.behavior.scale object. The user can then select one of these.

If hnim_schema.Interaction-model.idiom[this].local-feedback=TRUE then the “local feedback” column may be designed to be mandatory. If the value stored in hnim_schema.Interaction-model.idiom[this].local-feedback.type=diegetic, the user needs to fill in the response. If the value is “extra-diegetic”, a hotspot feedback can be specified in the production environment.

The list of (possible) next segments may be loaded into the “next segment” column from within the CTP editor. The user selects one. The increment-menu values may be loaded into the “set behavior” column from hnim_schema.Interaction-model.behavior[this]. scale.increment-menu. The user then sets the change to the behaviour resulting from this idiom's performance.

Since all idiom(+target+behavior) combinations need to be covered, the user can populate the list on the “user performs” side with these combinations, to make sure that no errors have been made; the “check missing conditions” option may be used for this purpose.

The example GUI shown and described herein assumes one behaviour with two labels, for the sake of simplicity. However, multiple nuanced (multiple-valued) behaviours may be possible according to the interaction-model's data structure, and merely require a suitable GUI to configure their impact on the HNIM.

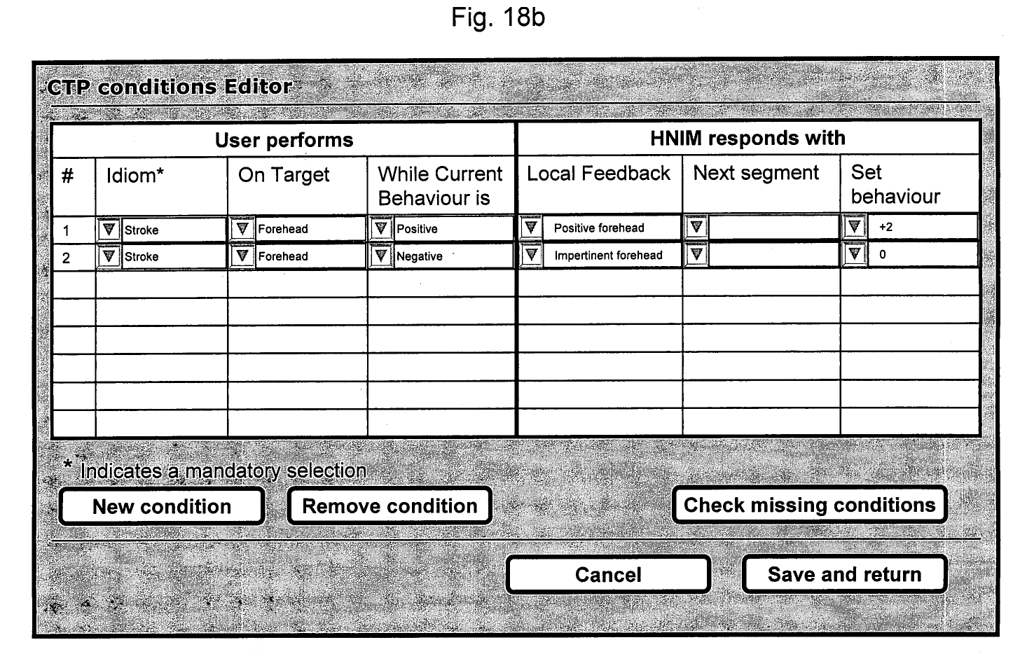

As shown in FIG. 18A, according to conditions 1 and 2, the author can set conditions such that if the HNIM's user's current “behaviour” is represented as “prefers resolution A”, and the HNIM's user sends the SMS, the HNIM's representation of that “behaviour” may be affirmed and its value increased by a factor of “+10”; whereas if the user cancels the SMS, the represented “behaviour” may be weakened by a factor of “−10. This means that the represented behaviour can change from “prefers resolution A” to “prefers resolution B”, and this affects subsequent CTPs in which that behaviour contextualises the condition as it would e.g. appear in the “while current behaviour is” column.

The data shown in FIG. 18A pertains to a “send or cancel SMS to Rona?” example described herein. The data shown in FIG. 18B pertains to a second example taken from “Interface Portraits”, an interactive computer-based video installation based on gestural-tactile interaction with a simulated character's face. As shown in FIG. 18B, although “Interface Portraits” is not an HNIM, its interaction model too can be represented here. If the user of the “Interface Portrait” is interpreted by the software (based on computations of the user's previous gestures) to have a “positive” attitude, the portrait response to a “stroke” idiom on the “forehead” target may be to play a “positive forehead” video clip, in which the portrait may be seen to react positively to the stroking of his forehead by the user; but if the software has interpreted the user's behaviour up to the current point to have been “negative”, the software behind the portrait may interpret the exact same gesture (“idiom”+“target” combination) as “impertinent”, and respond by playing an “impertinent forehead” video clip, expressing the portrait's dissatisfaction at that exact same gesture.

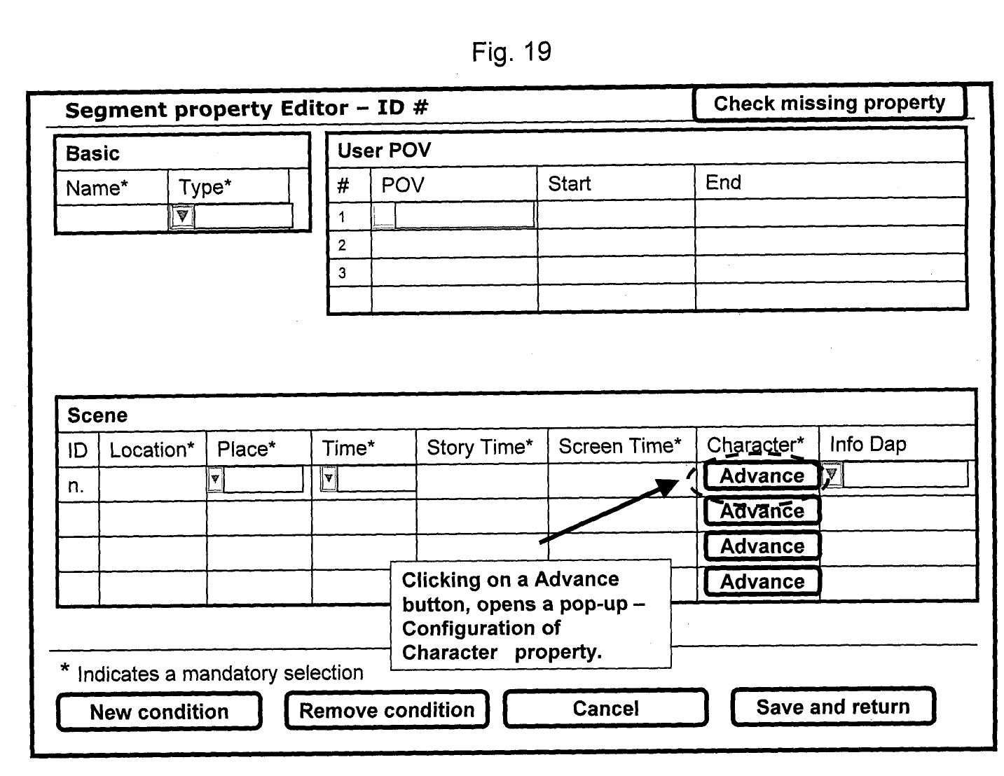

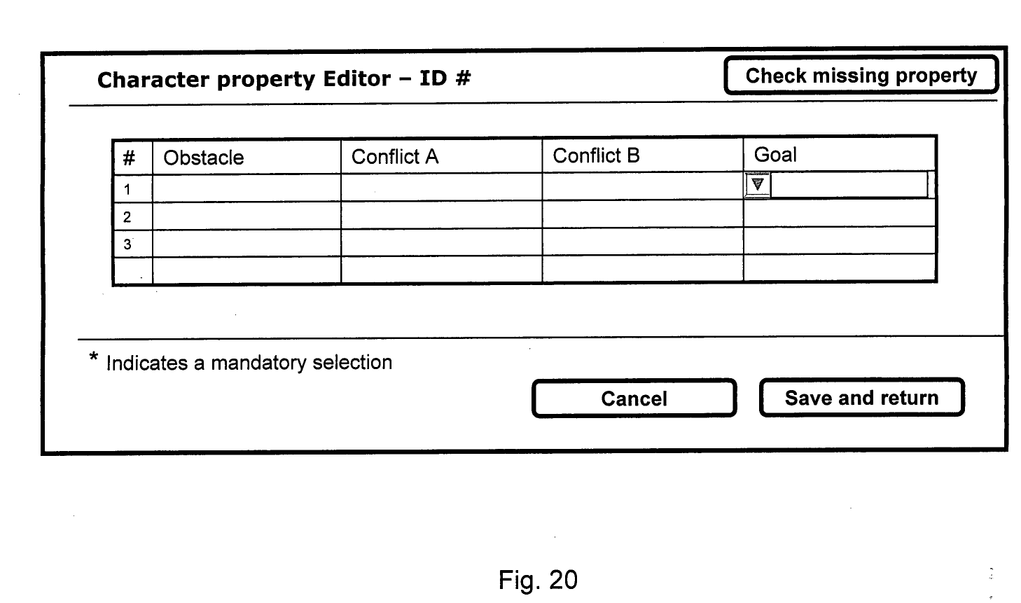

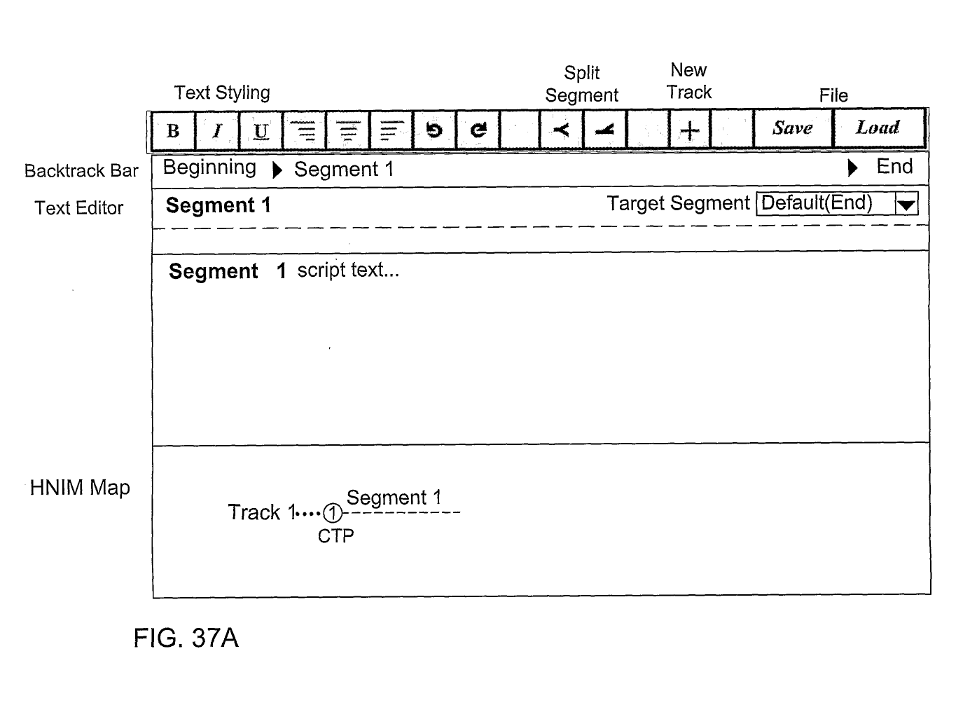

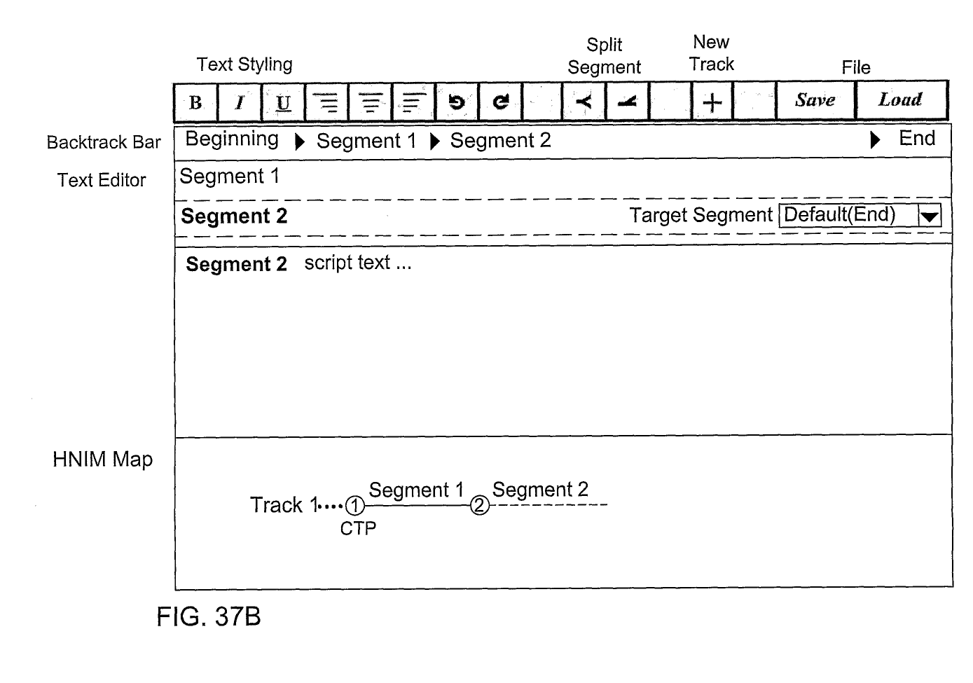

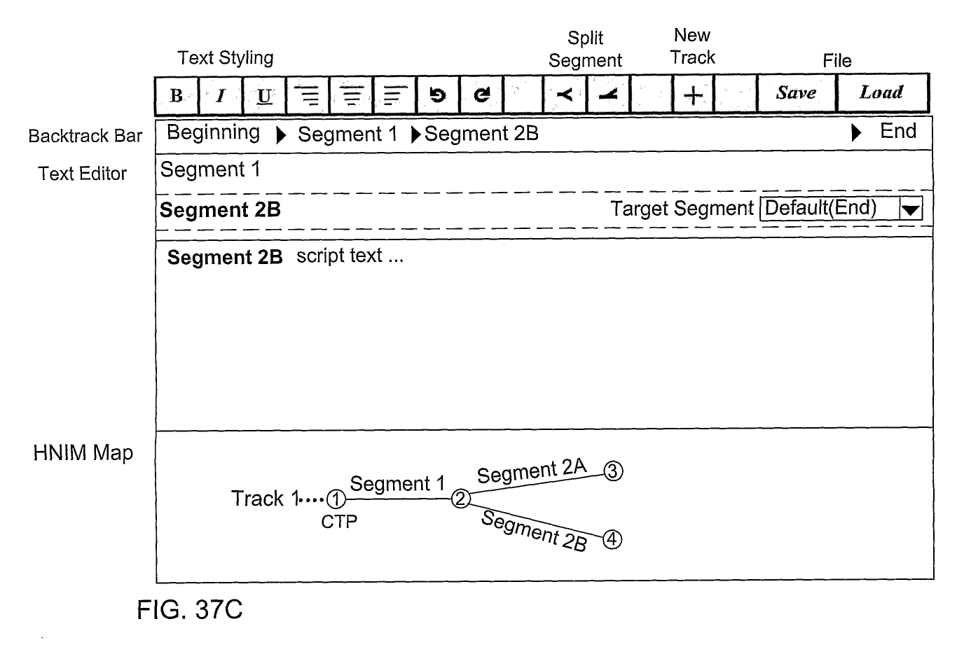

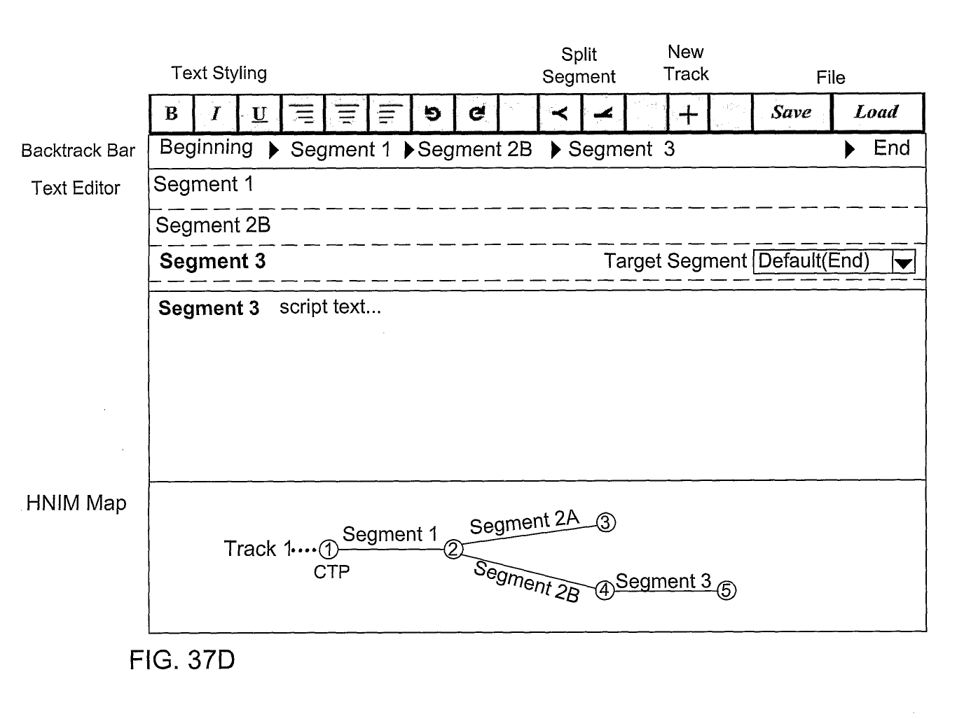

FIGS. 19-20 illustrate example screen shots on which GUIs for a segment property editing functionality and a character property editing functionality, typically provided as part of hypernarrative editor 20 of FIG. 4, may be based. The GUIs of FIGS. 19-20 are useful, for example, in conjunction with the GUI shown in FIGS. 37A-37D by way of example and described hereinbelow. The segment property editing functionality of FIG. 19 may pop up if a segment is clicked, such as “segment 1” in the map shown in FIG. 37D. The character (protagonist) property editing functionality of FIG. 20 may pop up if one of the “advance” buttons in FIG. 19 is clicked upon.

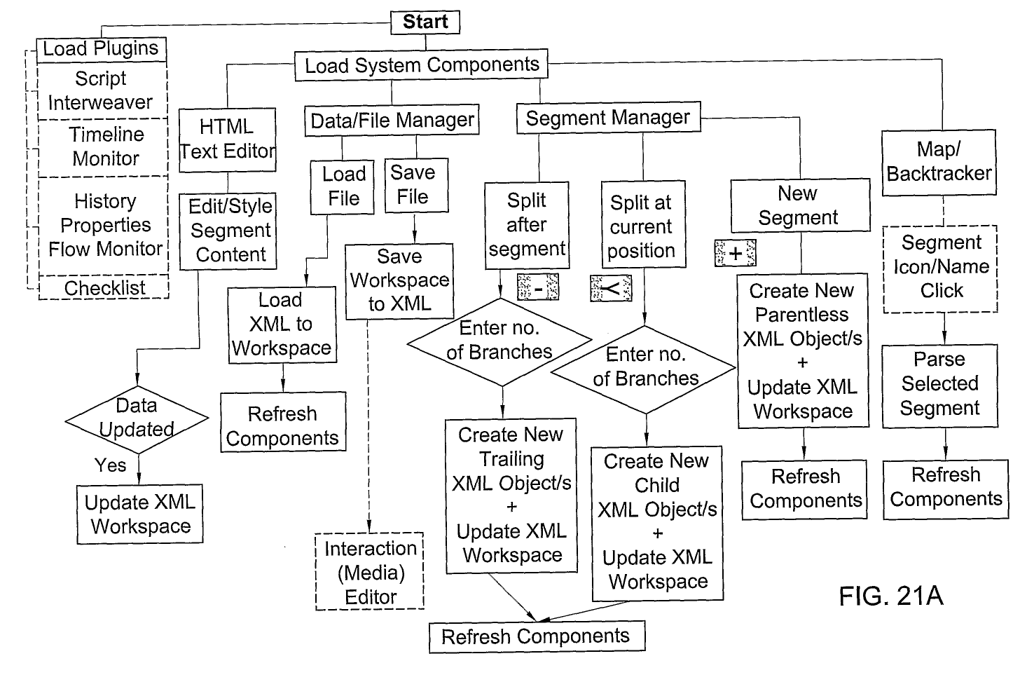

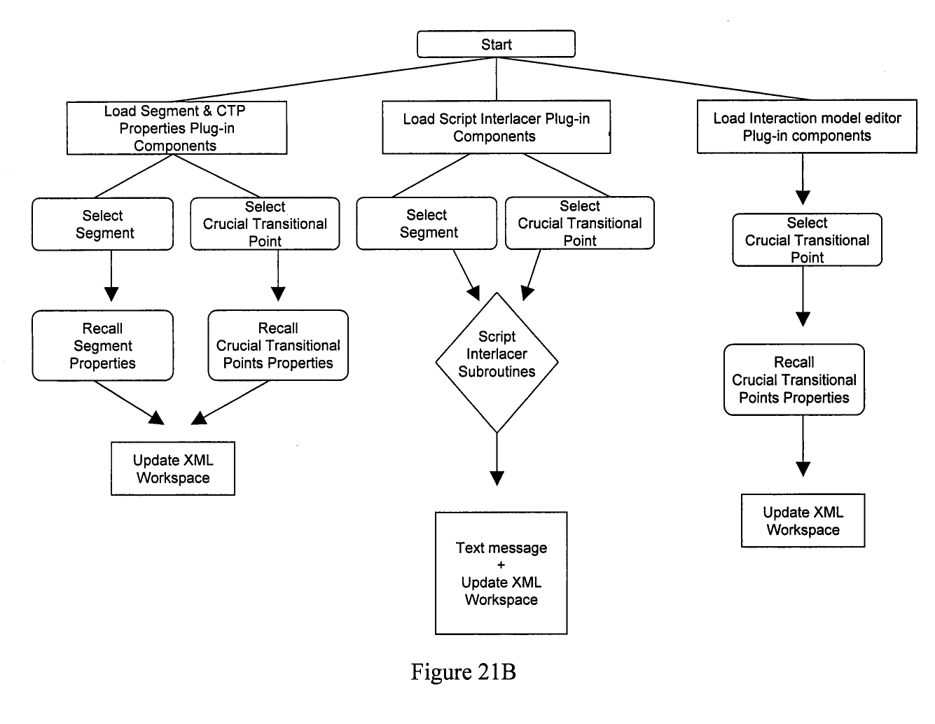

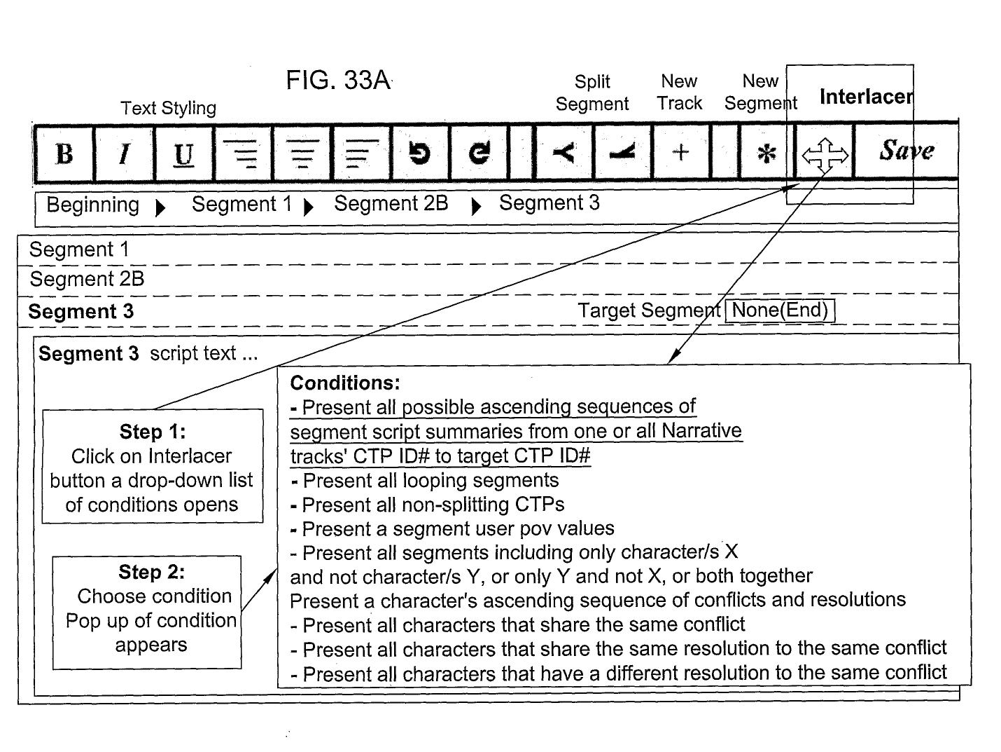

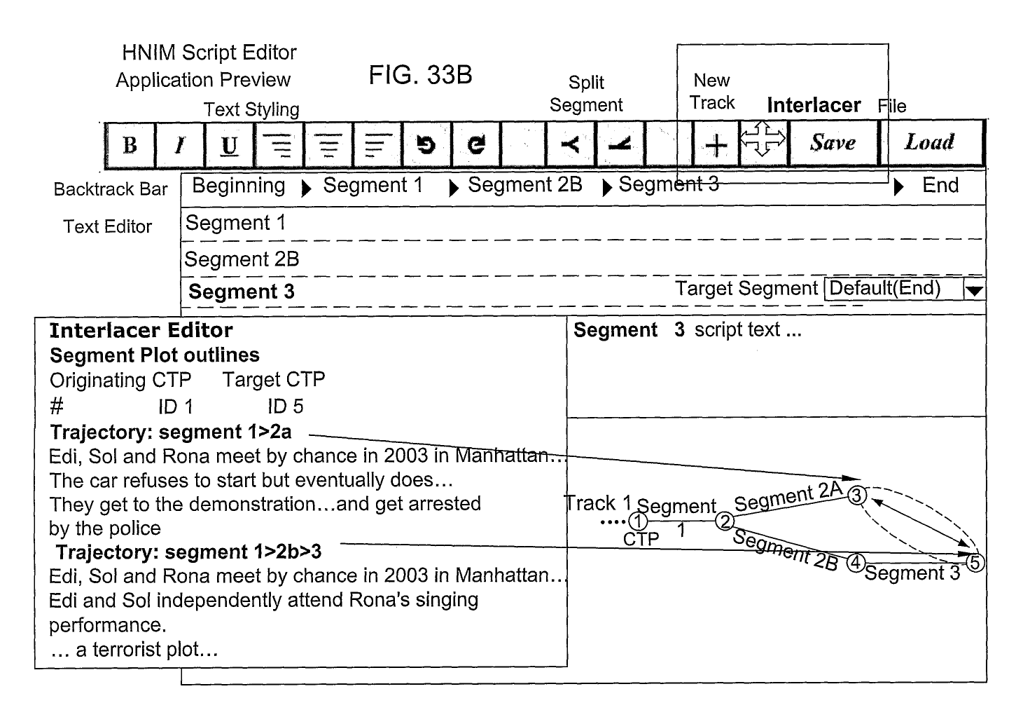

FIG. 21A is a simplified flowchart illustration of operations performed by script editor 15 in FIG. 4, according to a first embodiment of the present invention. One possible implementation of the “script interweaver” load plug-in of FIG. 21A, also termed herein either “Interlacer Editor” or “script interlacer”, is described herein with reference to FIGS. 33A-33B. One possible implementation of the “History properties flow monitor” load plug-in in FIG. 21A, also termed herein the “Segment & CTP Properties Editor” is described herein with reference to FIGS. 10-15. One possible implementation of the “checklist” load plug-in of FIG. 21A, also termed herein the “the interaction Model editor”, is described herein with reference to FIGS. 22, 23, 24A, 24B. Suitable methods of operations for the three plug-ins may be in accordance with the simplified flowchart illustration of FIG. 21B.

The HNIM Interaction model editor 40 is now described with reference to FIGS. 22-24C. The interaction model editor 50 is typically designed to allow creative authors with no particular technical skills (such as programming or storyboarding) to creatively explore the experiential and dramatic qualities of interaction models, rather than start from concrete devices and their already known control capabilities. It allows authors to design—rather than to program or build—an interaction model for their particular HNIM creation. It is intended to make it easier for authors to think in a more integrative way about the relationships between storytelling and interaction. They can then always consult interface/interaction designers on the right devices for their concept, or even commission engineers to build customised interfaces to implement their model. Interaction/interface designers can also work inside this environment to extend its capabilities.

An interaction model may comprise a definition of the user's actions and behaviors and their meaning in the story in dramatic terms.

An action may be author-defined as a single physical action; and what the software accepts as input through input devices during action duration. This input may comprise a series of registered system events which begins in an initiating system event and ends with a terminating system event.

An action's sample-rate may be the number of registered system events during a unit of the action's duration. The maximal action sample-rate depends on the specific input device's maximal output frequency and the computer's maximal input frequency (which may be determined by the lowest frequency of any of the hardware units that lead from the input device to the CPU) and can further be limited by software (for example by the BIOS or operating system).

Example: A “single-point gesture” action begins with the initiating system event “mouse down”, and registers at regular time points (depending on sample-rate) the X,Y coordinates of the pointing device until the terminating system event “mouse up”. Its data structure may comprise a finite list of length n with three fields: T_{(1 . . . a)},x,y

System events can be generated intentionally by a user manipulating input devices; or they can be generated by sensors, including but not limited to microphones, webcams, conductivity, heat, humidity or other suitable sensors which the system monitors for certain predefined thresholds, values etc. and which the system registers as (unintentional) user events.

An interaction idiom includes the labeling in dramatic terms of a particular action. An idiom can include a target object in the story world, but the object can be left undefined. It may possess, globally or locally, a list or lists of intensity values that it adds to or subtract from predefined behaviors (see below).

Example: A user performs a slow dragging of a pointing device (defined relatively as a range of the sums of distances between the x,y coordinates in the list divided by the action's duration) such as a mouse or touch screen. This can be labeled a “stroke”. A “stroke” is thus an idiom. A user holding a mouse button down or pressing against a touch screen for more than a certain duration can be said to perform a “poke”. A “poke” is thus another idiom. If a target object was defined, the user can be said to “stroke” or “poke” that object.

A behavior is a computation on a pattern of idioms performed by the user during a duration. One difference between an idiom and a behavior is that while idioms may usually elicit a local (immediate) as well as global (persistent or deferred) feedback response from the system, a behavior does not elicit such local response but rather works at a deeper level.

Example: idioms can be assigned positive or negative intensity values reflecting an assumed attitude on the part of the user, either in relation to a protagonist (“empathic”, or “hostile”) or the main dramatic conflict (favors outcome A or favors outcome B). The accumulation of the intensity values of idioms performed by the interactor can add to, or subtract from the behavior's value in the end-user model. Thus, consistently performing certain idioms at crucial transitional points (or even outside them) may result in a clear behavior (of empathy/hostility, or outcome preference), to which the author can come up with an appropriate dramatic response in the hypernarrative editor.

The set of idioms (dramatically labeled actions) and behaviors defined in this editor constitutes a particular HNIM's interaction model.

The interaction model editor, as shown in FIG. 22, includes some of the following components:
An extensible Device List 2210
A device list manager 2220
An actions and gestures editor 2230
An Idiom and Behavior editor 2240

Typically, the device list 2210 may comprise an extensible database of interface devices described (using a common general language):
a. Informationally, the information they communicate (data-structures)
b. Phenomenologically, detailing the media they use to communicate information.

As an example, both a mouse and a touch screen can function as pointing devices capable of generating the same system events and delivering the same information to the computer. In this respect they can be considered informationally equivalent as input devices. But they also differ in their functionality and pragmatic context: the touch screen is also a display, i.e. an output device that provides the user with information via the visual modality; and in that the mouse requires the user to manipulate objects indirectly, via the proxy visual surrogate of the cursor, involving a more complex process of hand-eye coordination than the more direct touch screen's manipulation of visual display elements.

The device list 2210 also typically details, for every device, the system events it generates or recognizes (such as mouseOver, mouseUp, onClick). The device list manager 2220 allows an engineer or interaction/interface designer to extend the device list by describing new interface devices.

The actions and gestures editor 2230 allows the user to select and compose patterns of user actions from the system events stored in the device list. The user can freely mix system events to compose action or action patterns (gestures), choosing either from all known system events or from a filtered selection of specific devices (a “Platform”. Examples of platforms include the combination of a keyboard, mouse, display and speakers known as a multimedia PC, or an iPhone, which is a mobile multimedia platform including a touch-screen, accelerometers and other interface devices).

The idioms and behaviors editor 2240 may be the top tier of the interaction-model editor. Minimally, it is a place for an author to list the actions afforded to the user in the HNIM experience and describe them formally as idioms, with or without targets. This description may be dramatic rather than technical. Less minimally, the author can already link idioms to the actions and gestures defined in the Actions and Gestures editor. This is also where the author can list behaviors, their scales and other parameters.

To define an idiom, the author can specify some or all of:
Interaction idioms. These are meaningful labels applied to a user action and describing it in dramatic terms, as part of the story world. Idioms may include a target object in the story world, but this can also be left undefined to account for extra-diegetic interaction, or interaction outside the crucial transitional points.
Behavior intensity-value. In case an idiom can signify that the user is performing it as part of a strategy or as a symptom for a certain pattern of behavior, the idiom can carry a value which stores the amount (positive or negative) its performance contributes to a defined behavior.
   This value may be set in the CTP editor described above for every idiom-target pairing, since it depends on the local context of the idiom's performance.
Behaviors. The list of patterns of user behavior that can be used in the hypernarrative editor can be created in the interaction model editor. As mentioned above, every idiom can be defined to have a global contribution to a behavior; but the same idiom can also be defined to influence behavior differently under different contexts—either at a certain crucial transitional point, or in relation to previous user actions performed (as represented by the current relevant “behavior” value).

Example: a user stroking the face of a protagonist can be doing so out of empathy, and thus the idiom can contribute to the value of an “empathy” behavior. But if the current context of the user behavior has already been established to be “hostility”, the same stroke may be interpreted negatively as threatening or mocking. The response of the protagonist in both cases needs to be different, and it is possible in a HNIM thanks to this distinction between a single user action and the stored and processed memory of a pattern of user-actions: the behavior.

One method for using the interaction-model editor 40 of FIG. 4 is now described in detail.

The various editors of the interaction-model editor can be used in any order. The application of the interaction model to an HNIM typically includes at least two steps:
First, in the interaction model editor 40 of FIG. 4, the user defines the interaction idioms (and optionally behaviors) for the work.
Then, these idioms (and optionally behaviors) become available to the author within the HNIM hyper-narrative editor 20.

For definition of idioms and behaviors, the user may opt to use only the idioms and Behaviors editor 2240, without specifying actions and gestures, or devices and system events. However, when the interaction-model editor 40 is used to its full potential, it can convey to the production environment 52 additional information, e.g. which (known or customized) interface devices are to be used to set up the particular HNIM designed in the system of FIG. 4.

An example workflow is now described.

1. Specifying and composing device properties in the device list manager 2220:

An interaction designer can extend the device list by describing existing or custom-made devices that are not included in the list, using a unified language of device input and output properties and the system events they recognize and generate.

2. Defining actions and gestures.

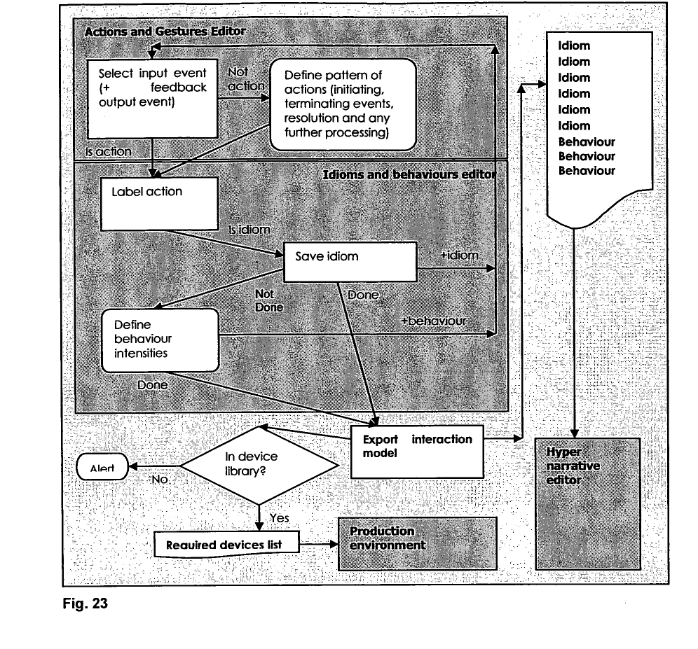

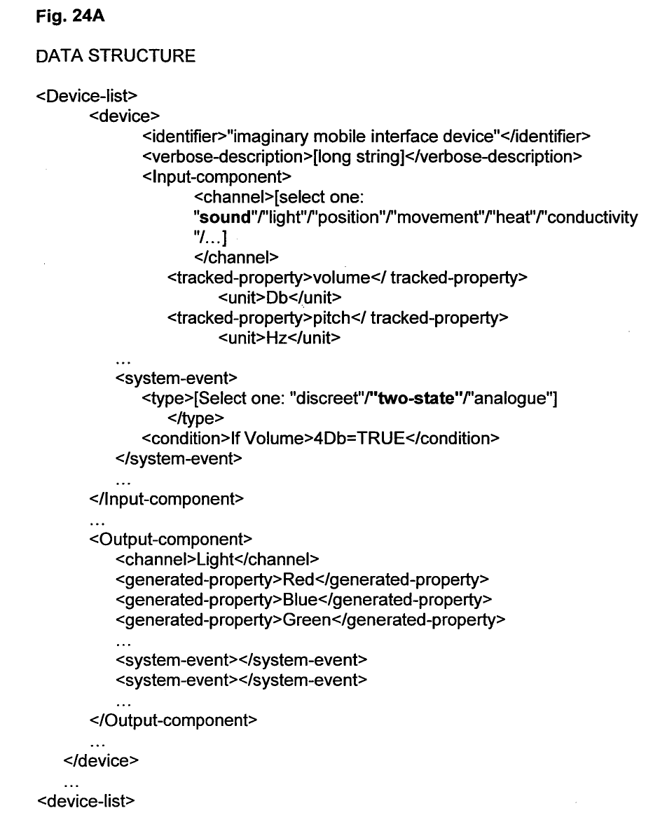

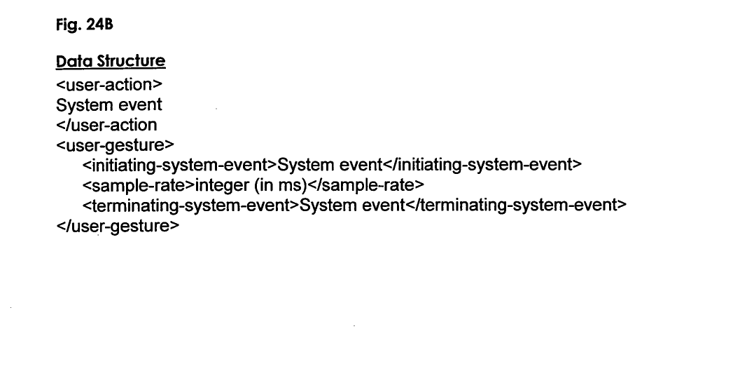

An author can then use the Actions and Gestures editor 2230 to select from amongst the available system events, using menus, those events or event patterns that may be afforded to the user e.g. in accordance with a suitable interaction model.
Actions may be defined in terms of input/output system events.
Input system events may be selected from a list of possible input/output events described in generalized terms;
A single input event may constitute a user action by itself;
A list of events (or a gesture), beginning with an initiating system event and ending with a terminating system event, and possibly serving as basis for further processing (e.g. pattern recognition), can also be defined as a user action.
Output events (local feedback)—a perceptible system response, either diegetic or extra diegetic, that signals to the interactor that his/her user action has indeed been performed.
Defining idioms in the Interaction model editor. This step may be performed in accordance with the methodology shown in FIG. 23, showing a method for defining idioms and behaviors in the interaction model editor 40 in accordance with certain embodiments of the present invention.
The output of the interaction model editor 40 to the hyper narrative editor 20 of FIG. 4 typically includes a list of interaction idioms, interactor actions labeled so that they become meaningful dramatic actions; and optionally also behaviors.

3. Using interaction idioms and behaviors in the hypernarrative script editor.

Interaction idioms and behaviors defined in the interaction model editor 40 constitute a list stored in the object HNIM_schemainteraction-model. This list may be accessible in the hypernarrative script editor 20 via a CTP editor interface provided for editing “crucial transitional points”. Each idiom can be linked dramatically and intuitively to the next segment. This may be done by defining “interventions”. An “intervention” is a causal connection between (a) what the user does and (b) how the HNIM responds. The user can specify some or all of the following:

(a) What the user does may be broken down into (i)“idiom”, (ii)“target” and (iii)“current behavior”.
i. The idiom is a dramatic label describing the user's action, typically including not merely what the user does physically (“click a left mouse button”) but what the user's actions mean in the story world
ii. The target is the (optional) object of an idiom. The user performs a “press” idiom on a “send button” target. The targets may be pre-defined in the Hypernarrative Script Editor's segment properties editing interface, for every segment
iii. The current behavior is the way the HNIM interprets the user's behavior up to the current point. Behavior forms (and possibly decays) over time, as the HNIM makes inferences about the user's behavior with each idiom performed, as described in (vi) below.
   (b) How the HNIM responds is broken to (iv) local feedback, (v) next segment and (vi) set behavior
iv. local feedback—some perceptible output including but not limited to an animation or sound that signals to the users that their action took effect.
v. next segment—the user determines what HNIM segment may be played as a result of the user's intervention.
vi. Set behavior—this is how behaviors develop. Each user intervention can be evaluated by the author in relation to a behavior (or several, although this is not represented in the suggested GUI) and the user can determine whether its performance means that the user has intensified or weakened this particular behavior. This user can also decide how much of a change to the represented behavior it is, on a scale determined in the interaction-model editor.

For example: the interaction idiom “press [specify target object] (short)” can be complemented by the (diegetic) target object “Send button” and be linked to segment x, whereas the idiom “press [specify target object]”, when linked to the target object “Cancel button” would lead to segment y.

Using behaviors, the same idiom and target can yield different HNIM responses, based on the user's interaction record (as an assumed trace of user intentions). Thus, the idiom performance “press the cancel button” would lead to one segment if the user's behavior is currently assumed to be “friendly to the protagonist” and to another segment if the user's behavior amounts to “hostile to the protagonist”.

There may be many possible workflows and use scenarios for interaction model editor 40, accommodating different user profiles, such as but not limited to the following:
a) Bottom-up interaction design allows an interaction author to work at the level of system events to compose simple or more complex actions, gestures and possibly simple behaviors (if certain system events are missing from the relevant menus, they can be added in the device list manager). A complete set of interface definitions can be worked out before any story information is available, in order to simulate a target platform's interface options. These options can then be turned into idioms and behaviors and made available to the Hypernarrative script editor 20 of FIG. 4.
b) Top-down dramatic design can begin by specifying the possible user idioms and behaviors that are dramatically required. This would be appropriate for a screenwriter with less developed understanding of the interactive possibilities but with a vision of the role and possible involvement of the end-user in the particular HNIM's story's world, who wishes to define the idioms and behaviors that constitute that HNIM end-user's interaction model. An interface designer (human) can then break this interaction model down to its more technical constituents and if necessary design the interface devices required.
c) A mixed approach can be enabled, with the user switching between top-down drama centered design and bottom-up interface centered design until the right interaction model is shaped.

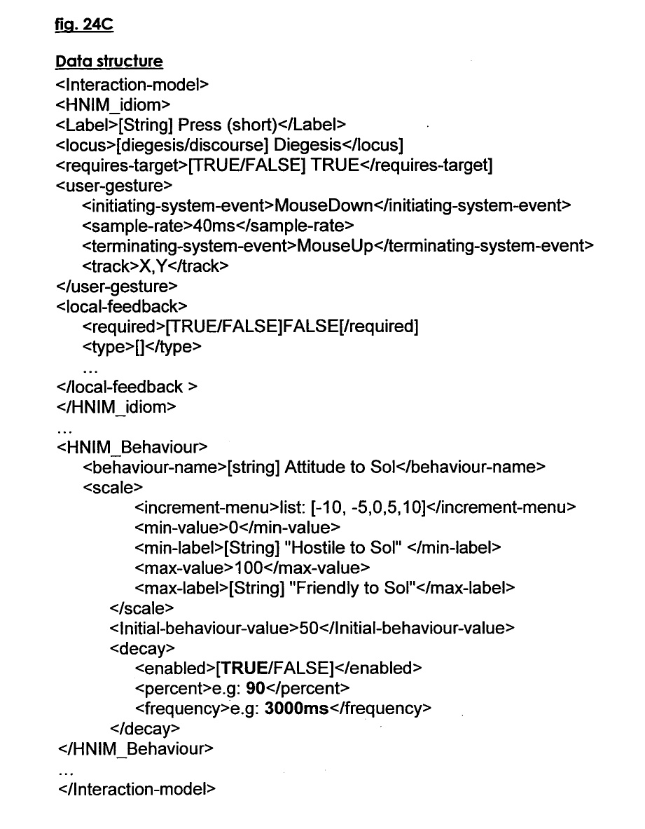

The input to the device list manager 2220 of FIG. 22 may be the already stored device list and/or user input. The device list manager 2220 displays the existing device list and allows the user to:
edit existing values
Add new devices, specifying their values
   The interface for editing or adding new devices can for example be xml editing or wizard based GUI.
   The output of the device list manager 2220 may comprise an updated device list, an internally stored list of device descriptions in XML format, e.g. as shown in FIG. 24.

The input to actions and gestures editor 2230 includes the list of possible system events stored in the device list. Processes and computations performed by actions and gestures editor 2230 may include some or all of the following, in any suitable order such as the following:
1) The editor 2230 displays to the user menus with system events, organized according to phenomenological and informational sub categories.
2) The human user creates a list of actions and gestures to be used by the HNIM author in the idioms and behaviors editor.
3) A single system event can be defined as an action
4) Patterns of system events can be defined as gestures, e.g. specifying some or all of:
   a) An initiating system event
   b) Intermediate system events to monitor
      i) Frequency of sampling the intermediate events
   c) A terminating system event
   d) Optionally, pluggable additional processing on the gesture (using an external script)

Editor 2230 outputs a list of actions and gestures to the Idioms and Behaviors editor 2240, e.g. as shown in FIG. 24B.

The idiom and behavior editor 2240 accepts the following types of input: List of system events imported from the stored device list; and

User input:
“Labels”: strings of text entered through its interface at specific places.
“Values”: user-determined selections of data types from menus available through its interfaces.
Predefined system events initiating executable processes (such as “save”, “save as . . . ”, “export”, ok”), made available through menus or buttons in its interfaces.

The idiom and behavior editor 2240 creates and stores the “interaction model”, a list 2250 of idioms and behaviors and typically also compiles and stores a “required devices list”, a list of the <identifier> fields of the devices whose system-events have been used in the interaction model's idioms. Editor 2240's output to the production environment 52 typically includes a “required devices list”, in xml format, readable by the production environment 52. Editor 2240's output to the Hypernarrative script editor 20 typically includes the Interaction Model 2270 as a list 2250 of “idioms” and “behaviors” in xml format, readable by the hypernarrative script editor 20, e.g. as shown in FIG. 24C.

Description of interface devices in a generalized informational and phenomenological language in accordance with certain embodiments of the present invention provides some or all of the following advantages:
1. The informational description allows specific devices to be replaced by equivalent devices that are similar in terms of their input/output events and data structures.
2. The phenomenological description gives the author greater clarity and overview regarding the experiential dimension of interface devices, thus allowing the process of interaction-model design to take place on a less technical and thus more creative level.
3. By holding a complex representation of the user's behavior, the HNIM can make assumptions about the user's intentions and more accurately respond to (or frustrate) those intentions according to the author's own intentions.
4. Behaviors can also contextualize user inaction, so that lack of action at a specific crucial transitional point would be evaluated against an existing model of the user, based on previous actions (intentional or otherwise), and may yield a different branching outcome each time. This obviates the need to arbitrarily specify “default” branching decisions that may be unable to take the user's intentions into account.
5. The user of the hyper-narrative editor 20 may be able to choose within an interface for editing a “crucial transitional point” branching outcomes for all possible combinations of interaction idioms and user behaviors. This may provide the creative author with a logical overview of possible user interventions (intentional or otherwise) in the story, at every crucial transitional point.

The applications of the interaction model editor 40 as shown and described herein are not necessarily limited to narrative contexts. The need to design and adapt Interaction models arises in other application domains where end-users may perform complex interactions with complex simulations or representations, from installation art through computer aided design to video games.

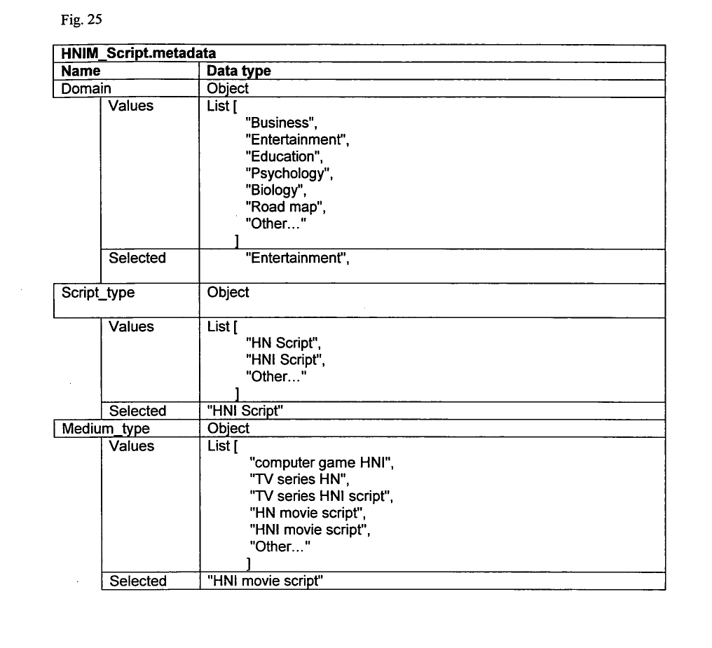

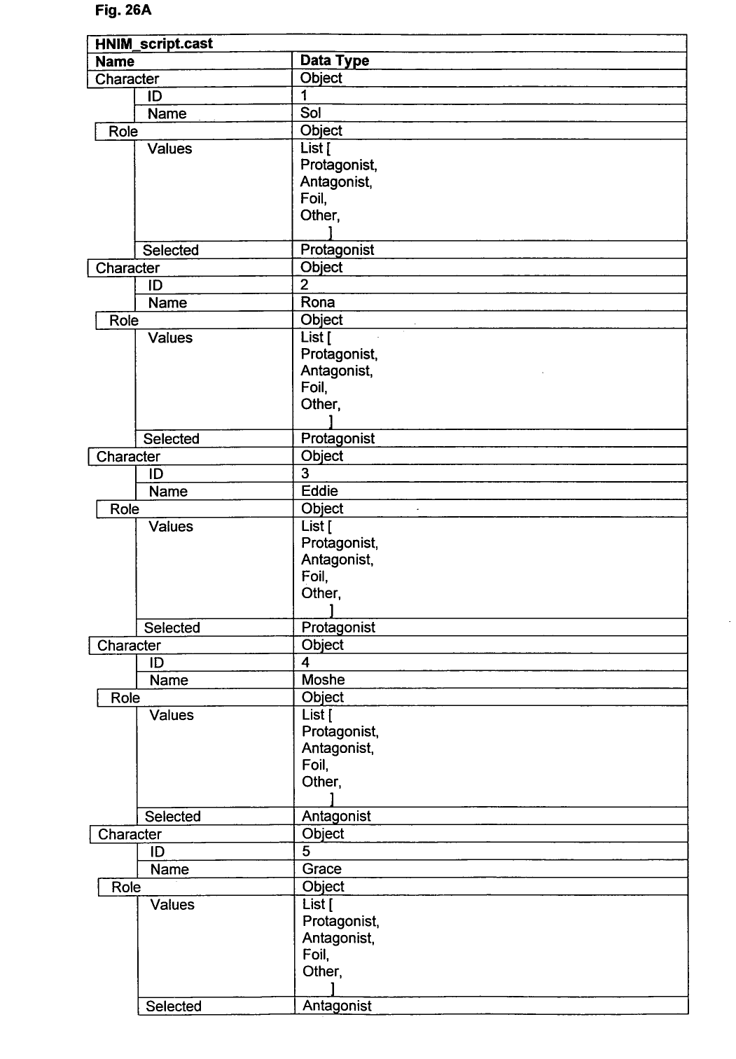

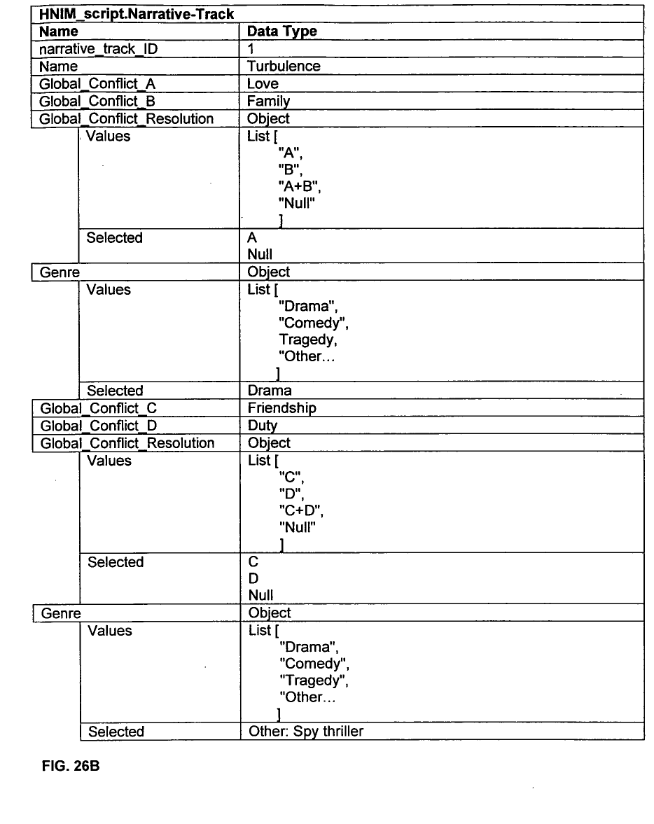

Reference is now made to FIGS. 25-32B which illustrate an example work session using the authoring environment 15 of FIG. 4 (also termed herein “script editor 15”) including interaction model editor 40 and interlacer 45. A Schema of a Dramatic Hyper-Narrative Interaction Flow may be generated. The work session may include the following operations 1-11:
1. Author opens Script Editor 15, perhaps using the script properties editor GUI of FIGS. 19 and 20.
2. Author enters properties for script, thereby generating the table of FIG. 25. The hyper-narrative editor 20 may be used for this purpose.
3. Author Can Start Writing from Scratch (option a) and branch the narrative or author can enter pre-written portions of scripts and start branching these (option b).

Example: The author elects to do (b), using the following pre-written story opening, also termed herein “Story Context of the HNIM Turbulence”:

“In the heart of the drama are three friends (Edi, Sol and Rona) who meet by chance in 2003 in Manhattan, New York when Edi and Sol independently attend Rona's singing performance. They meet 20 years after a traumatic personal-political event. At this renewed meeting, Sol produces a Polaroid photo from back then showing the three of them hugging. In a flashback scene the three are sitting in Eddie's old car and smoking grass. They are just about to drive off to participate in an illegal demonstration against the Lebanon War. The car refuses to start but eventually does and they get to the demonstration where they get arrested by the police (who also find drugs in the car). In their interrogation the detectives persuade each friend that the 2 others betrayed him/her, leading to the breaking of their friendship and spirit and to their paths parting. Rona, as it turns out, went to a kibbutz where she married Moshe; Sol went back to the US where he married Grace; whereas Eddie cannot disclose to Sol and Rona that while in jail he was drafted to the Israeli secret service and was sent undercover to the US posing as a diamond dealer. During their mutual reminiscing, the three patch up the misunderstandings that led to their dispersion.”

The script case information pertinent to the system may be entered in the form of a suitable table e.g. the script cast table illustrated in FIGS. 26A-26B.
4. Author has entered the script with properties up to a point where he wants to interlace the story of Eddy with that of Rona and Sol that have branched before. He clicks on the Interlacer 45, e.g. using the GUI shown in FIGS. 33A-33B, for Condition: “Present all possible ascending sequences of segment plot outlines from one or all Narrative tracks' CTP ID[1] to target CTP ID[6]”.

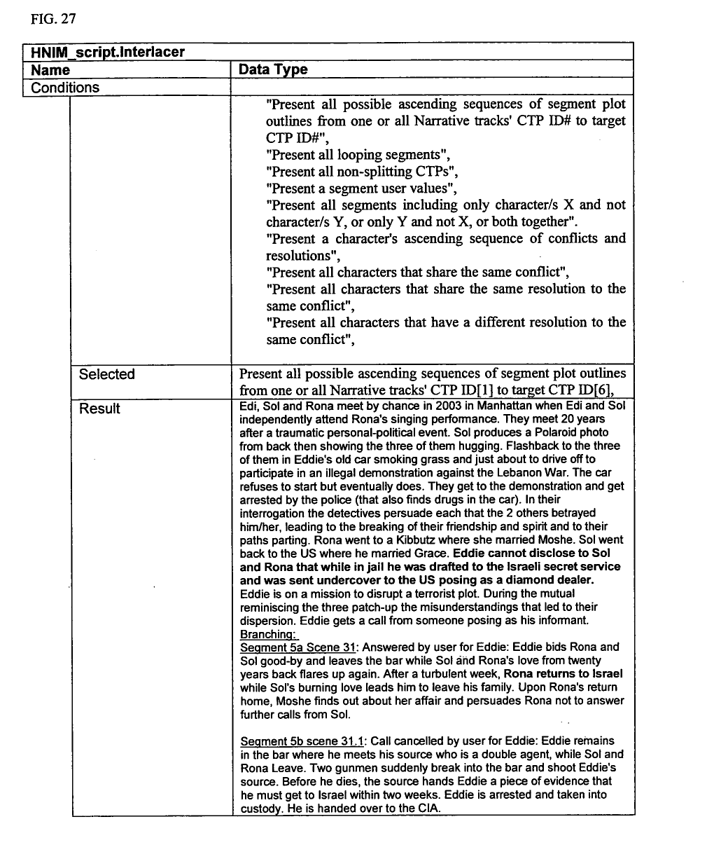

The pertinent information may be stored in a suitable script interlacer table such as that illustrated in FIG. 27.

The Author may realize that for interlacing he can bring Sol and Eddie together. He may also realize that if a user reaches the interlacing point from Sol's trajectory he needs to fill in Eddie on what transpired between Rona and Sol but not necessarily vice-versa, since Sol does not (yet) know that Eddie is a spy.

Author continues Segment 5a Scene 31: Sol, lost and alone seeks Eddie's help, so calls him. Sol tells Eddie about his affair with Rona, his burning love for her, about his leaving his wife, about not being able to communicate with Rona. He says he must meet him. Eddie sets a meeting with Sol later in the afternoon in his office.

### Dissolve

Author continues Segment 5b Scene 31.1: Eddie is released after two weeks and upon leaving the CIA headquarters he gets an urgent call from Sol. Sol tells Eddie about his affair with Rona, his burning love for her, about his leaving his wife, about not being able to communicate with Rona. He says he must meet him. Eddie sets a meeting with Sol later in the afternoon in his office.

### Dissolve

Author repeats the following scenes in both segment trajectories:
:
Segment 5a/Segment 5b: Scene 32. Inside Eddie's NY office. Late afternoon:
Sol & Eddie sit in the office.
Sol (agitated):
. . . I heard him shouting something and then the line was disconnected . . . I can't get hold of her since . . .
Eddie notices Sol has something in hand under the table

### Eddie:

What have you got there?
Sol puts the Polaroid photo on the table. Eddie takes the photo and lays it on the table.
Camera slowly focuses on the photo

### Eddie:

Have you ever asked yourself what would have happened if we didn't make it to the demonstration?
Polaroid photo morphs to
32.1 Eddie, back in 1982 looks at the Polaroid photo of him with Rona & Sol waving their fists in the air

### Dissolve

Eddie gets in the car & tries starting it. He tries again with no success. Sol & Rona sit in the back. The two are infatuated with each other. Rona buries her head in Sol's neck & hair.
32.1.2 Camera focuses on Eddie's hand turning the starter key. The camera moves to focus up close behind the dashboard on a hidden electric wire firing up. Cut to Eddie's face cursing. Cut to shot of electric wire firing up.
5. Author proceeds to design a Crucial Transitional Point (also termed herein a “CTP”), e.g. using the CTP editing functionality provided by hyper-narrative editor 20 of FIG. 4 and/or the interaction model editor 40.

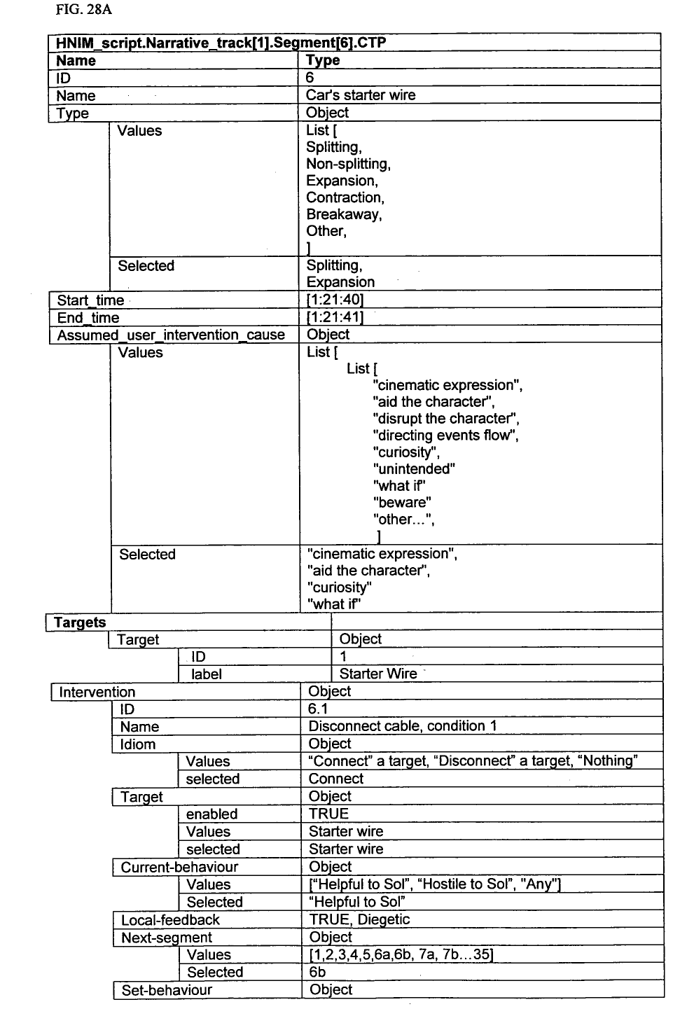

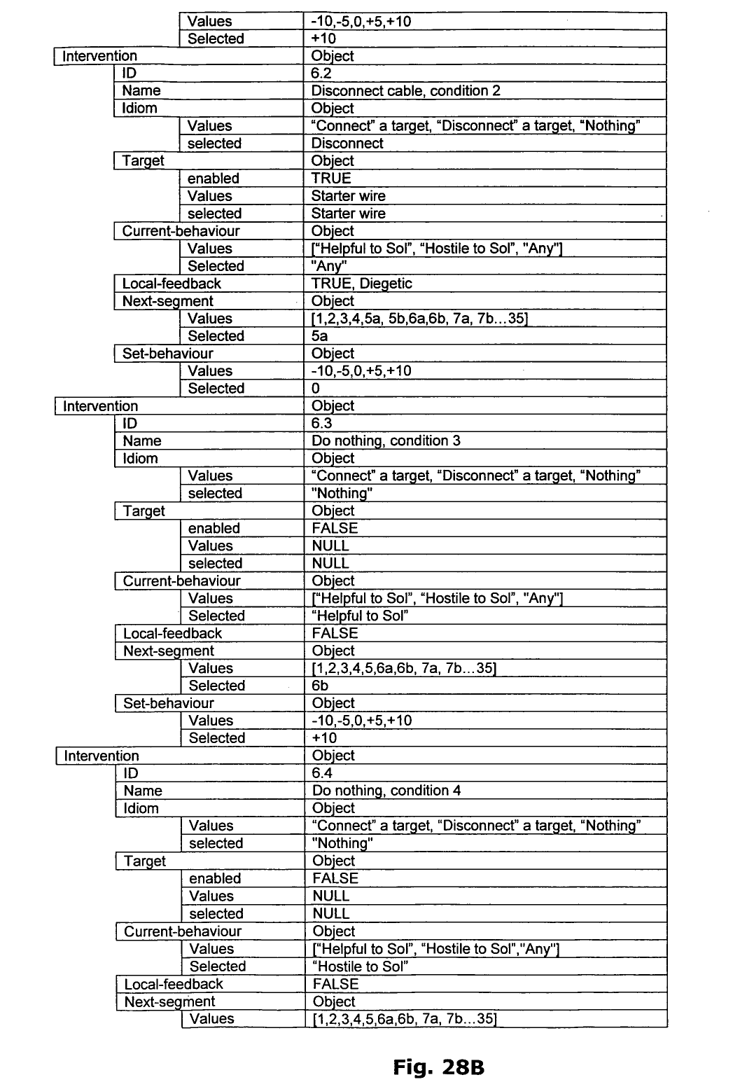

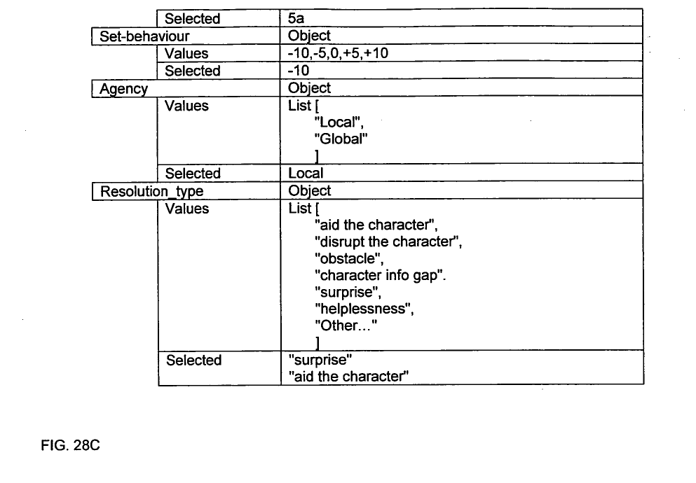

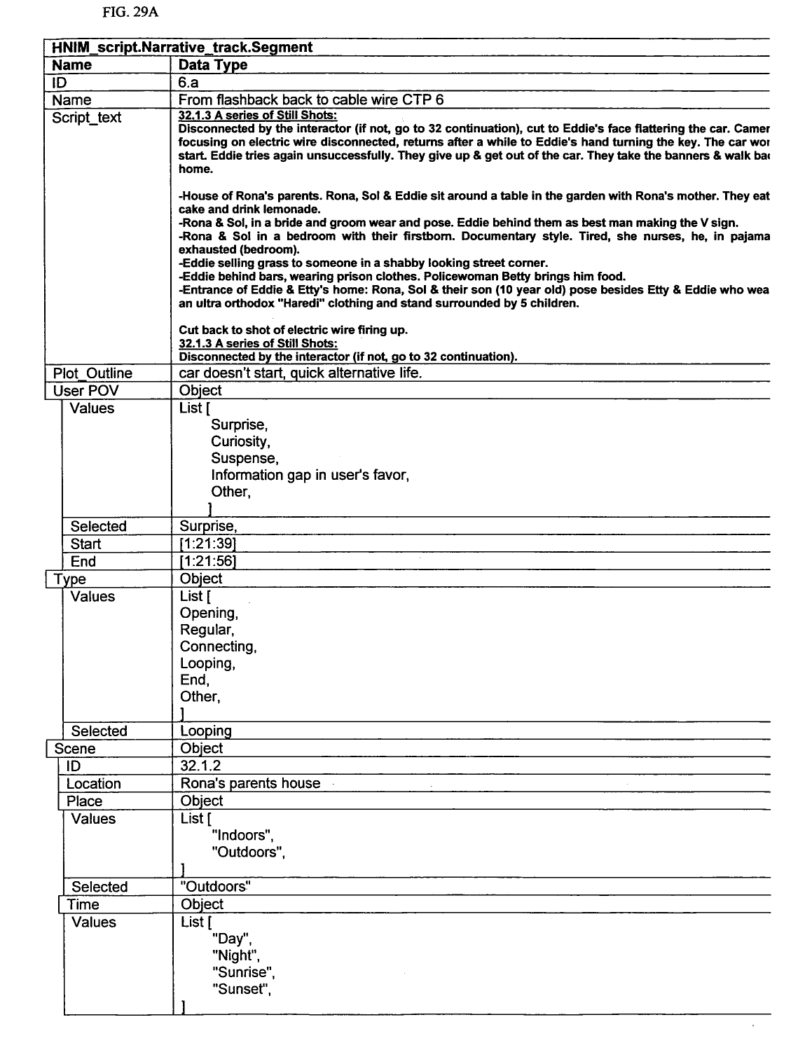

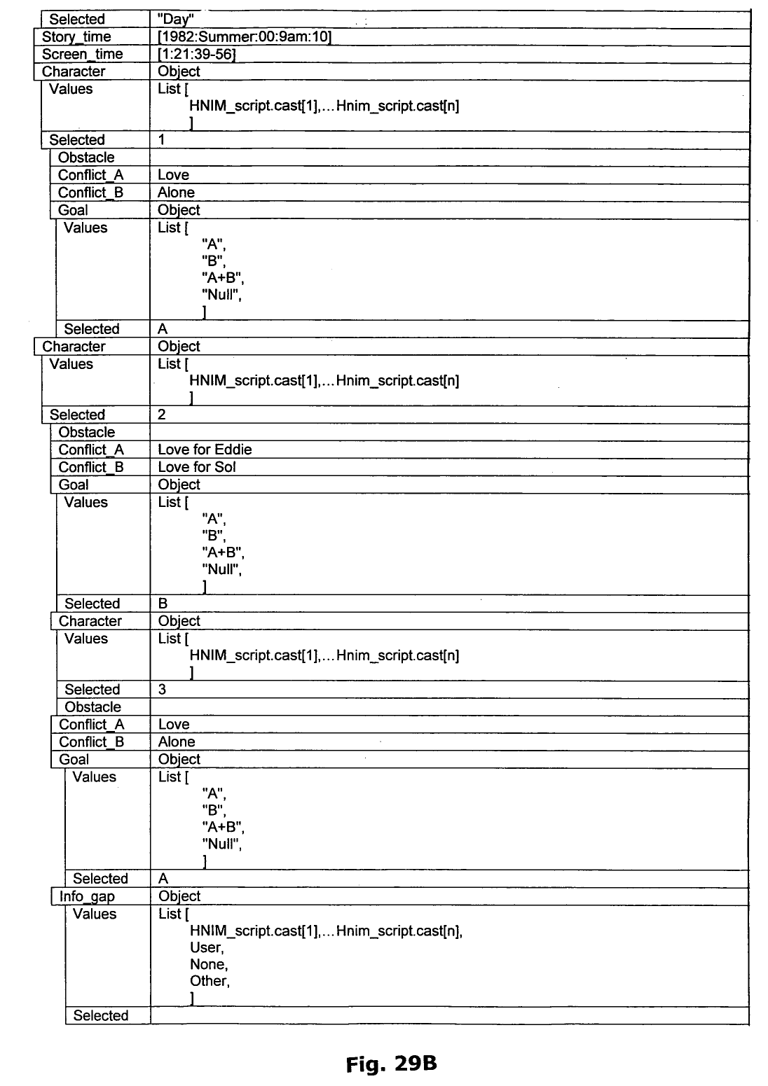

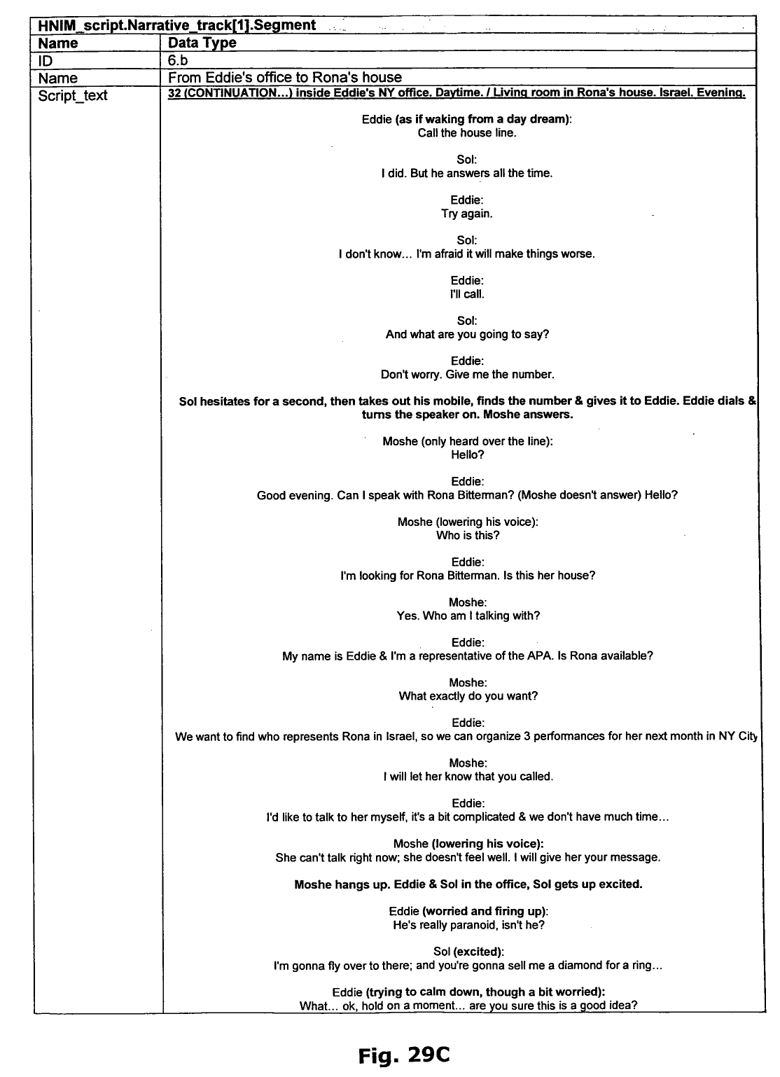

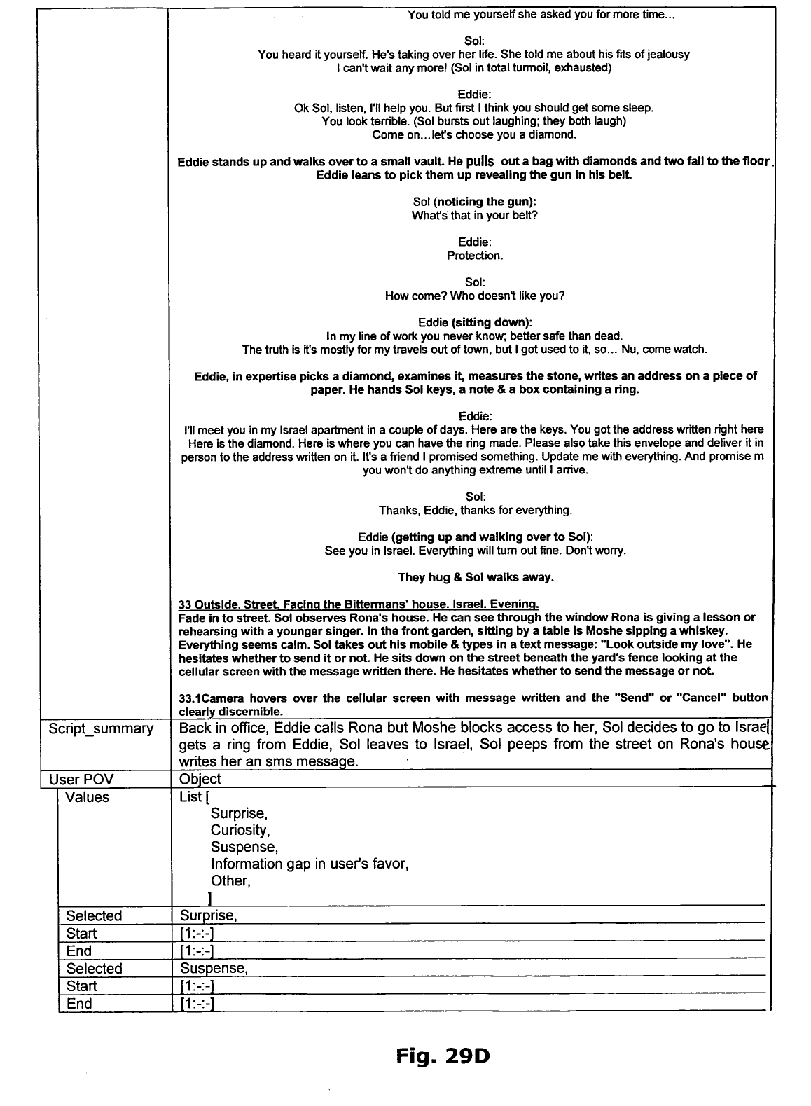

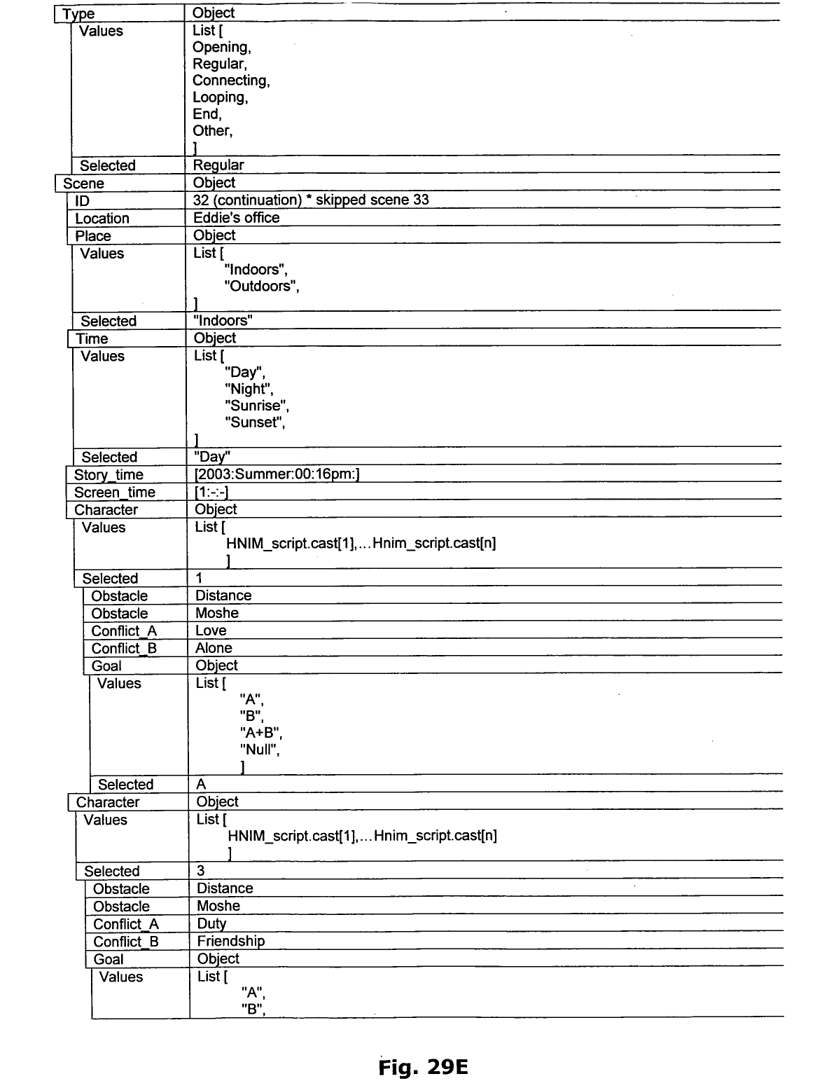

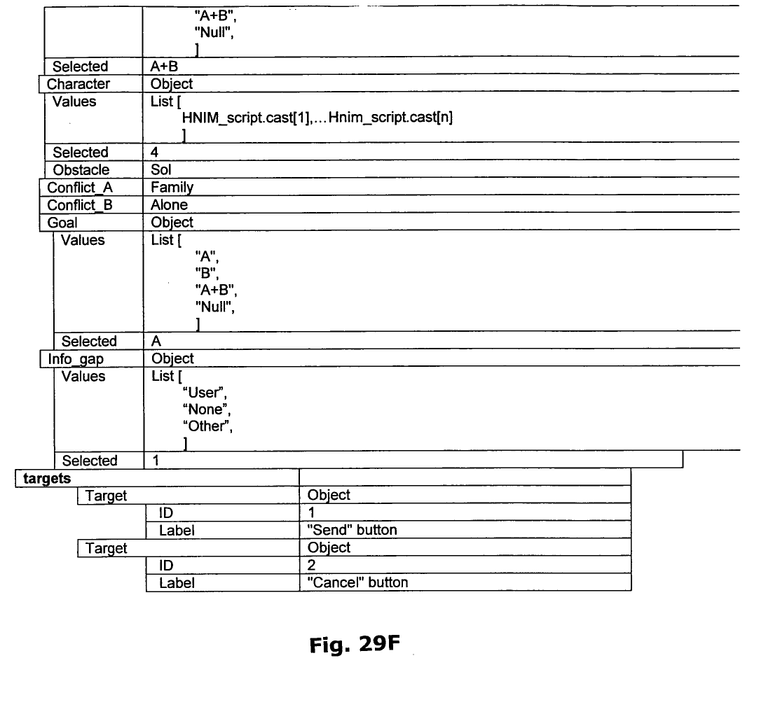

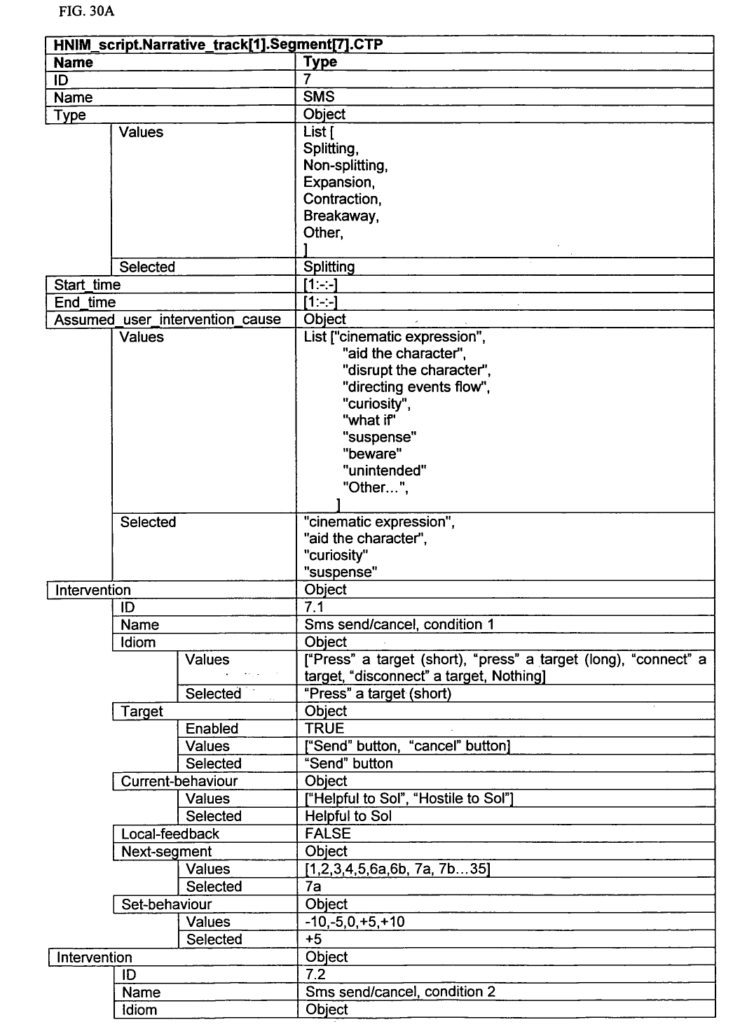

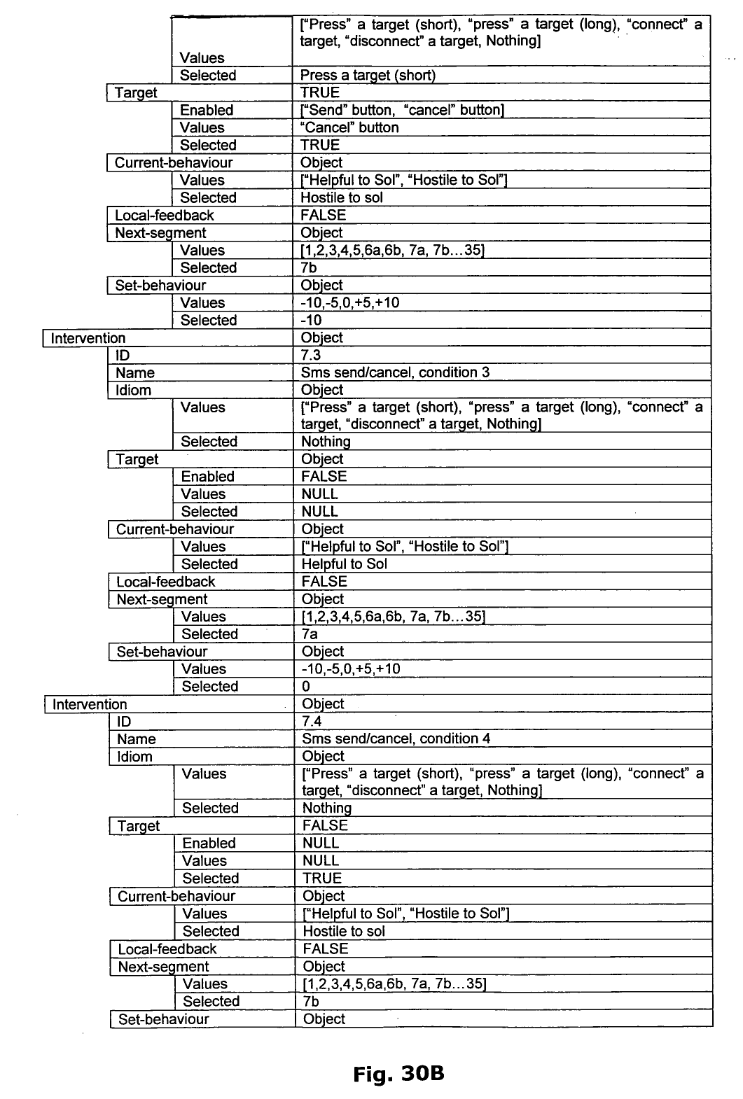

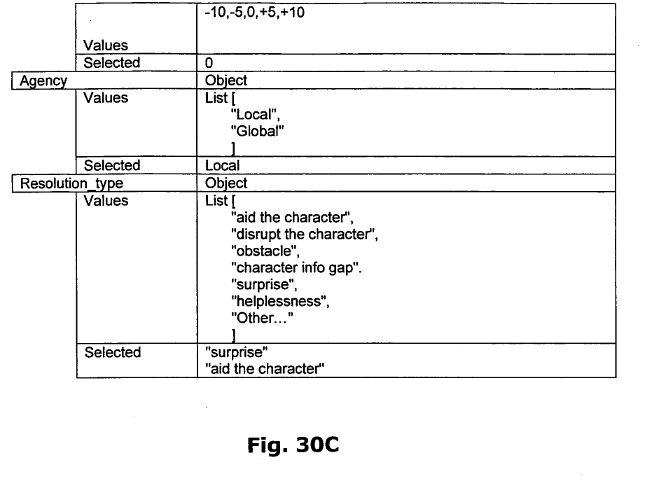

The pertinent information may be stored in a table associated with the individual CTP designed by the author which may be uniquely identified by the system, such as the CTP characterizing table illustrated in FIGS. 28A-28C, taken together.
6. Author continues entering properties to segments resulting in a segment characterizing table such as that illustrated in FIGS. 29A-29F, taken together. An example of a table characterizing a CTP located in track 1, segment 7, in the illustrated example, is shown in FIGS. 30A-30C, taken together.

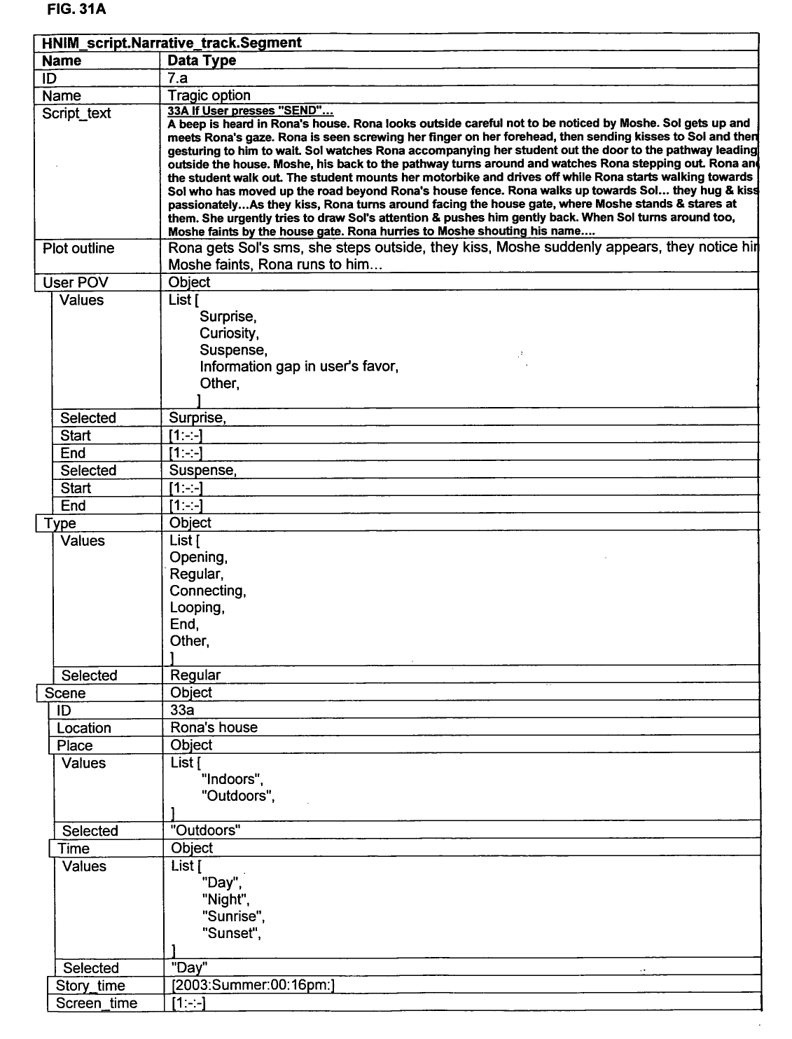

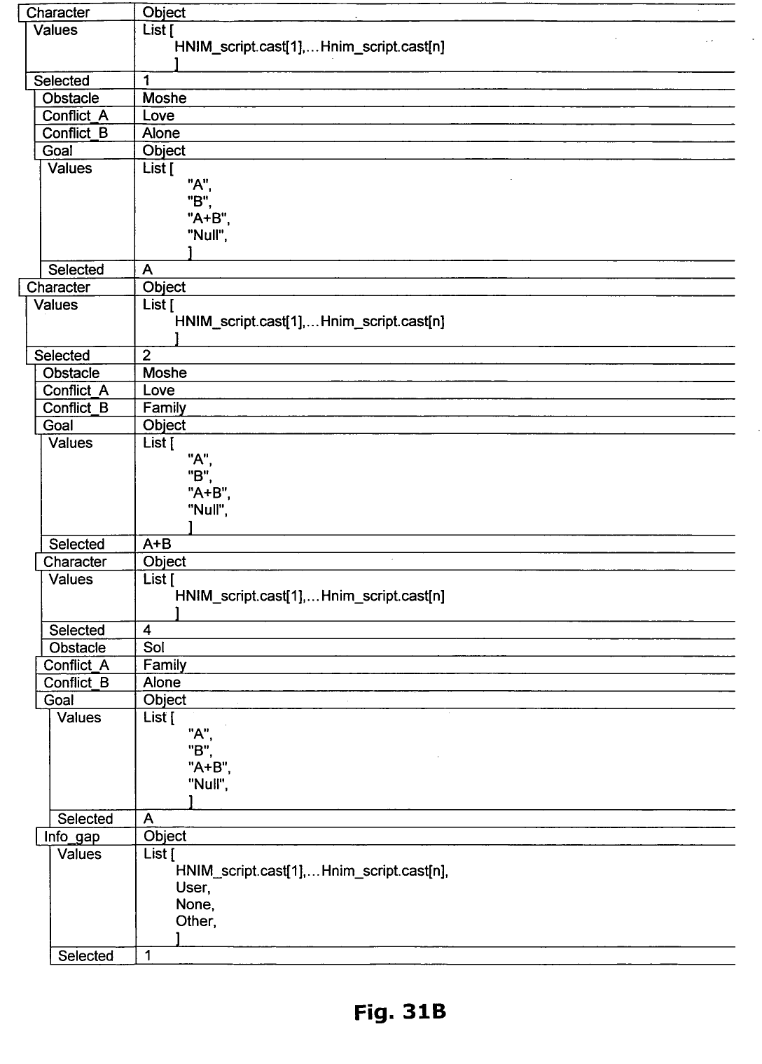

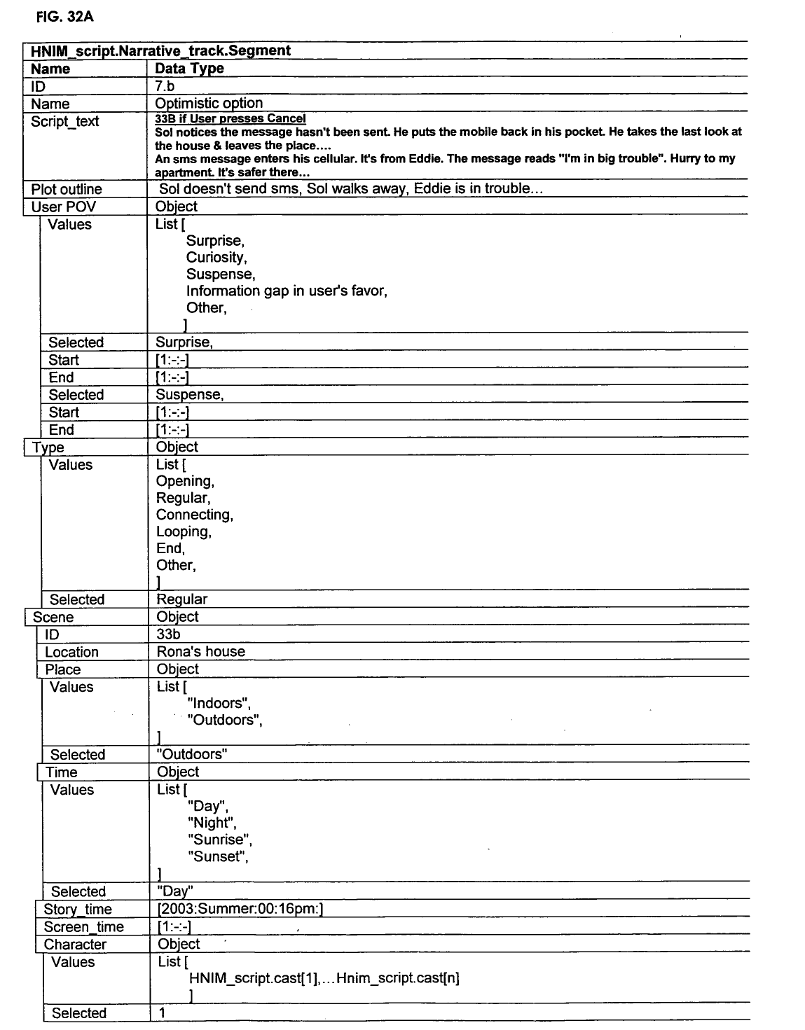

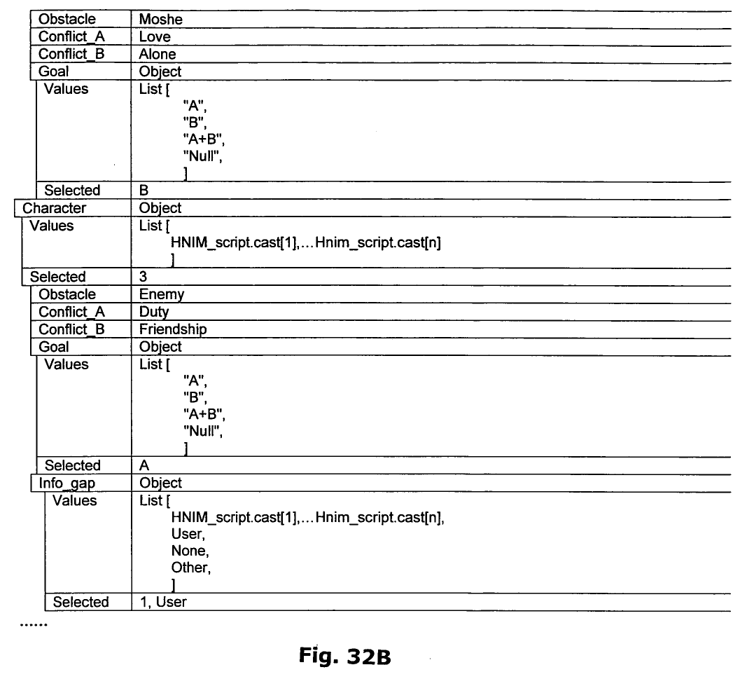

An example of a table characterizing a first, “tragic” segment of a narrative track in the script is illustrated in FIGS. 31A-31B, taken together. An example of a table characterizing a second, “optimistic” segment of the same narrative track in the script is illustrated in FIGS. 32A-32B, taken together.
7. Author occasionally runs textual simulations, using simulation functionality 60 in FIG. 4.
8. Author completes writing the HNIM which then goes out to be filmed and edited outside the system.
9. Once the Author completes writing the HNIM, the authoring environment 15 saves the state of the HNIM_schema object (50 in FIG. 4) and exports it as an XML workspace which the production environment 52 can then open.
10. The HNIM's Screenplay and storyboard 55 go out to be filmed and edited outside the system of FIG. 4.
11. The Edited Film returns to be worked on in the Production environment 52.

An example specification and workflow for the Script Editor 15 of FIG. 4 is now described. The HNIM Script Editor acts as a XML namespace editor. The graphic user interface actions may be used to create or edit existing HNIM Story XML files. Layout and Features may include some or all of the following:
Trackback Bar
   The trackback bar shows the segment intersection history,
   The trackback bar allows jumping to a specific segment by pressing its name.
HTML Text Editor (per segment)
   Allows editing of the active segment's text.
Interactive map
   Plots the story's segment structure as a map,
   The map allows jumping to a specific segment or CTP by pressing its icon.
Multiwindow display
   Accordion GUI component active segments display.
Plugins
   The editor may be designed in a scalable modular software design,
   Adding plugins to the script editor may allow advanced functions such as intelligent script interlacing script properties editor and interaction model editor.
   Actions may include some or all of the following:
New Track Button
   Add a new track to the timeline
   Adds a new parentless XML Object (<SEGMENT>) to the story workspace.
Split Segment Button
   Add a new segment at the end of the active segment.
   Adds a new XML Object (<SEGMENT>) to the story workspace and sets the parent of the object as the current active segment.
Trailing Segment Button
   Add a new segment at the end of the active segment.
   Adds a new XML Object (<SEGMENT>) to the story workspace and sets the “trail” property of the object as the current active segment.
Split Middle Segment Button (advanced mode)
   Split a segment into a sub-segment, Content after the current cursor location may be moved to a new trailing segment.
   Adds two new XML Objects (<SEGMENT>) to the story workspace,
   The first object's parent is set to as the current active segment,
   The second object is set to trail the current active segment.
Change Target Segment
   Change the target of the current segment.
   Alters the “target” property of the current segment XML object.
Save File
   Saves the current XML workspace to a file.
Load File
   Loads a HNIM Story file into the current XML workspace.
Text Styling
   Basic text styling functions—Align, Bold, Underline, Italic.
   The styling actions allows styling interactions with the HTML Editor component.
   The content for each segment may be saved as the text content of the XML Object (<SEGMENT>).
Editing (system and clipboard)
   Basic editing functions—Undo, Redo, Copy, Paste.
Print
   Prints a section or the entire document.

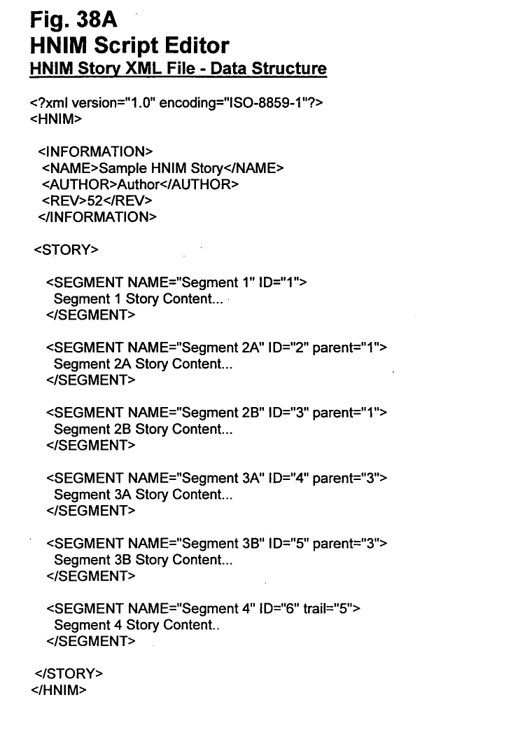

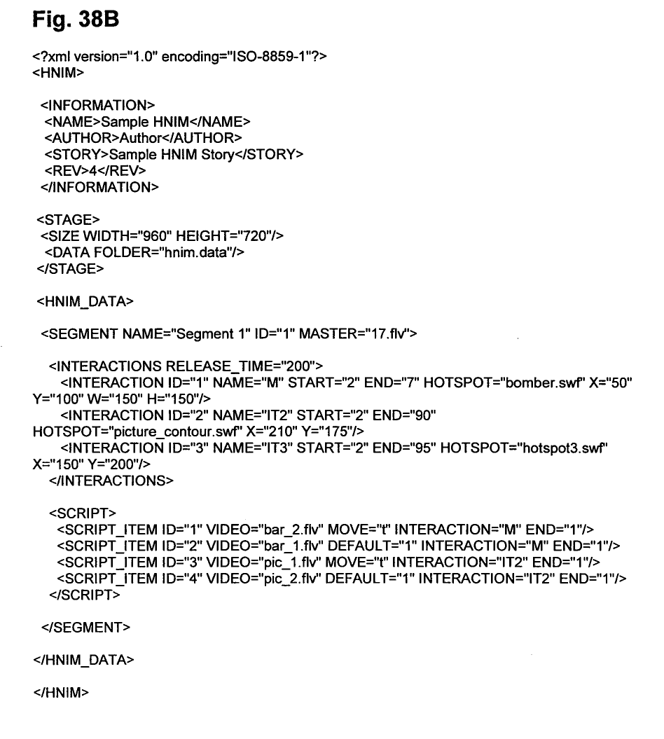

An example of a suitable HNIM Story XML File Data Structure is illustrated in FIG. 38A.

Typically, the segment and CTP properties defined by the user in her interaction with the script editor 15 may be used by the Interlacer module 45, particularly, although not exclusively, when the user wants to connect a given CTP to an already existing target CTP. This may be done by running sub-routines over the script and segment/CTP data base being written, and presenting some or all of this data according to different user defined conditions. One suitable method by which the user may interact with the system shown and described herein to achieve this is the following:
a) On the map described herein with reference to the screen editor, the user traces a line connecting a chosen CTP and a target CTP.
b) The user clicks on an interlacer button which may for example be located on the upper bar of the script editor adjacent text styling buttons and split segment buttons described herein. Responsively, a drop down of interlacing conditions list appears (e.g., “Present sequence of segment plot outlines”).
c) The user clicks on one of the conditions.
d) The user Marks on the map a CTP to serve as a start point and a CTP to serve as an end point. The condition may be applied to those Segments and CTPs intermediate the starting-point and end-point CTPs.
e) When the end point is clicked, a pop-up appears detailing the trajectory of the condition requested in step c. above. For example, marking segments from CTP 3 to CTP 6 results in a pop-up of a sequence of previously stored segment plot outlines of segments located between CTP 3 and CTP 6.

Interlacer Generator

Examples of Interlacer conditions for the interlacer module 45 of FIG. 4 are now described in detail.
1. Interlacer Condition: Present all possible ascending sequences of plot outlines from HNIM_script.Narrative_track.Segment.CTP.ID to HNIM_script.Narrative_track.Segment.CTRID+n.
   a. This condition eases for the author the writing of a next segment's plot in that it follows the plot outline, and helps the author identify what plot information has to be filled in when two segments are to be interlaced.
   b. Search & organize: Generate a list of all possible ascending segment paths. Each path represent one possible branch, the list may start at the first HNIM_Script.Narrative_Track.Segment.ID and then may follow one branch out of the possible next-segment given in HNIM_script.Narrative_track.Segment.CTP.ID.Intervention.ID.Next-segment property, until the specified HNIM_script.Narrative_track.Segment.CTP.ID+n
   c. Present: HNIM_script.Narrative_track.Segment.ID.Plot outline and HNIM_script.Narrative_track.Segment.ID.Script_text for each ascending member in the PathID.SegmentList. The term “organize” is used herein to include arranging data in a suitable format for a suitable movie—or movie-component manipulating or generating task, including sorting data according to at least one suitable pre-stored criterion and presenting the output of the sorting, including sorted data, to a human user.
2. Interlacer Condition: Present all possible ascending sequences of segment plot outlines from one or all Narrative tracks. This condition helps forging plot-wise multi-consistent end segments. HNIM_script.Narrative_track.Segment.CTP.ID to target_HNIM_script.Narrative_track.Segment.CTRID.target_HNIM_script.Narr ative_track.Segment.CTP.ID end segment.
3. Interlacer Condition: Present all looping segments (A looping segment is a segment that branches from and returns to a given CTP. Looping segments do not affect the consequent course of the narrative track). This condition helps the author short-circuit previous portions of the narrative since you can define the looping segment's CTP as the target CTP of an originating CTP, and then proceed to script an “unlooping” of the looping segment in such manner that it connects to the originating CTP, thus short-circuiting intermediary material (by also e.g presenting all narrative intermediary material now short-circuited as a character's dream or imagination).
   a. Search: Generate a list Looping_SegmentsList =allHNIM_script.Narrative_track.Segment.ID that have those properties: HNIM_script.Narrative_track.Segment.ID.Type[Looping]
   b. Present: for each ascending member in the Looping_SegmentsList present those properties:
      i. HNIM_script.Narrative_track.Segment.ID.
      ii. HNIM_script.Narrative_track.Segment.ID.Name
      iii. HNIM_script.Narrative_track.Segment.ID.Script_text
      iv. HNIM_script.Narrative_track.Segment.CTP.ID.Start_line
      v. HNIM_script.Narrative_track.Segment.CTP.ID.End_line
4. Interlacer Condition: Present all non-splitting CTPs. This condition allows the author to identify CTPs from where he can easily branch. This helps short-circuit previous portions of the narrative since the author can define the non-splitting CTP as the target CTP of an originating CTP, and then proceed to script a new segment branching from the target CTP in such manner that it connects to the originating CTP, thus short-circuiting intermediary material (by also presenting all narrative intermediary material now short-circuited as e.g. a character's dream or imagination).
   a. Search: Non_Splits_CTP_List=all HNIM_script.Narrative_track.CTP.ID that their property HNIM_script.Narrative_track.Segment.CTP.Intervention.ID<2
   b. Present: The CTP.ID value in the list Non_Splits_CTP_List HNIM_script.Narrative_track.Segment.CTP.Intervention.ID.Next-segment
5. Interlacer Condition: Present a segment “user pov values”. This condition helps assessing the segment's dramatic structure from the point of view of its effect upon the user. For example, information gap in a user's favor can be designed to encourage the user to intervene when the CTP arrives, given that he knows something the character does not know. Thus it may be better to position such gap towards the end of the segment and before the CTP. Hence, if assumed user intervention cause (see properties list) is “aid the character”, then if the information gap in the user's favor is related to such aid, it may encourage the user to intervene. Likewise, if suspense is to be picked up after a CTP, a surprising outcome can be achieved if the user's presumed-as-helpful to the character information gap in the segment before the CTP turns out to lead to detrimental results for the character. property name

HNIM_script.Narrative_track.SegmentID.User_POV
a. Search: Enter a value of HNIM_script.Narrative_track.SegmentID
b. Present:
   i. HNIM_script.Narrative_track.SegmentID.User_POV
   ii. HNIM_script.Narrative_track.SegmentID.User_POV.Start
   iii. HNIM_script.Narrative_track.SegmentID.User_POV.End
6. Interlacer Condition: Present all segments including only character/s X and not character/s Y, or only Y and not X, or both together. This condition helps write future scenes for X and Y together, offering their shared or exclusive knowledge/experiences. For example, this eases identifying what information a given character may lack for a) using in a new segment this knowledge gaps to create suspense, b) filling (through dialogue or flashbacks), in a new segment where a character appears, the missing information pertinent for this character at this point in the story so as to re-orient the characters and the user.
   a. Search & organize:
      i. HNIM user Input:
         1. “Character ID—X”: user determine only one character ID from a list of characters ID, generated from a suitable table e.g. the script cast table named HNIM_script.cast illustrated in FIGS. 26A. character_ID_X=user determined characters ID.
         2. “Character ID—Y”: user determine only one character ID from a list of characters ID, generated from a suitable table e.g. the script cast table named HNIM_script.cast illustrated in FIGS. 26A. character_ID_Y=user determined characters ID.
      ii. Generate a list named Character_Conflict_Gap of all HNIM_script.Narrative_track.Segment.ID that maintain the flowing condition:
         1. HNIM_script.Narrative_track.Segment.ID.Scene.characte r=character_ID_X
      iii. Generate a list named Character_Conflict_Gap of all HNIM_script.Narrative_track.Segment.ID that maintain the flowing condition:
         1. HNIM_script.Narrative_track.Segment.ID.Scene.characte r=character_ID_Y
      iv. Generate a list named Character_Conflict_Gap of all HNIM_script.Narrative_track.Segment.ID that maintain all the flowing condition:
         1. HNIM_script.Narrative_track.Segment.ID.Scene.characte r=character_ID_X
         2. HNIM_script.Narrative_track.Segment.ID.Scene.characte r=character_ID_Y
   b. Present: The values of Segment ID from the list named Character_Conflict_Gap
7. Interlacer Condition: Present a character's ascending sequence of conflicts and resolutions. This condition allows identifying a character's recurring or shifting conflicts and goals (a resolution to a conflict represents a character's goal) so that a) helps check whether the character is consistent/inconsistent, b) helps future turning of a character into being more consistent or inconsistent.
   a. Search & organize:
      i. HNIM user Input:
         1. “Character ID—X”: user determine only one character ID from a list of characters ID, generated from a suitable table e.g. the script cast table named HNIM_script.cast illustrated in FIGS. 26A. character_ID_X=user determined characters ID.
      ii. Generate a list named Character_X_Segments of all HNIM_script.Narrative_track.Segment.ID that maintain the flowing condition:
         1. HNIM_script.Narrative_track.Segment.ID.Scene.characte r=character_ID_X
   b. Present: For each ascending HNIM_script.Narrative_track.Segment.ID in the Character_X_Segments List present those properties:
      i. HNIM_script.Narrative_track.Segment.ID.Scene.Character.HNI M_script_cast[character_ID_X].Conflict_A
      ii. HNIM_script.Narrative_track.Segment.ID.Scene.Character.HNI M_script_cast[character_ID_X].Conflict_B
      iii. HNIM_script.Narrative_track.Segment.CTP.ID.Intervention.ID.R esolution_type
      iv. HNIM_script.Narrative_track.Segment.CTP. ID.Intervention.ID.Conflict_Resolution
      v. HNIM_script.Narrative_track.Segment.CTP. ID.Intervention.ID.Default_segment
      vi. HNIM_script.Narrative_track.Segment.CTP. ID.Intervention.ID.Agency
8. Interlacer Conditions: Present all characters that share the same conflict (e.g. love or family), the same resolution (i.e. goal—e.g. love) to the same conflict or a different resolution (i.e. goal love; goal family) to the same conflict. These conditions allow matching characters together for them working together towards the same goal or be antagonistic to each other when their goals conflict.
   a. Search & organize: Generate a list named Character_Conflict_List of all HNIM_script.Narrative_track.Segment.ID.Scene.character. HNIM_script.cast[n] that maintain the flowing condition:
      i. HNIM_script.Narrative_track.Segment.ID.Scene.character. HNIM_script.cast[n].conflict_A=HNIM_script.Narrative_track.Segment.ID.Scene.character. HNIM_script.cast[n+1].conflict_A and
      ii. HNIM_script.Narrative_track.Segment.ID.Scene.character. HNIM_script.cast[n].conflict_B=HNIM_script.Narrative_track.Segment.ID.Scene.character. HNIM_script.cast[n+1].conflict_B or
      iii. HNIM _cript.Narrative_track.Segment.ID.Scene.character. HNIM_script.cast[n].Goal=HNIM_script.Narrative_track.Segment.ID.Scene.character. HNIM_script.cast[n+1].Goal
   b. Present: The values Characters ID and Segment ID from the list Non_Character_Conflict_List

FIGS. 33A-33B are screenshots exemplifying a suitable GUI for the Interlacer 45 of FIG. 4. The Interlacer 45 eases orientation, particularly (but not only) when the user wants to connect a given CTP to an already existent target CTP, typically by running sub-routines over the script and data base being written, allowing their presentation according to different “interlacer” conditions selected by the user, such as but not limited to the interlacer conditions listed above. Initially, an interlacer button may be clicked upon. Responsively, a drop-down list of interlacer conditions may appear. The user selects an interlacer condition; a pop-up of the condition may then appear as shown in FIG. 33A. As shown in FIG. 33B, the system may be operative, typically responsive to a user's selection of a segment e.g. by clicking upon a graphic representation thereof in the “map” shown in FIG. 33B, to search through, organize and display script segment data on behalf of the human user. For example, in FIG. 33B, a sequence of plot outlines are shown, taking the user from a first CTP selected by him through all intervening script segments, up until a second CTP selected by him.

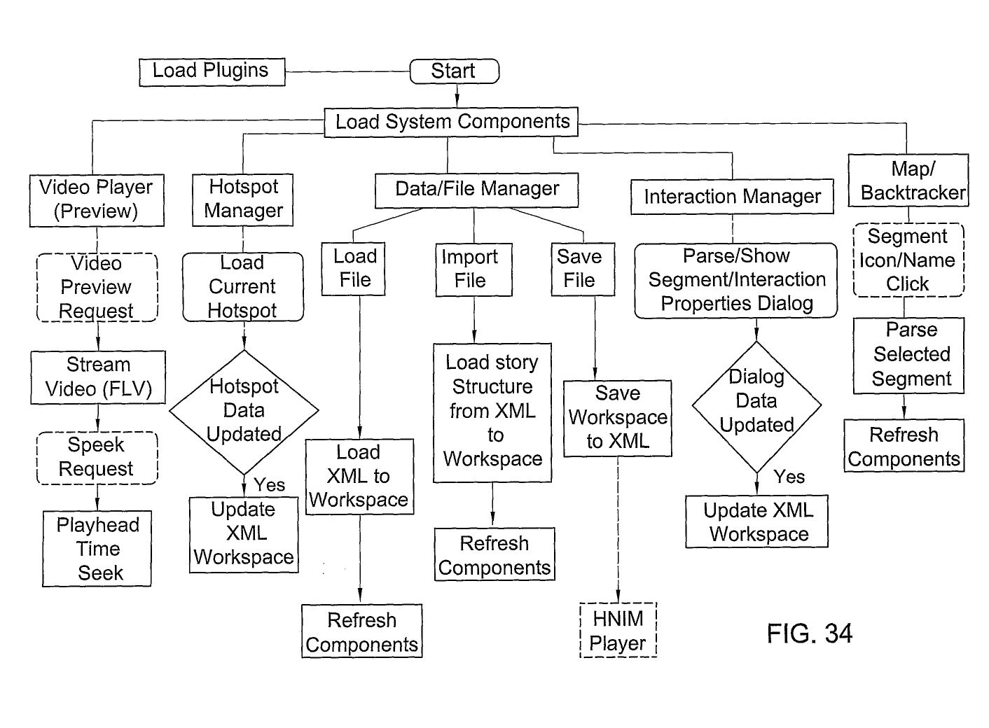

FIG. 34 is a simplified flowchart illustration of methods which may be performed by the production environment 52 of FIG. 4, including the interaction media editor 80 thereof. Some or all of the methods in this flowchart illustration and others included herein may be performed in any suitable order e.g. as shown.

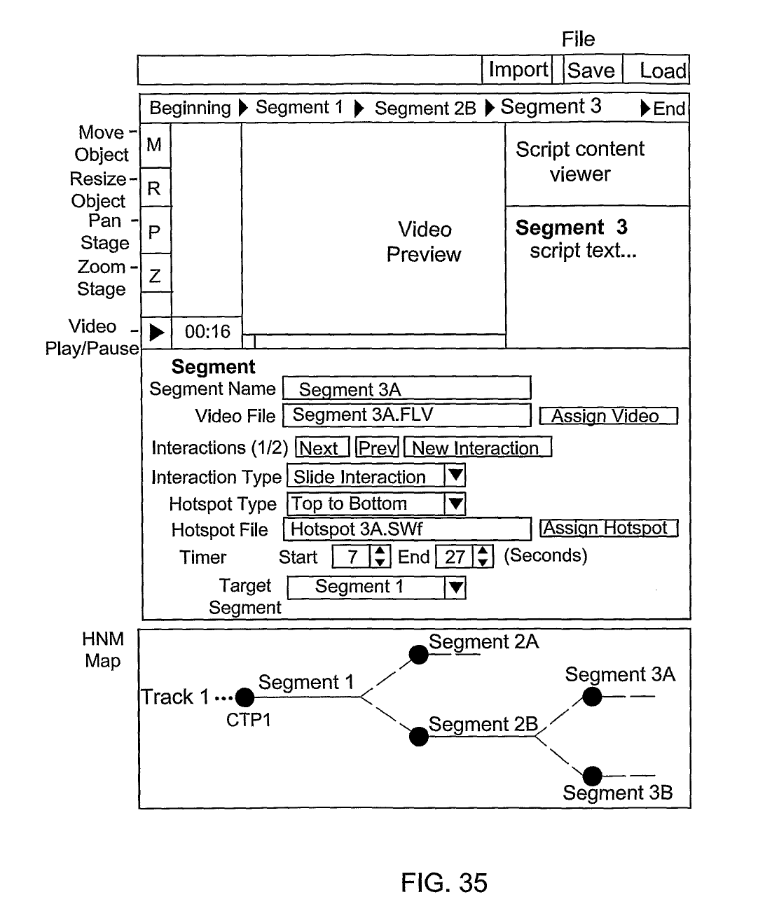

FIG. 35 is a screenshot exemplifying a suitable GUI (graphic user interface) for the production environment 52 of FIG. 4.

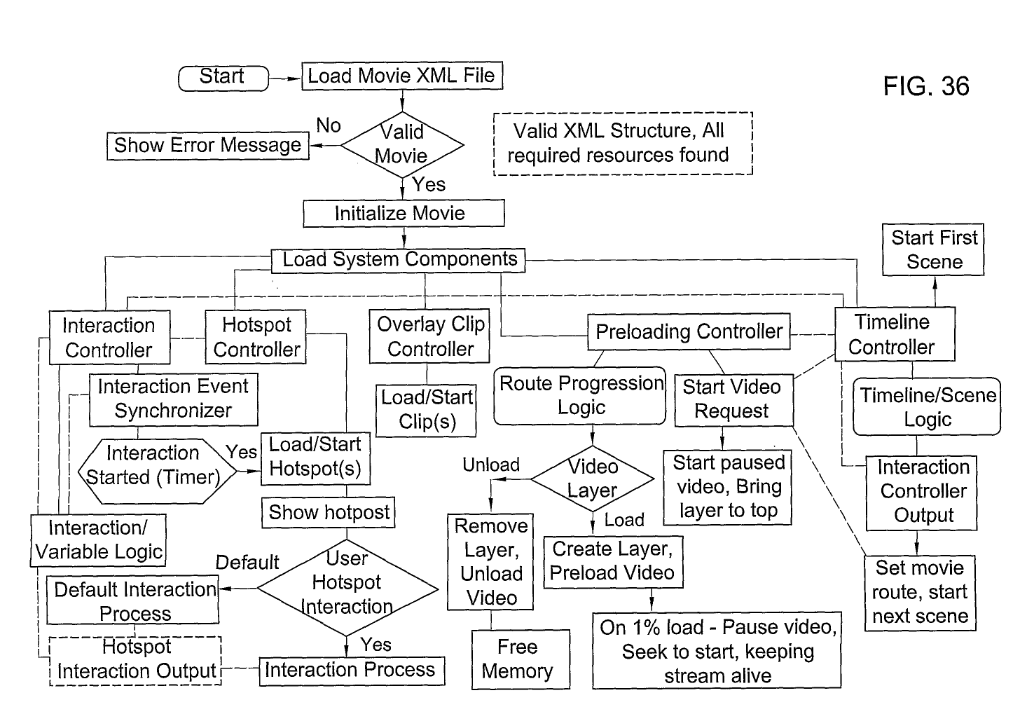

FIG. 36 is a simplified flowchart illustration of methods which may be performed by the player module 90 of FIG. 4. Some or all of the methods in this flowchart illustration and others included herein may be performed in any suitable order e.g. as shown. The player 90 typically loads a XML file generated with the HNIM Media (Interaction) Editor 80 of FIG. 4 and plays the movie according to the script. A suitable startup Sequence for this purpose may include some or all of the following steps:
1. Validate Source File
2. Validate XML Workspace Structure
3. Validate Resources (Video, Hotspot and Clip files)
4. Initialize Movie (Create master video object, Create video containers according to configuration settings—resolution/quality/bitrate)
5. Load system components
6. Request Timeline controller to start first scene

The components shown in the flowchart illustration of FIG. 36 are now described in detail in accordance with certain embodiments of the present invention:

The timeline controller manages the playhead and time-line flow. The Timeline/Scene Logic routine manages and monitors all required controllers for the current scene. Information about the current interaction (if any) may be sent to the Interaction Controller. Interaction Controller Output typically comprises an Interaction Controller response generated by the user (Hotspot) or by a default interaction. The Timeline Controller sends a request to the Preloading Controller for a video according to the script.

The Preloading Controller allows loading and unloading of videos on the fly while the movie is playing, and provides exceptional response times by utilizing a paused live-stream method.

Suitable Route Progression Logic typically comprises a routine which finds all possible script output segments for the current segment in order to preload the associated video files beforehand. The routine also typically detects video files which may be no longer required in the current route in order to unload them and free memory. Video Preloading Logic may be provided which typically pauses the video stream at, say, 1% progress while keeping video stream alive. A “Start Video Request” typically comprises a “Timeline Controller” request to start playing a paused video (and bring layer to top).

The Interaction Controller typically comprises—Interaction/Variable Logic,—an Interaction Event Synchronizer and an Interaction Timer. The Interaction/Variable Logic typically includes a variable bank logic controller whose operation is such that a specific interaction or movement can result in a variable name being set. Each next interaction can specify variable terms, e.g. in play if/don't play if format.

The Interaction Event Synchronizer typically verifies each Interaction event in order to check it is associated with the current interaction, scene and video. With the Synchronizer, disabled interaction in syncs commonly occur due to fast video switching or multiple triggering.

The Interaction Timer may be responsible to providing the Interaction Controller with the interaction timing for each scene. To do this, timing Information may be sent by the Timeline Controller. When an interaction starts the timeline controller sends a request to a Hotspot Controller in order to load/show all hotspots.

The Hotspot Controller typically generates a Load/Start Hotspot Request to Load, Show and Start a specific hotspot. The hotspot may be loaded in a layer over the current video layer. A specific hotspot layer ordering can be specified, e.g. as a “z-index”. The hotspot controller also typically generates Hotspot Output which may be sent (/default output) back to the Interaction Controller which delivers it to the Timeline Controller.

An Overlay Clip Controller typically generates a Load/Start Clip Request to Load, Show and Start a specific clip. The Load/Start clip request may include timing data to show/hide the clip. The clip may be loaded in a layer over the current video layer. A specific clip layer ordering can be specified, e.g. as a-z index.

FIGS. 37A-37D, taken together, are an example of a work session in which a human user interacts with screen editor 15 of FIG. 4, via an example GUI, in order to generate a HNIM (hyper-narrative interactive movie) in accordance with certain embodiments of the present invention.

An example specification and workflow for the production environment 52 of FIG. 4 is now described. The HNIM Interaction media editor acts as a XML namespace editor. The graphic user interface actions may be used to create or edit existing HNIM XML files. Layout and Features may include some or all of the following:
a—Trackback Bar
   The trackback bar shows the segment intersection history,
   The trackback bar allows jumping to a specific segment by pressing its name.
b—Interactive map
   Plots the movie's segment structure as a map,
   The map allows jumping to a specific segment by pressing its icon.

Actions for Stage Objects (Hotspot/overlay) Control may include some or all of the following:

The user can manipulate graphic on-stage objects (hotspots and overlays) by selecting a specific tool.
A—Tool: Move
   Move a hotspot/overlay object.
   The XML object associated with the overlay object/hotspot may be updated with the new location (“x”,“y” properties)
B—Tool: Resize
   Resize an overlay object/hotspot.
   The XML object associated with the hotspot/overlay object may be updated with the new size (“w”,“h” properties)
C—Tool: Rotate
   Rotate an overlay object/hotspot.
   The XML object associated with the hotspot/overlay object may be updated with the new rotation value (“rotation” property)
d—Tool: Zoom (in/out)
   Stage zoom control.
e—Tool: Pan
   Stage pan control.

Actions for Segment Interaction Control are now described. The segment interaction control allows the user to select and edit segment properties and interactions for the current active segment. Each segment supports multiple interactions. The actions may include some or all of the following:
a—Segment Name
   Edit the name of the active segment. alters the <SEGMENT> XML object “name” property.
b—Segment Video
   Associate a video file for the segment (browse). alters the <SCRIPT_ITEM> XML object “video” property.
c—Interaction: Type
   Select an interaction type (None, Slide, Touch, Default, Drag and Drop, Slide+Power).
   alters the <INTERACTION> and <SCRIPT_ITEM> XML objects move, type, and default properties.
d—Interaction: Hotspot Type
   Hotspot detection type (slide: left to right, slide: right to left, slide: top to bottom, slide: bottom to top, touch,)
   alters the <SCRIPT_ITEM> XML object “move” property.
e—Interaction: Target Segment
   Dropdown list containing the sections in the workspace.
   alters the <SCRIPT_ITEM> “target” property.
f—Interaction: Timer
   Two numeric steppers for controlling the interaction start and end time (seconds).
   alters the <SCRIPT_ITEM> “end” and “start” properties.
g—Interaction: New Interaction
   Add an empty interaction.
   a matching <INTERACTION> and <SCRIPT_ITEM> XML objects for the new interaction.
h—Interaction: Hotspot file
   Associate a hotspot file (Flash SWF/PNG/JPG/GIF) for the interaction (browse).
   alters the <INTERACTION> XML object “hotspot” property.
i—Interaction: Browse (Next/Prev)
   Browse existing interactions.
j—Interaction: Save (if an interaction exists)
   Save current interaction.
   a matching <INTERACTION> and <SCRIPTITEM> XML objects may be created for the interaction.

Other actions may for example include some or all of the following:

a—Save File: Saves the current XML workspace to a file.
b—Load File: Loads a HNIM file into the current XML workspace.
c—Import Story File: Import a HNIM Story file structure into the current XML workspace. This function may be used to load the segment structure from a HNIM story file.

An example of a suitable HNIM XML File Data Structure for the production environment 52 is illustrated in FIG. 38B.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery.

1. A system for generating a filmed branching narrative, the system comprising:
apparatus for receiving a plurality of narrative segments; and
apparatus for receiving and storing ordered links between individual ones of said plurality of narrative segments and for generating a graphic display of at least some of the plurality of narrative segments and of at least some of the ordered links.

2. A system according to claim 1 and also comprising a track player operative to accept a viewer's definition of a track through said filmed branching narrative and to play said track to the viewer.

3. A system according to claim 1 wherein said narrative segment comprises a script segment including digital text.

4. A system according to claim 1 wherein said narrative segment comprises a multi-media segment including at least one of an audio sequence and a visual sequence.

5. A system according to claim 1 and also comprising apparatus for receiving and storing, for at least one individual segment from among the plurality of narrative segments, at least one segment property characterizing the individual segment.

6. A system according to claim 1 wherein said ordered links each define a node interconnecting individual ones of said plurality of narrative segments and wherein said system also comprises for receiving and storing, for at least one said node, at least one node property characterizing said node.

7. A system according to claim 5 and also comprising:
a linking rule repository storing at least one rule for generating a linkage characterization characterizing a link between individual segments as a function of at least one property defined for said individual segments; and
a linkage characterization display generator displaying information pertaining to said linkage characterization.

8. A system according to claim 5 wherein said at least one segment property includes a set of characters associated with said segment.

9. A system according to claim 5 wherein said at least one segment property includes a plot outline associated with said segment.

10. A system according to claim 1 wherein said receiving and storing includes selecting a point on said graphic display corresponding to an endpoint of a first narrative segment and associating a second narrative segment with said point.

11. A system according to claim 6 and also comprising a linking rule repository storing at least one rule for generating a linkage characterization characterizing a link between individual segments as a function of at least one property defined for said individual nodes; and
a linkage characterization display generator displaying information pertaining to said linkage characterization.

12. A system according to claim 1 and also comprising a track generator operative to accept a user's definition of a track through said filmed branching narrative, to access stored segment properties associated with segments forming said track, and to display said stored segment properties to the user.

13. A system according to claim 5 wherein said at least one segment property includes a characterization of the segment in terms of conflict.

14. A method for playing an interactive movie, the method comprising:
receiving a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available; and
repeating the stages of:
playing to a user a dramatic segment; and
allowing the user, at a crucial transitional point, to interactively transit to another dramatic segment or continue playing at least one dramatic segment without the user's intervention wherein upon transiting to some ending dramatic segments no further transitions and crucial transitional points are available.

15. A method for generating an interactive movie, the method comprising:
receiving a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some ending dramatic segments no further transitions and crucial transitional points are available; and
generating a graphical representation of the hyper-narrative structure.

16. A method for generating an interactive movie, the method comprising:
receiving a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some ending dramatic segments no further transitions and crucial transitional points are available; and
storing the hyper-narrative structure.

17. A system for playing an interactive movie, the system comprising:
a memory unit for storing a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some ending dramatic segments no further transitions and crucial transitional points are available;
a media player module that is adapted to play to the user a dramatic segment out of the stored dramatic segments; and
an interface that is adapted to allow the user, at a crucial transitional point, to interactively transit to another dramatic segment or if user does not intervene, to continue playing at least one dramatic segment and until the ending dramatic segment.

18. A system for generating an interactive movie, the system comprising:
an interface that is adapted to receive a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available; and
a graphical module that is adapted to generating a graphical representation of the hyper-narrative structure.

19. A system for generating an interactive movie, the system comprising:
an interface, adapted to receive a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available; and
a memory unit, adapted to store the hyper-narrative structure.

20. A computer readable medium that stores a hyper-narrative structure and to store instructions that when executed by a computer cause the computer to repeat the stages of: playing to a user a dramatic segment and allowing the user, at a crucial transitional point, to interactively transit to another narrative dramatic segment or if user does not intervene, to continue playing at least one dramatic segment and until an ending dramatic segment; wherein the hyper-narrative structure comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available.

21. A computer readable medium that stores instructions that when executed by a computer cause the computer to: receive a hyper-narrative structure that comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available; and generate a graphical representation of the hyper-narrative structure.

22. A computer readable medium that stores instructions that when executed by a computer cause the computer to repeat the stages of: playing to a user a dramatic segment of a hyper-narrative structure and allowing the user, at a crucial transitional point, to interactively transit to another dramatic segment or if user does not intervene, to continue playing at least one dramatic segment and until an ending dramatic segment; wherein the hyper-narrative structure comprises multiple narrative movie tracks, each narrative movie track is divided into dramatic segments culminating in an ending dramatic segment, and crucial transitional points; wherein a crucial transitional point facilitates a user's interactive transition from one dramatic segment of a first narrative movie track to at least one of another dramatic segment in that track and a dramatic segment of a second narrative movie track wherein upon transiting to some of the ending dramatic segments no further transitions and crucial transitional points are available.

23. A system according to claim 1 wherein said ordered links each comprise a graphically represented CTP and wherein said apparatus for receiving and storing is operative to allow a new segment to be connected between any pair of CTPs.

24. A system according to claim 23 wherein said apparatus for receiving and storing is operative to allow a new segment to be connected between an existing CTP and at least one of the following:
an ancestor of the existing CTP; and
a descendant of the existing CTP.

25. A system according to claim 1 and also comprising an editing functionality allowing each narrative segment to be text-edited independently of other segments.

26. A system according to claim 2 wherein said apparatus for receiving and storing includes an option for connecting at least first and second user-selected segments each including at least one CTP, by generating a segment starting at a CTP of the first segment and ending at a CTP in the second segment.

27. A system for generating a branched film, the system comprising:
apparatus for generating an association between video segments and respectively script segments thereby to define film segments; and
a CTP manager operative to receive a user's definition of at least one CTP defining at least one branching point from which a user-defined subset of said film segments are to branch off, and to generate a digital representation of said branching point associating said user defined subset of said film segments with said CTP, thereby to generate an interactive or non-interactive determined branched film element.

28. A system according to claim 5 wherein said segment property includes a characterization of a segment as one of an opening segment, regular segment, connecting segment, looping segment, and ending segment.

29. A system according to claim 28 and wherein said graphic display of at least some of the plurality of narrative segments and of at least some of the ordered links comprises a graphic display generated in accordance with an interlacer condition, wherein said interlacer condition comprises a request to display all ending segments.

30. A system according to claim 28 and wherein said graphic display of at least some of the plurality of narrative segments and of at least some of the ordered links comprises a graphic display generated in accordance with an interlacer condition, wherein said interlacer condition comprises a request to display all looping segments.

31. A system according to claim 5 wherein said segment property includes a list of at least one obstacle present in said segment.

32. A system according to claim 31 wherein each obstacle is associated with a character in said segment.

33. A system according to claim 32 wherein said graphic display of at least some of the plurality of narrative segments and of at least some of the ordered links comprises a graphic display generated in accordance with an interlacer condition, wherein said interlacer condition comprises a request to display obstacles for character x in an order of appearance defined by a previously determined order of said segments.

34. A system according to claim 5 wherein said segment property includes a segment plot outline.

35. A system according to claim 34 wherein said graphic display of at least some of the plurality of narrative segments and of at least some of the ordered links comprises a graphic display generated in accordance with an interlacer condition, wherein said interlacer condition comprises a request to display segment plot outlines in an order of appearance defined by a previously determined order of said segments thereby to facilitate identification by a human user of lacking plot information to be filled in when two segments are to be interlaced.

36. A system according to claim 35 wherein said graphic display of at least some of the plurality of narrative segments and of at least some of the ordered links comprises a graphic display generated in accordance with an interlacer condition, wherein said interlacer condition comprises a request to display segment plot outlines that precede an ending segment in an order of appearance defined by a previously determined order of said segments thereby to facilitate identification by a human user of lacking plot information to be filled in for generating multi-track consistent end segments.

37. A system according to claim 5 wherein said segment property includes a list of at least one “user pov value”.

38. A system according to claim 5 wherein the segment property includes a list generated in accordance with an interlacer condition, wherein said interlacer condition comprises a request to display a segment “user pov valued” to facilitate assessment by a human user of a segment's dramatic structure from the point of view of its effect upon an interactor.

39. A system according to claim 5 wherein said segment property includes a list of at least one “character”.

40. A system according to claim 39 wherein said list is generated in accordance with an interlacer condition, wherein said interlacer condition comprises a request to display all segments including a user-defined subset of character's X and character/s Y to facilitate the writing of future scenes by a human user for X and Y together, offering their shared or exclusive knowledge/experiences.

41. A system according to claim 39 wherein said segment property is associated with at least one “conflict” and one “goal” in said segment.

42. A system according to claim 41 wherein said segment properties are generated in accordance with an interlacer condition, wherein said interlacer condition comprises a request to display a list of segment character conflicts and goals in an order of appearance defined by a previously determined order of said segments thereby to facilitate identification by a human user of a character's recurring or shifting conflicts and goals for its consistency and future development.

43. A system according to claim 39 wherein X's segment properties are associated with Y's segment properties generated in accordance with an interlacer condition, wherein said interlacer condition comprises a request to display a list of all characters that share the same conflict, the same goal or a different goal to facilitate a human user to match characters for them to work together towards the same goal or be antagonistic to each other when their goals do not match.

44. A system according to claim 6 wherein said node property comprises a characterization of each node as at least a selected one of: a splitting node, non-splitting node, expansion node, contraction node, breakaway node.

45. A system according to claim 34 wherein said graphic display of at least some of the plurality of narrative segments and of at least some of the ordered links comprises a graphic display generated in accordance with an interlacer condition, wherein said interlacer condition comprises a request to display all non-splitting nodes, thereby to facilitate identification by a human user of potential splittings.

46. A system according to claim 27 and also comprising a branched film player operative to play branched film elements generated by the CTP manager.

47. A method for generating a filmed branching narrative, the method comprising:
receiving a plurality of narrative segments;
receiving and storing ordered links between individual ones of said plurality of narrative segments and generating a graphic display of at least some of the plurality of narrative segments and of at least some of the ordered links.

48. A method for generating a branched film, the method comprising:
generating an association between video segments and respectively script segments thereby to define film segments; and
receiving a user's definition of at least one CTP defining at least one branching point from which a user-defined subset of said film segments are to branch off, and generating a digital representation of said branching point associating said user defined subset of said film segments with said CTP, thereby to generate a branched film element.

49. A computer program product, comprising a computer usable medium having a computer readable program code embodied therein, said computer readable program code adapted to be executed to implement any of the methods shown and described herein.

50. A system according to claim 25 wherein said editing functionality includes at least some Word XML editor functionalities.

51. A system according to claim 2 wherein said track player is operative to accept a viewer's definitions of a plurality of tracks through said filmed branching narrative and to play any selected one of said plurality of tracks to the viewer.

52. A hyper narrative authoring system comprising:
apparatus for generating a schema object which passes on, to a production environment, a set of at least one condition including computation of how to translate user's behavior to a next segment to play.

53. A system according to claim 52 wherein said schema object is structured to support a human author's use of natural language pertaining to narrative to characterize branching between segments and to associate said natural language with at least one of an input device and a hotspot used to implement said branching.

54. A system according to claim 52 wherein said schema object is operative to store a breakdown of natural language into objects.

55. A system according to claim 54 wherein said objects comprise at least one of “idioms” and “targets”.

56. A system according to claim 52 wherein said system is also operative to display simulations of interactions.

57. A system according to claim 52 wherein said conditions are stored in association with respective nodes interconnecting branching narrative segments.

58. A system according to claim 57 wherein said conditions are defined over CTP properties defined for at least one of said nodes.
